(19) United States
(12) Patent Application Publication
(10) Pub. No.: US 2026/0134100 A1
(43) Pub. Date: May 14, 2026

(54) DATA BACKUP AND/OR PROVISIONING APPARATUS AND METHOD FOR DATA BACKUP AND/OR DATA PROVISIONING

(71) Applicant: Valutis Technologies GmbH, Gröbenzell (DE)

(72) Inventors: Benjamin OHMER, Munich (DE); Hans Thomas Alexander Echnaton HAUNHORST, Bonn (DE)

(21) Appl. No.: 19/119,634

(22) PCT Filed: Oct. 9, 2023
(86) PCT No.: PCT/EP2023/077936

§ 371 Date: Apr. 9, 2025

(30) Foreign Application Priority Data
Oct. 10, 2022 (DE) 10 2022 126 232.4
Oct. 12, 2022 (DE) 10 2022 126 633.8
Oct. 31, 2022 (DE) 10 2022 128 858.7

(51) Int. Cl. G06F 21/56; G06F 11/1446

(52) U.S. Cl. CPC G06F 21/566; G06F 11/1458; G06F 2201/805; G06F 2221/034

(57) ABSTRACT

A data backup device (1), such as a data backup and/or provisioning device, includes a passivation device (2) that converts original digital data (4) into resulting digital data (6), and a reactivation device (80) that converts the resulting digital data into target data (22) corresponding to the original data. The passivation device includes at least one passivation logic gate (8) and is configured to convert the original digital data into the resulting digital data and to generate the resulting digital data. The original digital data are defined by a first binary sequence (16). The resulting digital data are defined by a second binary sequence (18) that is different from the first binary sequence (16).

The prior art discloses, for example, the following publications elucidating the technical background of the present invention: FPGA based approach for signature based antivirus applications, Guinde, N. B.; Lohani, R. B., Association for Computing Machinery -Feb. 25, 2011.

E. Nurvitadhi, D. Sheffield, Jaewoong SiM, A. Mishra. G. Venkatesh and D. Marr, “Accelerating Binarized Neural Networks: Comparison of FPGA, CPU, GPU, and ASIC,” 2016 International Conference on Field-Programnaile Technology (FPT), Xi'an, China, 2016, pp. 77-84, doi: 10.1 1l09/FPT.2016.7929192.

K. Alrawashdeh and C. Purdy, “Ransomware Detection Using Limited Precision Deep Learning Structure in FPGA,” NAECON 2018-IEEE National Aerospace and Electronics Conference, 2018, pp. 152-157, doi: 10.1109/NAECON.2018.8556824.

Cilardo, A., Maisto, V., Mazzocca, N., Rocco di Torrepadula, F. (2022). A Proposal for FPGA-Accelerated Deep Learning Ensembles in MPSoC Platforms Applied to Malware Detection. In: Vallecillo, A., Visser, J., P6rez-Castillo, R. (eds) Quality of Information and Communications Technology. QUATIC 2022. Communications in Computer and Information Science, vol 1621.

Springer, Cham. https://doi.org/10.1007/978-3-031-14179-9_16 The following publications are also known: U.S. Pat. No. 9,389,663B2, U.S. Ser. No. 10/867,078B2, US20170102950A1.

In its report “Hype Cycle for Storage and Data Protection Technologies, 2021”, published on 22.07.21, Gardner, Inc. highlighted very precisely that there is no solution that can securely protect a data backup against ransomware attacks, which is why multi-level solutions are recommended.

Gardner, Inc. introduces the term “cyberstorage”. Approaches that have been published in this regard can be found, for example, in the following publications: US2022/0156395A1, US2023032139A1, US2022156396A1, US2023153438A1, US2023141909A1, WO2023076089A1, U.S. Ser. No. 11/632,394B1, KR20230042840A, US20190207969A1, US2021286884A1.

Furthermore, the following publications demonstrate methods for homomorphic analysis of data: G. R. Thompson and L. A. Flynn, “Polymorphic malware detection and identification via context-free grammar homomorphism,” in Bell Labs Technical Journal, vol. 12, no. 3, pp. 139-147, Fall 2007, doi: 10.1002/bltj.20256.

Mercy Joseph and Gobi Mohan, “Design a hybrid Optimization and Homomorphic Encryption for Securing Data in a Cloud,” in International Journal of Computer Networks and Applications (IJCNA), Volume 9, Issue 4, July -August (2022), DOI: 10.22247/ijcna/2022/214502. Liam Morris, “Environment Analysis of Partially and Fully Homomorphic Encryption”, Department of Computer Science, Rochester Institute of Technology, Rochester, New York, May 10, 2013. Additional documents that deal with homomorphic data are e.g.: US2023291541A1, US2023291573A1, US2023188343A1, WO2023158193A1.

In addition, the following publications show methods for obfuscating data: Protecting Software through Obfuscation: Can It Keep Pace with Progress in Code Analysis?; ACM Computing Surveys; Volume 49; Issue 1; Article No.: 4pp 1-37; https://doi.org/10.1145/2886012; 05.04.2016.

S. K. Udupa, S. K. Debray and M. Madou, “Deobfuscation: reverse engineering obfuscated code,” 12th Working Conference on Reverse Engineering (WCRE'05), Pittsburgh, PA, USA, 2005, pp. 10 pp.-54, doi: 10.1109/WCRE.2005.13.

Sebastian Banescu, Christian Collberg, Vijay Ganesh, Zack Newsham, and Alexander Pretschner. 2016. code obfuscation against symbolic execution attacks. In Proceedings of the 32nd Annual Conference on Computer Security Applications (ACSAC '16). Association for Computing Machinery, New York, NY, USA, 189-200. https://doi.org/10.1145/2991079.2991114.

B. Yadegari, B. Johannesmeyer, B. Whitely and S. Debray, “A Generic Approach to Automatic Deobfuscation of Executable Code,” 2015 IEEE Symposium on Security and Privacy, San Jose, CA, USA, 2015, pp. 674-691, doi: 10.1109/SP.2015.47.

Viticchié et al, “Assessment of Source Code Obfuscation Techniques,” 2016 IEEE 16th International Working Conference on Source Code Analysis and Manipulation (SCAM), Raleigh, NC, USA, 2016, pp. 11-20, doi: 10.1109/SCAM.2016.17.

You and K. Yim, “Malware Obfuscation Techniques: A Brief Survey,” 2010 International Conference on Broadband, Wireless Computing, Communication and Applications, Fukuoka, Japan, 2010, pp. 297-300, doi: 10.1109/BWCCA.2010.85.

Hada, S. (2000). Zero-Knowledge and Code Obfuscation. In: Okamoto, T. (eds) Advances in Cryptology -ASIACRYPT 2000. ASIACRYPT 2000. Lecture Notes in Computer Science, vol 1976. Springer, Berlin, Heidelberg. https://doi.org/10.1007/3-540-44448-3_34.

Code Obfuscation Literature Survey; Arini Balakrishnan, Chloe Schulze; CS701 Construction of Compilers, Instructor: Charles Fischer; Computer Sciences Department University of Wisconsin, Madison; Dec. 19, 2005.

Additional publications that deal with obfuscated data are e.g.: US2023259613A1, US2023262032A1, US2023239144A1.

OCR analyses are also described in the following publications: Algorithms and methods for document-specific analysis of historical and OCR-captured texts, Ulrich Reffle, 24.10.2011, ISBN-13: 978-3843901062.

Full text via OCR -possibilities and limits, Maria Federbusch, Christian Polzin, 2013, ISBN 978-3-88053-185-7.

OCR ACCURACY IMPROVEMENT ON DOCUMENT IMAGES THROUGH A NOVEL PRE-PROCESSING APPROACH, A. El Harraj and N. Raissouni, Signal & Image Processing: An International Journal (SIPIJ) Vol.6, No.4, August 2015, DOI: 10.5121/sipij.2015.6401 1.

### OCR Based Thresholding, Yves Rangoni, Faisal Shafait, Thomas M. Breuel.

Going Grey?Comparing the OCR Accuracy Levels of Bitonal and Greyscale Images, Tracy Powell, Gordon Paynter, ISSN 1082-9873.

Adaptive Thresholding for OCR: A Significant Test Ray Smith, Chris Newton, Phil Cheatle Personal Systems Laboratory HP Laboratories Bristol HPL-93-22 March, 1993.

Binarization Techniques used for Grey Scale Images, Puneet, Garg, International Journal of Computer Applications (0975-8887), Volume 71-No. 1, June 2013.

The following documents also describe sample identifiers: J.-S. Luo and D. C.-T. Lo, “Binary malware image classification using machine learning with local binary pattern,” 2017 IEEE International Conference on Big Data (Big Data), Boston, MA, USA, 2017, pp. 4664-4667, doi: 10.1109/BigData.2017.8258512.

D. Kothari, M. Patel and A. K. Sharma, “Implementation of Grey Scale Normalization in Machine Learning & Artificial Intelligence for Bioinformatics using Convolutional Neural Networks,” 2021 6th International Conference on Inventive Computation Technologies (ICICT), Coimbatore, India, 2021, pp. 1071-1074, doi: 10.1109/ICICT50816.2021.9358549.

E. R. Urbach, J. B. T. M. Roerdink and M. H. F. Wilkinson, “Connected Shape-Size Pattern Spectra for Rotation and Scale-Invariant Classification of Gray-Scale Images,” in IEEE Transactions on Pattern Analysis and Machine Intelligence, vol. 29, no. 2, pp. 272-285, Feb. 2007, doi: 10.1 109/TPAMI.2007.28.

T. Ojala, M. Pietikainen and T. Maenpaa, “Multiresolution gray-scale and rotation invariant texture classification with local binary patterns,” in IEEE Transactions on Pattern Analysis and Machine Intelligence, vol. 24, no. 7, pp. 971-987, July 2002, doi: 10.1109/TPAMI.2002.1017623.

Riesen, K., Bunke, H. (2008). IAM Graph Database Repository for Graph Based Pattern Recognition and Machine Learning. In: da Vitoria Lobo, N., et al. Structural, Syntactic, and Statistical Pattern Recognition. SSPR/SPR 2008. Lecture Notes in Computer Science, vol 5342. Springer, Berlin, Heidelberg. https://doi.org/10.1007/978-3-540-89689-0_33 Furthermore, with patent application PCT/EP2022/059665, the applicant of the present patent application filed a patent application for a technology that uses an analog interface to create a barrier that cannot be overcome by malware. The objects of PCT/EP2022/059665 can be combined with the objects of the present invention. In particular, actuation signals can be effected in the system according to the present invention in accordance with one or more subject matters of PCT/EP2022/059665. The subject matters of PCT/EP2022/059665 are hereby made the subject matter of the present publication by reference in their entirety.

It is the object of the present invention to provide a reliable and preferably high-performance way of storing data securely and preferably conveniently. Additionally or alternatively, the present invention is intended to provide a way to make email communication secure and convenient. Additionally or alternatively, the present invention is intended to provide a way of controlling machines, in particular robots, vehicles, systems, or parts thereof, securely and conveniently via the Internet.

According to the invention, the aforementioned object is solved by a data backup device, in particular a data backup and/or provisioning device, according to claim 1.

A data backup and/or provisioning device according to the invention preferably comprises at least: a passivation device for converting original digital data into resulting digital data, wherein the passivation device comprises at least one passivation logic gate and wherein the at least one passivation logic gate is configured for converting the original digital data into the resulting digital data and for generating the resulting data, wherein the passivation device comprises a passivation device input interface for supplying the original data to the at least one passivation logic gate, and wherein the passivation device comprises a passivation device output interface for outputting the resulting data generated by the at least one passivation logic gate, wherein the original digital data is preferably defined by a first binary sequence, wherein the resulting digital data is preferably defined by a second binary sequence, wherein the first binary sequence and the second binary sequence are particularly preferably different from each other. Furthermore, the data backup and/or provisioning device preferably comprises a reactivation device for converting the resulting data into target data, wherein the reactivation device comprises a reactivation device input interface for supplying the resulting data to the reactivation device and preferably a reactivation device output interface for outputting the target data, wherein the target data preferably matches the original data by at least 90% or at least 95% or at least 99% or at least 99.9% or exactly 100%. Resulting data is preferably stored as a resulting data file.

This embodiment is particularly suitable because malicious code sent to the system can no longer be executed and therefore cannot cause any damage to the system until it is reactivated. The data backup and/or provisioning device according to the invention can also be referred to as “cyberstorage” in the sense of the definition of “Gardner, Inc” described at the beginning. Furthermore, this type of storage particularly prefers to obfuscate the data, thereby deactivating or rendering non-executable any malicious code contained therein. In addition, the data stored in this way can preferably still be analyzed without the data or the malicious code potentially contained therein being made executable again, consequently data stored in accordance with the present invention can have homomorphic properties. Homomorphic encryptions have the major disadvantage that very complex mathematical operations have to be carried out, which results in a high time requirement, a high computing effort and consequently a high energy consumption. The analyzability of obfuscated data creates a much more efficient way of storing data in a non-executable way and also of analyzing it securely.

According to a preferred embodiment of the present invention, the passivation device input interface for forwarding digital signals is connected to the passivation device output interface exclusively via the at least one passivation logic gate.

This embodiment is particularly suitable as no further connections need to be secured against unauthorized access.

According to a preferred embodiment of the present invention, the passivation device, in particular at least the passivation logic gate, is at least a part of a data backup and provision device logic gate device, in particular Field Programmable Gate Array (FPGA) or Application Specific Integrated Circuit (ASIC) or Complex Programmable Logic Device (CPLD) or Simple Programmable Logic Device (SPLD).

This embodiment is particularly suitable as the components used are particularly suitable for executing redundant processes and are very fast.

According to a preferred embodiment of the present invention, a providing device is provided.

According to a preferred embodiment of the present invention, the providing device data memory has a providing device data memory for storing the resulting data. This embodiment is particularly suitable, since the providing device data memory allows the resulting data to be transferred directly to further process steps without having to be stored again in another, possibly permanent, memory.

According to a preferred embodiment of the present invention, the passivation device output interface is connected to a providing device input interface of the providing device. This embodiment is particularly suitable, as this connection allows data to be passed directly from the passivation device to the providing device.

According to a preferred embodiment of the present invention, the providing device input interface is connected to the providing device data memory and wherein a providing device output interface of the providing device is provided, wherein the providing device output interface is connected to the providing device data memory.

The fact that the providing device input interface is connected to the providing device data memory means that the data introduced via the providing device input interface can be fed directly or indirectly to the providing device data memory. This design is particularly suitable, as the resulting data can be sent to the providing device data memory through this connection.

According to a preferred embodiment of the present invention, resulting data stored in the providing device data memory of the providing device can be forwarded to the reactivation device by the data processing device of the providing device, in particular via a bidirectional or unidirectional data connection, in particular by means of at least or exactly one optical fiber. This embodiment is particularly suitable, since forwarding the resulting data to the reactivation device by means of an optical fiber, for example, enables particularly fast transmission of the data to the reactivation device.

According to a preferred embodiment of the present invention, the providing device has a providing device communication interface, wherein the providing device communication interface is connected to the working system or the control device by means of a unidirectional data connection, in particular by means of at least or exactly one optical fiber, for transmitting status data of the providing device.

This design is particularly suitable because the separate communication interface means that status data can be transmitted unidirectionally, independently of other data transmission.

The status data preferably includes the memory utilization, the power utilization, the number of files stored in the providing device data memory and/or the names of the files stored in the providing device data memory and/or documentation of executed commands. This embodiment is particularly suitable, as the status data thus provides information about the running processes and resources used.

According to a preferred embodiment of the present invention, the passivation device and the providing device are part of a passivating and providing unit. This embodiment is particularly suitable because combining the units saves resources or allows them to be used jointly, and internal interfaces allow data to be exchanged even more quickly.

According to a preferred embodiment of the present invention, the passivation device output interface is connected to a providing unit data memory of the passivating and providing unit for supplying the input data. This embodiment is particularly suitable because the data can be written directly from the passivation unit to the memory through the connection.

According to a preferred embodiment of the present invention, a providing unit output interface of the passivating and providing unit is provided, wherein the providing unit output interface is connected to the providing unit data memory. This embodiment is particularly suitable, since the connection enables the data to be stored in the providing unit data memory after passing through the providing device.

According to a preferred embodiment of the present invention, resulting data stored in the providing unit data memory of the passivation and providing unit can be forwarded to the reactivation device by a data processing device of the passivation and providing unit, in particular via a bidirectional or unidirectional data connection, in particular by means of at least or exactly one optical fiber. That is, the data processing device of the passivation and providing unit is configured to forward resulting data stored in the providing unit data memory of the passivation and providing unit to the reactivation device. This design is particularly suitable because the data processing device can take over processes that do not necessarily have to be carried out by the other components of the passivation and providing unit.

According to a preferred embodiment of the present invention, a data checking device is provided for detecting malware. This embodiment is particularly suitable, since the data checking device can already detect malware within the device.

The data verification device preferably has a data verification device input interface for feeding the resulting data to a data processing device of the data verification device for detecting malware in the resulting data. This embodiment is particularly suitable as the separate input interface can be configured exclusively for feeding the data to the data checking device.

Preferably, the data verification device has a data verification device output interface for outputting the resulting data verified by the data processing device of the data verification device and/or for outputting a verification result. This embodiment is particularly suitable because the data can be transferred to other devices through this interface after verification.

According to a preferred embodiment of the present invention, the data verification device input interface for forwarding digital signals and/or data is preferably connected to the data verification device input interface exclusively via the data processing device of the data verification device.

According to a preferred embodiment of the present invention, the data processing device of the data verification device comprises at least one CPU and/or GPU. This embodiment is particularly suitable, since a CPU or GPU is suitable for executing common methods for checking data.

According to a preferred embodiment of the present invention, the data checking device is configured or designed as a processor device for controlling the functions of the data checking device and/or for effecting data exchange with at least one further device, in particular a working system and/or a control system and/or a data backup and/or provision device logic gate device and/or the passivating device and/or the providing device and/or a passivating and providing unit. The control system can be designed as an intermediate device or communication device between the working system and the data backup and/or provisioning device.

This design is particularly suitable as it allows control functions to be triggered directly on the basis of the results determined in the data checking device.

According to a preferred embodiment of the present invention, the data verification device as a data processing device comprises at least one data verification logic gate and wherein the at least one data verification logic gate is configured to detect malware in the resulting data. This embodiment is particularly suitable, since the logic gate used can, by its nature, only perform the data verification desired by it and thus there is no possibility of attack by malware.

According to a preferred embodiment of the present invention, the data verification device input interface for forwarding digital signals is connected to the data verification device output interface exclusively via the at least one data verification logic gate. That is, the resulting digital data is processed or verified by the at least one data verification logic gate before being passed to the data verification device output interface. This embodiment is particularly suitable as it ensures that the resulting digital data must have passed through a data verification logic gate at least once before reaching the output interface.

According to a preferred embodiment of the present invention, the data verification logic gate, depending on a verification result of the resulting data, in particular the concrete resulting data file, sends a signal to the passivating and providing unit and the passivating and providing unit marks the resulting data, in particular the concrete resulting data file, as contaminated or not contaminated or assigns it to a storage area intended for contaminated resulting data, in particular contaminated resulting data files, in particular the specific resulting data file, as contaminated or uncontaminated or assigns it to a storage area which is intended for contaminated resulting data, in particular contaminated resulting data files, or assigns it to a storage area which is intended for uncontaminated resulting data, in particular contaminated resulting data files. In the context of the present invention, contaminated means that code representing malware is part of the respective data. In this context, malware may include, for example, Trojans, in particular encryption Trojans, and/or viruses. This embodiment is particularly suitable because it isolates resulting data that has already been positively checked for known malicious code and cannot reach the other units independently.

According to a preferred embodiment of the present invention, the data processing device of the data verification device comprises at least one data verification logic gate, wherein the data verification device comprises a data verification device data memory, wherein malware representation data is provided in the data verification device data memory. This embodiment is particularly suitable, since this malware representation data can be used for partial or complete comparison with the resulting data by the data processing device of the data verification device.

According to a preferred embodiment of the present invention, the malware representation data can be updated by means of an update device. This embodiment is particularly suitable, as the stored malware representation data can be supplemented with newly recognized malware representation data.

The update device can be supplied with updates directly from a server device or indirectly via the control device and/or the working system. The update supply is preferably encrypted and the updates are preferably stored on a data storage device or part of a data storage device that is technically, in particular physically, separated from the remaining data storage devices, i.e. not directly connected to each other.

According to a preferred embodiment of the present invention, the malware representation data of a malware has a malware representation data binary sequence, wherein the malware representation data binary sequence is different from the binary sequence of the malware. This embodiment is particularly suitable, as no actual malware can be generated from the malware representation data.

According to a preferred embodiment of the present invention, the malware representation data binary sequence is longer than the malware binary sequence, in particular the malware representation data binary sequence is longer than the malware binary sequence by at least a factor of 1.2 or a factor of 1.6 or a factor of 2 or a factor of 4 or a factor of 8.

Additionally or alternatively, according to a preferred embodiment of the present invention, all contiguous bit sequences of the malware representation data binary sequence having a length of at least 0.001%, in particular at least 1% or preferably at least 10% or most preferably at least 20%, of the total length of the malware representation data binary sequence are different from all contiguous bit sequences of the malware representation data binary sequence having a length of at least 0.001%, in particular at least 1% or preferably at least 10% or most preferably at least 20%, of the total length of the malware representation data binary sequence.

In addition or alternatively, according to a preferred embodiment of the present invention, contiguous bit sequences of the malware representation data binary sequence having a length of at least 32 bits, in particular at least 64, at least 128, at least 256 or at least 512 bits, are different from all contiguous bit sequences of the malware representation data binary sequence having a length of at least 32 bits, in particular at least 64, at least 128, at least 256 or at least 512 bits. This embodiment is particularly suitable, as no actual malware and no malicious code parts can be generated from the malware representation data.

According to a preferred embodiment of the present invention, the data verification logic gate is connected to the data verification device data memory by data technology, in particular for readout.

This embodiment is particularly suitable, since a check can be carried out directly from the memory by means of the logic gate.

According to a preferred embodiment of the present invention, the data verification device data memory comprises at least one lookup table, wherein the lookup table comprises malware representation data relating to a plurality of malware. This embodiment is particularly suitable as the table provides the malware representation data in a structured form for the data checking device.

According to a preferred embodiment of the present invention, the data checking device is configured to perform a comparison of the malware representation data and the resulting data. This embodiment is particularly suitable, as the data checking device can thus detect a known malware in the resulting data.

According to a preferred embodiment of the present invention, the binary sequence of the original data can be converted into the resulting data according to a first logic and the malware representative data can be generated from the bit sequences of the malware according to the first logic. This embodiment is particularly suitable because neither the original data nor the malware representations are present in the original bit sequence and can be executed.

According to a preferred embodiment of the present invention, the resulting data preferably represents machine-readable character encoding.

According to a preferred embodiment of the present invention, the character encoding is preferably a 2 bit character encoding or a 3 bit character encoding or a 4 bit character encoding or a more than 4 bit, in particular 7, 8 or 18 bit character encoding, in particular American Standard Code for Information Interchange (ASCII) or Indian Script Code for Information Interchange (ISCII) or Tamil Script Code for Information Interchange (TSCII). This embodiment is particularly suitable as the use of readable characters in the resulting data enables simple translation.

According to a preferred embodiment of the present invention, the resulting data preferably represent color values and/or brightness values. This embodiment is particularly suitable, since a very high data transmission rate can be achieved due to the high number of values separated from each other.

According to a preferred embodiment of the present invention, the malware representation data represents a preferably machine-readable character encoding.

According to a preferred embodiment of the present invention, the character encoding is preferably a 2 bit character encoding or at least a 2 bit character encoding or a 3 bit character encoding or a 4 bit character encoding or at least a 4 bit character encoding or a more than 4 bit, in particular 7, 8 or 18 bit character encoding, in particular American Standard Code for Information Interchange (ASCII) or Indian Script Code for Information Interchange (ISCII) or Tamil Script Code for Information Interchange (TSCII). This embodiment is particularly suitable, as the use of readable characters enables a character-by-character comparison of the malware representation data with the resulting data.

According to a preferred embodiment of the present invention, the malware representation data represents color values and/or brightness values. This embodiment is particularly suitable because, in addition to the character-by-character comparison, an optical comparison of the malware representation data with the resulting data can also be performed.

According to a preferred embodiment of the present invention, the resulting data can be deleted in the event that the presence of malware or a defined group of malware or a defined probability for the presence of malware can be determined by the verification resulting. This design is particularly suitable, since further use or storage is unnecessary if the resulting data is infected with an already known malware.

According to a preferred embodiment of the present invention, the data checking device comprises a data checking communication interface, wherein the data checking communication interface is connected by means of a unidirectional data connection, in particular by means of at least or exactly one optical fiber, to the working system or the control device for transmitting status data of the data checking device. This embodiment is particularly suitable, since the working system or the control device can thus be informed of the status of the submitted data and of the processing system without any data transmission taking place beyond the status data.

The status data preferably includes the memory utilization, the power utilization, the number of files stored in the data verification device data memory and/or the names of the files stored in the data verification device data memory and/or documentation of executed commands.

This embodiment is particularly suitable, as no further unauthorized data can be transmitted due to the defined parameters in the structure of the status data.

According to a preferred embodiment of the present invention, the data verification device, in particular at least the data verification logic gate, is a part of the Data backup and/or provisioning device-Logic gate device, in particular Field Programmable Gate Array (FPGA) or application-specific integrated circuit (ASIC) or Complex Programmable Logic Device (CPLD) or Simple Programmable Logic Device (SPLD). This design is particularly suitable, as the execution of the data checking device on a logic gate optimally exploits its strength in the redundant execution of complex logic.

According to a preferred embodiment of the present invention, the data checking device is part of a data checking unit.

According to a preferred embodiment of the present invention, a data verification unit output interface of the data verification unit is connected to a reactivation device input interface of the reactivation device.

According to a preferred embodiment of the present invention, a providing unit output interface of the passivating and providing unit is connected to the data verification device input interface for transmitting the resulting data.

According to a preferred embodiment of the present invention, a providing unit output interface of the passivating and providing unit is directly connected to the data verification device input interface.

According to a preferred embodiment of the present invention, a providing unit output interface of the passivating and providing unit is directly connected to the data verification device input interface via a unidirectional conductor, in particular optical fiber.

According to a preferred embodiment of the present invention, a providing device output interface of the providing device is connected to the data verification device input interface for transmitting the resulting data.

According to a preferred embodiment of the present invention, a providing device output interface of the providing device is directly connected to the data verification device input interface.

According to a preferred embodiment of the present invention, a providing device output interface of the providing device is directly connected to the data verification device input interface via a unidirectional conductor, in particular optical fiber.

According to a preferred embodiment of the present invention, the data checking device is a component of the passivating and providing unit. This embodiment is particularly suitable because the combination of the various devices on a logic gate maximizes the transmission speed, especially between the individual devices.

According to a preferred embodiment of the present invention, the reactivation device comprises at least one data processing device and wherein the at least one data processing device is configured to convert the resulting digital data into the target digital data.

According to a preferred embodiment of the present invention, the reactivation device input interface for forwarding digital signals is preferably connected to the reactivation device output interface exclusively via the data processing device.

According to a preferred embodiment of the present invention, the reactivation device data processing device comprises at least one CPU and/or GPU and wherein the at least one CPU and/or GPU is configured to convert the resulting digital data into the target digital data.

According to a preferred embodiment of the present invention, the target data can be executed and/or analyzed by the reactivation device data processing device in a sandbox.

According to a preferred embodiment of the present invention, the reactivation device input interface is connected to a data processing device of the reactivation device, in particular a reactivation logic gate, and/or a reactivation device data memory of the reactivation device, wherein the resulting data can be converted into the target data by the data processing device of the reactivation device and/or can be analyzed with regard to malware.

According to a preferred embodiment of the present invention, the reactivation device data memory is formed by at least a first reactivation device data memory and a second reactivation device data memory, wherein the first reactivation device data memory and the second reactivation device data memory are connected to each other in terms of data technology exclusively via at least one unidirectionally acting element, in particular the reactivation logic gate. This means that the target data, even if it contains malware, does not have a return channel from the second reactivation device data memory to the first reactivation device data memory for manipulating the data stored on the first reactivation device data memory.

According to a preferred embodiment of the present invention, the reactivation device data processing device comprises at least one reactivation logic gate and wherein the at least one reactivation logic gate is configured to convert the resulting digital data into the target digital data.

According to a preferred embodiment of the present invention, the reactivation device input interface for forwarding digital signals is connected to the reactivation device output interface exclusively via the at least one reactivation logic gate.

According to a preferred embodiment of the present invention, the first reactivation device data memory for providing the resulting data is functionally arranged before the reactivation logic gate and the second reactivation device data memory is functionally arranged after the reactivation logic gate for storing the target data. The first reactivation device data memory and the second reactivation device data memory may be physically separate data memories or a data memory with physically separate partitions.

According to a preferred embodiment of the present invention, the reactivation device may comprise a CPU and/or GPU or at least one CPU and/or GPU when the reactivation data processing device is the at least one reactivation logic gate, wherein the CPU and/or GPU is configured to execute and/or analyze the target data in a sandbox, in particular to analyze with respect to malware.

According to a preferred embodiment of the present invention, the reactivation device comprises an update device for updating malware identification data, wherein the CPU and/or GPU is configured to analyze the target data using updated malware identification data.

According to a preferred embodiment of the present invention, the reactivation device has a Reactivation device communication interface, wherein the reactivation device communication interface is connected to the working system or the control device by means of a unidirectional data connection, in particular by means of at least or exactly one optical fiber, for transmitting status data of the reactivation device.

The status data preferably includes the memory utilization, the power utilization, the number of files stored in the reactivation device data memory and/or the names of the files stored in the reactivation device data memory and/or documentation on executed commands.

According to a preferred embodiment of the present invention, the reactivation device, in particular at least the reactivation logic gate, is a part of the data backup and provision device logic gate device, in particular Field Programmable Gate Array (FPGA) or Application Specific Integrated Circuit (ASIC) or Complex Programmable Logic Device (CPLD) or Simple Programmable Logic Device (SPLD).

According to a preferred embodiment of the present invention, the providing device output interface is connected to the Reactivation device input interface.

According to a preferred embodiment of the present invention, a providing unit output interface of the passivating and providing unit is connected to the reactivation device input interface for transmitting the resulting data.

According to a preferred embodiment of the present invention, a providing unit output interface of the passivating and providing unit is directly connected to the reactivation device input interface.

According to a preferred embodiment of the present invention, a providing unit output interface of the passivating and providing unit is directly connected to the reactivation device input interface via a unidirectional conductor, in particular optical fiber.

According to a preferred embodiment of the present invention, a providing device output interface of the providing device is connected to the reactivation device input interface for transmitting the resulting data.

According to a preferred embodiment of the present invention, a providing device output interface of the providing device is directly connected to the reactivation device input interface.

According to a preferred embodiment of the present invention, a providing device output interface of the providing device is directly connected to the reactivation device input interface via a unidirectional conductor, in particular optical fiber.

According to a preferred embodiment of the present invention, a data verification device output interface of the data verification device is connected to the reactivation device input interface for transmitting the resulting data.

According to a preferred embodiment of the present invention, a data verification device output interface of the data verification device is directly connected to the reactivation device input interface.

According to a preferred embodiment of the present invention, a data verification device output interface of the data checking device is directly connected to the reactivation device input interface via a unidirectional conductor, in particular an optical fiber.

According to a preferred embodiment of the present invention, a data verification unit output interface of the data verification unit is connected to the reactivation device input interface for transmitting the resulting data.

According to a preferred embodiment of the present invention, a data verification unit output interface of the data verification unit is directly connected to the Reactivation device input interface.

According to a preferred embodiment of the present invention, a data verification unit output interface of the data verification unit is directly connected to the reactivation device input interface via a unidirectional conductor, in particular an optical fiber.

According to a preferred embodiment of the present invention, a providing device control logic gate part is provided. According to a preferred embodiment of the present invention, the providing device control logic gate part is configured to convert original providing device control data into providing device control resulting data.

According to a preferred embodiment of the present invention, a providing device control resulting data output is provided for outputting the providing device control resulting data.

According to a preferred embodiment of the present invention, the original providing device control data can be provided by the working system or the control device.

According to a preferred embodiment of the present invention, a reactivation device drive logic gate part is provided. According to a preferred embodiment of the present invention, the reactivation device control logic gate part is configured to convert original reactivation device control data into reactivation device control output data.

According to a preferred embodiment of the present invention, a reactivation device control output data output is provided for outputting the reactivation device control output data.

According to a preferred embodiment of the present invention, a reactivation device actuation data input is provided for supplying the reactivation device actuation original data.

According to a preferred embodiment of the present invention, the original reactivation device operating data can be provided by the working system or the control device.

According to a preferred embodiment of the present invention, a data verifier drive logic gate part is provided. According to a preferred embodiment of the present invention, the data verification device operating logic gate part is configured to convert original data verification device operating resulting data into data verification device operating resulting data.

According to a preferred embodiment of the present invention, a data checking device operating data output for outputting the data verification device operating resulting data is provided.

According to a preferred embodiment of the present invention, a data verifier drive data input for supplying the data verifier drive original data is provided.

According to a preferred embodiment of the present invention, the data verification device control original data is provided by the working system or the control device.

The above-mentioned task is additionally or alternatively also solved by a control system for controlling at least one digital subsystem via a network, in particular the Internet, the digital subsystem having a data input interface, the data input interface being connected to the network on the one hand and being connected to a control logic gate on the other hand, wherein the control logic gate is configured to generate defined control signals or control data in dependence on control original data supplied to the data input interface via the network, wherein the bit sequence of the control original data is preferably different from the bit sequence of the control signals or control data.

According to a preferred embodiment of the present invention, the digital subsystem has at least one unidirectional data line channel, in particular an optical fiber, for outputting status data.

According to a preferred embodiment of the present invention, control data for controlling the subsystem can be supplied to the subsystem exclusively via the control logic gate.

According to a preferred embodiment of the present invention, the status data can be output to the network exclusively via the unidirectional data line channel.

According to a preferred embodiment of the present invention, the subsystem is a robot or a robotic device.

According to a preferred embodiment of the present invention, the subsystem is a router, in particular a network router, in particular an Internet router.

According to a preferred embodiment of the present invention, the subsystem is a vehicle, in particular a car or a truck or an airplane or a construction vehicle, in particular an excavator or a concrete mixing vehicle or a grading roller, or a helicopter or a boat or a two-wheeler, in particular a motorcycle or scooter or a bicycle, in particular an eBike, or a rail-bound vehicle, in particular a train.

According to a preferred embodiment of the present invention, the subsystem is one or more actuators, in particular motor(s), in particular electric and/or pneumatic and/or hydraulic and/or motors operable by means of combustion processes, and/or for one or more water supply device(s) and/or a factory, in particular for the production of chemical base materials, refinery or waste incineration or food production or drug/vaccine production, or several factories and/or one medical device 148 or several medical devices and/or one communication device or several communication devices and/or one energy supply device, in particular a solar power plant, coal-fired power plant, wind power plant, gas-fired power plant, nuclear power plant, hydroelectric power plant or tidal power plant, or several energy supply devices and/or one production device, in particular an industrial robot, or several production devices.

According to a further preferred embodiment of the present invention, the control system according to the invention has a passivation system for converting digital control original data into digital control resulting data. The passivation system can be taken, for example, from patent application PCT/EP2022/059665 and is described there in detail and is used according to the present invention to form an additional or alternative communication channel for controlling the respective function processor device and/or for transmitting status data to the working system or a control device. The digital control resulting data preferably represents the digital control original data in a non-executable state and is used to control the function processor device, wherein the digital control original data represents a bit combination of digital original data, in particular a digital file or a digital data stream. Preferably, at least one drive data processor is provided for generating a plurality of different analog signals of a drive representative type in dependence on digital drive original data, wherein the digital drive original data represents a plurality of different input commands from at least one input device, wherein the plurality of different input commands of the digital drive original data are represented by a plurality of different analog signals of the drive representative type, wherein the plurality of different analog signals of the drive representation type can preferably be generated in several, in particular at least four, different states, wherein several or each analog signal of the drive representation type of the plurality of different analog signals of the drive representation type represents a defined input command, in particular directly or indirectly, said drive data processor having at least one data interface for receiving said digital drive original data, said drive data processor having at least one signal output for outputting said analog signals of said drive representative type, a drive input signal processor for converting said analog signals of said drive representative type into said digital resulting drive data for manipulating said digital drive resulting data, said drive input signal processor comprising at least one signal input for receiving the analog signals of the drive representative type output via said at least one signal output of said drive data processor, said digital drive resulting data being a digital representation of at least a part of said analog signals of the drive representative type, said drive input signal processor being at least indirectly coupled to a function processor means for executing or effecting at least one function and preferably a plurality of functions.

According to a further preferred embodiment of the present invention, the control of the function processor device for executing at least one defined function and preferably a plurality of different functions can be effected as a function of the digital control resulting data.

According to a further preferred embodiment of the present invention, the digital control resulting data can be generated for defined analog signals of the control representative type.

According to a further preferred embodiment of the present invention, the defined analog signals of the control representative type are assigned to or represent the defined function or functions of the function processor device.

According to another preferred embodiment of the present invention, a function output signal processing processor is provided for generating a plurality of different analog signals of the function processing type for mapping the driving of the function processor device.

According to a further preferred embodiment of the present invention, the plurality of different analog signals can be generated in at least four mutually different states.

According to a further preferred embodiment of the present invention, a function data processing processor is provided for generating visualization data for visualizing a function processor control visualization, in particular a function processor control mask.

According to a further preferred embodiment of the present invention, the function processor control visualization can be generated as a function processor control mask.

According to a further preferred embodiment of the present invention, the function processor control visualization is at least partially generatable in response to the analog signals of the function processing type generated by the function output signal processing processor.

According to a further preferred embodiment of the present invention, manipulation of the function processor control visualization can be effected by the at least one input device.

According to a further preferred embodiment of the present invention, the digital control original data can be generated depending on the manipulation of the function processor control visualization.

According to a further preferred embodiment of the present invention, the function processor control visualization and the control data processing processor are at least indirectly connected to each other via the data interface.

According to a further preferred embodiment of the present invention, the plurality of different analog signals of a bit part combination representative type comprises at least four different analog signals of the bit part combination representative type.

According to another preferred embodiment of the present invention, the plurality of different analog signals of the bit part combination representation type comprises at least thirty-two different analog signals of the bit part combination representation type.

According to a further preferred embodiment of the present invention, the drive original data processing processor has at least one signal output for generating the plurality of different analog signals of the bit part combination representation type, wherein the signal output can be supplied with a plurality of different combinations of at least voltage and current.

According to a further preferred embodiment of the present invention, the different combinations of at least voltage and current are analog single signals or modulated multiple signals.

According to a further preferred embodiment of the present invention, the driving original data processing processor for generating the plurality of different analog signals of the bit part combination representation type has a plurality of signal outputs which can be driven independently of each other, wherein at least a plurality of signal outputs can each be supplied with a plurality of different combinations of voltage and current by the driving original data processing processor.

According to a further preferred embodiment of the present invention, a plurality of different combinations of voltage and current per signal output comprises at least sixteen combinations.

According to a further preferred embodiment of the present invention, a plurality of different combinations of voltage and current per signal output comprises at least thirty-two different combinations.

According to a further preferred embodiment of the present invention, at least several of the independently controllable signal outputs can be controlled simultaneously to generate one analog signal each or at least several of the independently controllable signal outputs can be controlled simultaneously to generate a modulated analog signal.

According to a further preferred embodiment of the present invention, the digital control resulting data comprises a control resulting data format and the digital original data comprises a original data format, wherein the original data format and the control resulting data format are different.

According to a further preferred embodiment of the present invention, the input signal processing processor has at least one input signal processing processor output for outputting the digital drive resulting data.

According to a further preferred embodiment of the present invention, the input signal processing processor output is coupled to a storage medium for digitally storing the digital drive resulting data.

According to a further preferred embodiment of the present invention, there is preferably no digital data connection between the storage medium and the drive original data processor for transmitting digital drive original data.

According to another preferred embodiment of the present invention, the input signal processing processor and the driving original data processing processor are arranged on a circuit board.

According to another preferred embodiment of the present invention, the path of the analog signals of the bit part combination representation type from the driving original data processing processor to the input signal processing processor is shorter than 100 cm or shorter than 20 cm or shorter than 50 mm or shorter than 10 mm or shorter than 5 mm.

According to a further preferred embodiment of the present invention, the triggering original data is original reactivation device operating data and/or original data verification device operating data and/or original providing device operating data, in which case this data is not generated by a logic gate but results from the analog signals.

According to another preferred embodiment of the present invention, the control resulting data is data verification device operating resulting data and/or providing device control resulting data and/or reactivation device control resulting data.

According to a further preferred embodiment of the present invention, the function processor device is the data checking device and/or the providing device and/or the reactivation device and/or the logic gate device, in particular according to claim 86.

The above task is additionally or alternatively solved by a logic gate device, in particular an FPGA device, in particular precisely an FPGA. The logic gate device preferably comprises: At least one passivating logic gate part, wherein the at least one passivating logic gate part is configured to convert original digital data into resulting digital data, wherein the resulting data represents a passivated form of the original data. Passivated in this context means that the resulting data cannot be executed accordingly with respect to the original data.

According to a preferred embodiment of the present invention, a providing device data feed output is provided for outputting the resulting data to a providing device.

According to a preferred embodiment of the present invention, the logic gate device preferably comprises a providing device drive logic gate part. According to a preferred embodiment of the present invention, the providing device control logic gate part is configured to convert original providing device control data into providing device control resulting data.

According to a preferred embodiment of the present invention, a providing device control resulting data output is provided for outputting the providing device control resulting data.

According to a preferred embodiment of the present invention, the logic gate device preferably comprises a reactivation logic gate part. According to a preferred embodiment of the present invention, the reactivation logic gate part is configured to convert the resulting data into target data.

According to a preferred embodiment of the present invention, the logic gate device preferably has a reactivation device data feed output for outputting the target data to a reactivation device.

According to a preferred embodiment of the present invention, the logic gate device preferably has a reactivation device data feed input for feeding the resulting data.

According to a preferred embodiment of the present invention, the logic gate device preferably comprises a reactivation-device-control-logic-gate-part.

According to a preferred embodiment of the present invention, the logic gate device preferably has the reactivation device operating logic gate part configured to convert original reactivation device operating data into reactivation device operating output data.

According to a preferred embodiment of the present invention, a reactivation device control output data output is provided for outputting the reactivation device control output data.

According to a preferred embodiment of the present invention, a reactivation device actuation data input is provided for supplying the reactivation device actuation original data.

According to a preferred embodiment of the present invention, at least one data verification logic gate part is provided. According to a preferred embodiment of the present invention, the at least one data verification logic gate is configured to analyze resulting digital data with respect to malware.

According to a preferred embodiment of the present invention, the data validation logic gate part compares representative information, in particular binary sequences or parts of the binary sequences of the malware, of malware with the binary sequence or parts of the binary sequence of the original data held in a lookup table.

According to a preferred embodiment of the present invention, the data verification logic gate part is configured to convert the resulting data into the original data in a first step and then effect the comparison with the representation information held in the lookup table.

According to a preferred embodiment of the present invention, a data validation logic gate part output or each data validation logic gate part output via which the original data generated from the resulting data can be output to an original data memory and/or the original data memory is physically separated from the providing device data memory and/or the reactivation device data memory, in particular in such a way that malware cannot reach the providing device data memory and/or the reactivation device data memory.

According to a preferred embodiment of the present invention, the original data generated by the data verification logic gate part is deleted after the comparison, and preferably the memory area on which the data was provided is formatted.

According to a preferred embodiment of the present invention, matching data is generated as a function of the matching result, the matching data being assigned to the corresponding resulting data provided in the providing device or the corresponding resulting data being supplemented by the matching data.

According to a preferred embodiment of the present invention, the matching data comprises information on the embodiment of the representation information and/or the matching result.

According to a preferred embodiment of the present invention, the data validation logic gate part compares binary sequences of malware resulting data held in a lookup table with the binary sequence of the resulting data.

According to a preferred embodiment of the present invention, the binary sequences of malware resulting data provided in the lookup table are generated from malware original data according to the conversion of the original data into the resulting data.

According to a preferred embodiment of the present invention, the logic gate apparatus comprises a data verifier drive logic gate part. According to a preferred embodiment of the present invention, the data verification device operating logic gate part is configured to convert original data verification device operating resulting data into data verification device operating resulting data.

According to a preferred embodiment of the present invention, a data checking device operating data output for outputting the data verification device operating resulting data is provided.

According to a preferred embodiment of the present invention, a data verification device operating data input for supplying the original data verification device operating data is provided.

According to a preferred embodiment of the present invention, one or more FPGAs are provided.

According to a preferred embodiment of the present invention, at least two or exactly two or at least three or exactly three or at least four or exactly four of the logic gates: passivation logic gate part, providing device control logic gate part, reactivation logic gate part, reactivation device control logic gate part, data verification logic gate part and/or data verification device control logic gate part are formed by an FPGA.

According to a preferred embodiment of the present invention, at least two or exactly two or at least three or exactly three or at least four or exactly four of the logic gates: passivation logic gate part, providing device logic control gate part, reactivation logic gate part, reactivation device logic control gate part, data verification logic gate part and/or data verification device logic control gate part are each formed by an FPGA.

According to a preferred embodiment of the present invention, at least two or exactly two or at least three or exactly three or at least four or exactly four of the logic gates: passivation logic gate part, providing device logic control gate part, reactivation logic gate part, reactivation device logic control gate part, data verification logic gate part and/or data verification device logic control gate part are each formed by a plurality of FPGAs.

According to a further preferred embodiment of the present invention, the passivation logic gate part is configured to define or provide or determine or generate different zero binary sequence representations and/or ones binary sequence representations, in particular different combinations of zero binary sequence representations and/or ones binary sequence representations, for original data of a file.

According to a further preferred embodiment of the present invention, the passivation logic gate part executes an algorithm for predetermining or generating or determining the zero binary sequence representations and/or the ones binary sequence representations, or the passivation logic gate part executes a random algorithm for randomly determining or generating or determining the zero binary sequence representations and/or the ones binary sequence representations, or one or more look-up tables with a plurality of predetermined zero-ones binary sequence representations and/or the ones binary sequence representations are provided. Binary sequence representations and/or the ones binary sequence representations, or one or more look-up tables with a plurality of fixed zeros-ones binary sequence representation combinations are provided and the passivation logic gate part is arranged to select different zeros-ones binary sequence representation combinations, in particular randomly, wherein the one zeros-ones binary string representation combination is selected by the passivation logic gate part, in particular randomly, wherein the one look-up table or the plurality of look-up tables comprises at least 10, in particular at least 100 and preferably at least 1000 and particularly preferably more than 3000 and most preferably more than 5000 or 10000, different zeros-ones binary string representation combinations.

According to a further preferred embodiment of the present invention, the passivation logic gate part is configured to generate resulting data with respect to the original data of a file, wherein the resulting data is generatable with a plurality of zero binary sequence representations different from each other, wherein the zero binary sequence representations different from each other have bit sequences of different lengths and/or different bit sequences of the same length.

According to a further preferred embodiment of the present invention, the passivation logic gate part is configured to generate resulting data with respect to the original data of a file, wherein the resulting data is generatable with a plurality of ones binary sequence representations different from each other, wherein the ones binary sequence representations different from each other have bit sequences of different lengths and/or different bit sequences of the same length.

According to a further preferred embodiment of the present invention, the passivation logic gate part is configured to generate resulting data with respect to the original data of a file, wherein the resulting data is generatable with a plurality of ones binary sequence representations different from each other, wherein the ones binary sequence representations different from each other have bit sequences of different lengths and/or different bit sequences having the same length, and wherein the passivation logic gate part is configured to generate the resulting data with a plurality of zeros binary sequence representations different from each other, wherein the zeros binary sequence representations have bit sequences of different lengths and/or different bit sequences having the same length, to generate the resulting data with a plurality of zero binary sequence representations different from each other, wherein the zero binary sequence representations different from each other have bit sequences of different lengths and/or different bit sequences of the same length, wherein the bit sequences of the resulting data for the zero binary sequence representations and the ones binary sequence representations are different from each other.

According to a further preferred embodiment of the present invention, the passivation logic gate part is configured to generate representation data for the resulting data, wherein the representation data indicates which zero binary sequence representations and/or ones binary sequence representations the resulting data, in particular the respective concrete resulting data file, has.

According to a further preferred embodiment of the present invention, the representation data indicates which zero binary sequence representations and/or which ones binary sequence representations form the resulting data at which position of the resulting data.

According to another preferred embodiment of the present invention, the representation data identifies a first ones binary sequence representation having a first bit length in a first number for replacing the first number of ones of the original data and the representation data identifies a second ones binary sequence representation having a second bit length in a second number for replacing the second number of ones of the original data, wherein the first number of ones of the original data comprises more than two consecutive ones or more than 10 consecutive ones or more than 100 consecutive ones of the original data or preferably up to 10,000 consecutive ones and wherein the second number of ones of the original data comprises more than two consecutive ones or more than 10 consecutive ones or more than 100 consecutive ones of the original data or preferably up to 10,000 consecutive ones, wherein the first number and the second number are different from each other or wherein the first number and the second number are the same.

According to another preferred embodiment of the present invention, the representation data identifies a first zero binary sequence representation having a first bit length in a first number for replacing the first number of zeros of the original data and the representation data identifies a second zero binary sequence representation having a second bit length in a second number for replacing the second number of ones of the original data, wherein the first number of zeros of the original data comprises more than two consecutive zeros or more than 10 consecutive zeros or more than 100 consecutive zeros of the original data or preferably up to 10,000 consecutive zeros and wherein the second number of zeros of the original data comprises more than two consecutive zeros or more than 10 consecutive zeros or more than 100 consecutive zeros of the original data or preferably up to 10,000 consecutive zeros, wherein the first number and the second number are different from each other or wherein the first number and the second number are the same.

According to a further preferred embodiment of the present invention, the number of different zero binary sequence representations and the number of different ones binary sequence representations per resulting data, in particular per resulting data set or resulting data file, is the same or different.

According to a further preferred embodiment of the present invention, the representation data can be generated as part of the resulting data.

According to a further preferred embodiment of the present invention, the representation data can be generated as a separate data set associated with the resulting data.

According to a further preferred embodiment of the present invention, the Reactivation device, in particular one or at least one logic gate, in particular an FPGA or ASIC, is configured to effect the conversion of the resulting data into the target data (22) depending on the representation data.

Additionally or alternatively, the present invention may also relate to a method for securing data and preferably for providing data. The method preferably comprises at least the step of: Converting original digital data into resulting digital data by means of a passivation device, wherein the passivation device comprises at least one passivation logic gate, and wherein the at least one passivation logic gate is configured to convert the original digital data into the resulting digital data and to generate the resulting digital data, wherein the passivation device comprises a passivation device input interface for supplying the original data to the at least one passivation logic gate, and wherein the passivation device comprises a passivation device output interface for outputting the resulting data generated by the at least one passivation logic gate, wherein the original digital data is defined by a first binary sequence, wherein the first binary sequence and the second binary sequence are different from each other.

Additionally or alternatively, the method preferably also comprises the step of converting the resulting data into target data by means of a reactivation device, wherein the reactivation device comprises a reactivation device input interface for supplying the resulting data to the reactivation device and preferably a reactivation device output interface for outputting the target data, wherein the target data preferably matches the original data by at least 90% or at least 95% or at least 99% or at least 99.9% or exactly 100%.

According to a preferred embodiment of the present invention, the passivation logic gate is configured to generate zero binary sequence representations for zeros of the first binary sequence of the original digital data, and wherein the passivation logic gate is configured to generate ones binary sequence representations for ones of the first binary sequence of the original digital data.

According to a preferred embodiment of the present invention, the zero binary sequence representation has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a preferred embodiment of the present invention, the ones binary sequence representation has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a preferred embodiment of the present invention, the passivation logic gate is configured to define or provide or determine or generate different zero binary sequence representations and/or ones binary sequence representations for different original data, in particular different files, in particular original data to be processed successively.

For generating resulting data, the passivation logic gate according to a preferred embodiment of the present invention is configured to define or provide or determine or generate different zero binary sequence representations and/or ones binary sequence representations for original data of a file, in particular the first binary sequence.

According to a preferred embodiment of the present invention, the passivation logic gate executes an algorithm for predetermining or generating or determining the zero binary sequence representations and/or the ones binary sequence representations. Additionally or alternatively, the passivation logic gate executes a random algorithm for randomly determining or generating or determining the zero binary sequence representations and/or the ones binary sequence representations. In addition or alternatively, a look-up table or several look-up tables with a plurality of fixed zeros-ones binary string representation combinations is/are provided and the passivation logic gate is preferably set up to select different zeros-ones binary string representation combinations, in particular randomly, wherein the one look-up table or the plurality of look-up tables comprises at least 10, in particular at least 100 and preferably at least 1000 and particularly preferably more than 3000 and most preferably more than 5000 or 10000, different zeros-ones binary string representation combinations.

According to a preferred embodiment of the present invention, the one look-up table or the plurality of look-up tables comprise zeros-ones binary string representation combinations, wherein the zeros-ones binary string representation combinations comprise zeros-bit representations and ones-bit representations, wherein at least individual zeros-bit representations of the zeros-ones binary string representation combinations each comprise a first number of bits, and wherein at least individual ones-bit representations of the zeros-ones binary string representation combinations each have a second number of bits, wherein the first number of bits and the second number of bits are the same at least in the case of individual zeros-ones binary string representation combinations and/or wherein the first number of bits and the second number of bits are different at least in the case of individual zeros-ones binary string representation combinations.

According to a preferred embodiment of the present invention, the look-up table or tables is/are provided or stored or deposited in a memory device of the passivation device.

According to a preferred embodiment of the present invention, the passivation logic gate is configured to generate resulting data with respect to the original data of a file, wherein the resulting data is generated with a plurality of zero binary sequence representations different from each other, wherein the zero binary sequence representations different from each other have bit sequences of different lengths and/or different bit sequences of the same length.

According to a preferred embodiment of the present invention, the passivation logic gate is configured to generate resulting data with respect to the original data of a file, wherein the resulting data is generated with a plurality of ones binary sequence representations different from each other, wherein the ones binary sequence representations different from each other have bit sequences of different lengths and/or different bit sequences of the same length.

According to a preferred embodiment of the present invention, the passivation logic gate is configured to generate resulting data with respect to the original data of a file, wherein the resulting data is generated with a plurality of ones binary sequence representations different from each other, wherein the ones binary sequence representations different from each other have bit sequences of different lengths and/or different bit sequences of the same length, and wherein the passivation logic gate is configured to generate the resulting data with a plurality of ones binary sequence representations different from each other, wherein the ones binary sequence representations different from each other have bit sequences of different lengths and/or different bit sequences of the same length, to generate the resulting data with a plurality of zero binary sequence representations different from each other, wherein the zero binary sequence representations different from each other have bit sequences of different lengths and/or different bit sequences of the same length, wherein the bit sequences of the resulting data for the zero binary sequence representations and the ones binary sequence representations are different from each other.

According to a preferred embodiment of the present invention, the passivation logic gate is configured to generate representation data for the resulting data or with respect to the resulting data, wherein the representation data indicates which zero binary sequence representations and/or ones binary sequence representations the resulting data, in particular the respective concrete resulting data file, has.

According to a preferred embodiment of the present invention, the representation data indicates which zero binary sequence representations and/or which ones binary sequence representations form the resulting data at which position of the resulting data.

According to a preferred embodiment of the present invention, the representation data identifies a first ones binary sequence representation having a first bit length in a first number for replacing the first number of ones of the original data, and the representation data identifies a second ones binary sequence representation having a second bit length in a second number for replacing the second number of ones of the original data, wherein the first number of ones of the original data comprises more than two consecutive ones or more than 10 consecutive ones or more than 100 consecutive ones of the original data or preferably up to 10,000 consecutive ones, and wherein the second number of ones of the original data comprises more than two consecutive ones or more than 10 consecutive ones or more than 100 consecutive ones of the original data or preferably up to 10,000 consecutive ones, wherein the first number and the second number are different from each other or wherein the first number and the second number are the same.

According to a preferred embodiment of the present invention, the representation data identifies a first zero binary sequence representation having a first bit length in a first number for replacing the first number of zeros of the original data, and the representation data identifies a second zero binary sequence representation having a second bit length in a second number for replacing the second number of ones of the original data, wherein the first number of zeros of the original data comprises more than two consecutive zeros or more than 10 consecutive zeros or more than 100 consecutive zeros of the original data or preferably up to 10,000 consecutive zeros, and wherein the second number of zeros of the original data comprises more than two consecutive zeros or more than 10 consecutive zeros or more than 100 consecutive zeros of the original data or preferably up to 10,000 consecutive zeros, wherein the first number and the second number are different from each other or wherein the first number and the second number are the same.

According to a further preferred embodiment of the present invention, the passivation logic gate is configured to divide the first binary sequence into original data bit sequences, wherein the original data bit sequences comprise a plurality of bits, wherein the plurality of bits comprise one “0” bit or a plurality of “0” bits and one “1” bit or a plurality of “1” bits or “0” bits or “1” bits, and wherein the passivation logic gate is configured to store the number of bits of each original data bit sequence in the representative data, and wherein the passivation logic gate is configured to store the number of bits of each original data bit sequence in the representation data, and wherein the passivation logic gate is configured to store a bit-representation combination for each original data bit sequence in the representation data, in particular to generate or select, wherein each bit representation combination has a zero binary sequence representation or a link to a zero binary sequence representation for all “0” bits of an original data bit sequence and wherein each bit representation combination has a zero binary sequence representation or a link to a zero binary sequence representation for all “1” bits of the same original data bit sequence.binary sequence representation or a link to a ones binary sequence representation, or wherein each bit representation combination has a zeros-ones binary sequence representation combination or a link to a zeros-ones binary sequence representation combination for all “0” bits and “1” bits of an original data bit sequence.

According to a further preferred embodiment of the present invention, the passivation logic gate is configured to divide the first n bits of the first binary sequence into original data bit sequences whose average number of bits is less than 50 bits, in particular less than 20 bits or less than 15 bits, wherein the first n bits are less than 10,000 bits, in particular less than 5,000 bits and preferably less than 1,000 bits and particularly preferably less than 500 bits and most preferably less than 200 bits, and/or the passivation logic gate is configured to divide the last m bits of the first binary sequence into original data bit sequences whose average number of bits is less than 50 bits, in particular less than 500 bits and most preferably less than 200 bits, and/or the passivation logic gate is configured to divide the last m bits of the first binary sequence into original data bit sequences whose average number of bits is less than 50 bits, in particular less than 20 bits or less than 15 bits, the last m bits being less than 10,000 bits, in particular less than 5,000 bits and preferably less than 1,000 bits and particularly preferably less than 500 bits and most preferably less than 200 bits.

According to a further preferred embodiment of the present invention, the passivation logic gate is configured to divide the first n bits of the first binary sequence into original data bit sequences, the number of bits of which is between 2 bits and 50 bits, in particular between 4 bits and 20 bits and preferably between 5 bits and 15 bits, and/or the passivation logic gate is configured to divide the last m bits of the first binary sequence into original data bit sequences whose number of bits is between 2 bits and 50 bits, in particular between 4 bits and 20 bits and preferably between 5 bits and 15 bits.

According to a further preferred embodiment of the present invention, the passivation logic gate is configured to divide the bits between the first n bits, in particular 100 bits, of the first binary sequence and the last m bits, in particular 100 bits, of the first bit sequence into original data bit sequences whose average number of bits is greater than 20 bits, in particular is greater than 50 bits or is greater than 100 bits.

According to a further preferred embodiment of the present invention, the number of different zero binary sequence representations and the number of different ones binary sequence representations per resulting data, in particular per resulting data set or resulting data file, is the same or different.

According to another preferred embodiment of the present invention, the representation data is generated as part of the resulting data.

According to another preferred embodiment of the present invention, the representation data is generated as a separate data set associated with the resulting data.

An analysis unit, in particular for determining or detecting at least one malware signature or malware signature data, is provided, wherein the analysis unit is configured to generate analysis bit representation data and/or a text representation with a text processing device on the basis of resulting data, in particular also on the basis of the representation data assigned or associated with the respective resulting data, wherein the analysis bit representation data represents the first bit sequence in encrypted form or coded form and wherein the analysis bit representation data can be analyzed with respect to malicious code signature data or malware signatures contained in the first bit sequence or with respect to malware signatures or malicious code signature data or malware signatures or malware signatures or malicious code signature data or malware signatures contained in the first bit sequence and/or wherein the text representation can be analyzed with respect to a malicious code signature or malware signature contained in the first bit sequence or with respect to several malicious code signature data or malware signatures or malicious code signatures or malware signatures contained in the first bit sequence.

According to a further preferred embodiment of the present invention, the analysis unit has a processing device, in particular one or at least one logic gate device, such as an ASIC or an FPGA, and/or one or at least one CPU and/or one or at least one GPU, and a processing device 171, in particular a processing editor, in particular a color editor, grayscale editor, and/or character editor.

The processing device may additionally or alternatively be formed as part of the passivation device or the reactivation device.

According to a further preferred embodiment of the present invention, the analysis unit is configured to perform an OCR analysis (“optical character recognition” analysis), wherein the OCR analysis can be used to determine whether the translation of the malware signature is contained in the information, in particular character sequence and/or gray value sequence and/or color value sequence and/or color tone sequence, which can be optically output by means of the zeros analysis bit representation and ones analysis bit representation or the analyzable ones binary sequence representation and the analyzable ones binary sequence representation. gray tone sequence and/or color value sequence and/or color tone sequence.

According to a further preferred embodiment of the present invention, the analysis bit representation data relating to the zeros binary sequence representations of the resulting data, in particular of a resulting data file, comprise a plurality of first bit blocks relating to at least or exactly one zeros analysis bit representation of a normalization system and wherein the analysis bit representation data relating to the ones binary sequence representations of the resulting data, in particular of a resulting data file, comprise a plurality of second bit blocks relating to at least or exactly one ones analysis bit representation of the normalization system. the ones binary sequence representations of the resulting data, in particular of a resulting data file, comprise a plurality of second bit blocks to at least or exactly one ones analysis bit representation of the normalization system.

According to a further preferred embodiment of the present invention, the normalization system has a plurality of different bit blocks, each bit block being assigned a unique comparison parameter.

According to another preferred embodiment of the present invention, the comparison parameter is selected from the following group of comparison parameters: symbols, colors, grayscale, tones and/or patterns.

According to a further preferred embodiment of the present invention, the gray scale or color per bit block can be optically output by means of at least one pixel or several pixels, in particular 2, 3, 4, 5 or up to 10 or more than 10 or up to 200 pixels.

According to a further preferred embodiment of the present invention, 4 or more than 4 or 8 or more than 8 or 16 or more than 16 or 32 or more than 32 or up to 32 or preferably 64 or more than 64 or up to 64 or most preferably 128 or more than 128 or up to 128 or most preferably 256 or more than 256 or up to 256 or more than 512 or up to 512 or more than 1024 or up to 1024 different bit blocks are provided.

According to a further preferred embodiment of the present invention, the symbols are embodied as numbers and/or letters and/or characters, in particular numbers and/or letters and/or characters, in particular according to ASCII code. Additionally or alternatively, Chinese characters may be used.

Additionally or alternatively, in particular sufficiently distinguishable characters from different character systems or characters specially developed for the purpose of the present invention may be used.

An assignment of bit blocks and symbols can look like this for example

| | | | | | |
|---|---|---|---|---|---|
| | | 01000000 | @ | 01100000 | [symbol] |
| 00100001 | ! | 01000001 | A | 01100001 | a |
| 00100010 | [symbol] | 01000010 | B | 01100010 | b |
| 00100011 | # | 01000011 | C | 01100011 | c |
| 00100100 | $ | 01000100 | D | 01100100 | d |
| 00100101 | % | 01000101 | E | 01100101 | e |
| 00100110 | & | 01000110 | F | 01100110 | f |
| 00100111 | [symbol] | 01000111 | G | 01100111 | g |
| 00101000 | ( | 01001000 | H | 01101000 | h |
| 00101001 | ) | 01001001 | I | 01101001 | i |
| 00101010 | [symbol] | 01001010 | J | 01101010 | j |
| 00101011 | + | 01001011 | K | 01101011 | k |
| 00101100 | , | 01001100 | L | 01101100 | l |
| 00101101 | [symbol] | 01001101 | M | 01101101 | m |
| 00101110 | . | 01001110 | N | 01101110 | n |
| 00101111 | / | 01001111 | O | 01101111 | o |
| 00110000 | 0 | 01010000 | P | 01110000 | p |
| 00110001 | 1 | 01010001 | Q | 01110001 | q |
| 00110010 | 2 | 01010010 | R | 01110010 | r |
| 00110011 | 3 | 01010011 | S | 01110011 | s |
| 00110100 | 4 | 01010100 | T | 01110100 | t |
| 00110101 | 5 | 01010101 | U | 01110101 | u |
| 00110110 | 6 | 01010110 | V | 01110110 | v |
| 00110111 | 7 | 01010111 | W | 01110111 | w |
| 00111000 | 8 | 01011000 | X | 01111000 | x |
| 00111001 | 9 | 01011001 | Y | 01111001 | y |
| 00111010 | : | 01011010 | Z | 01111010 | z |
| 00111011 | ; | 01011011 | [ | 01111011 | { |
| 00111100 | < | 01011100 | \ | 01111100 | \| |
| 00111101 | = | 01011101 | ] | 01111101 | } |
| 00111110 | > | 01011110 | \hat{ } | 01111110 | ~ |
| 00111111 | ? | 01011111 | _{—} | 01111111 | DEL |

[symbol]

indicates data missing or illegible when filed

According to a further preferred embodiment of the present invention, the colors are 128 different colors or more than 128 different colors or preferable 256 different colors or more than 256 different colors or 512 different colors or more than 512 different colors.

A mapping of bit blocks and colors is according to another preferred embodiment of the present invention:

| | |
|---|---|
| 0000000 | Color value 1 |
| 0000001 | Color value 2 |
| . . . | |
| 0111111 | Color value 128. |

According to a further preferred embodiment of the present invention, the gray levels are 128 different gray levels or more than 128 different gray levels or preferably 256 different gray levels or more than 256 different gray levels or 512 different gray levels or more than 512 different gray levels.

A mapping of bit blocks and gray levels is according to another preferred embodiment of the present invention:

| | |
|---|---|
| 0000000 | Gray value 1 |
| 0000001 | Gray value 2 |
| . . . | |
| 0111111 | Gray value 128. |

According to a further preferred embodiment of the present invention, the data storage device and preferably the data storage and retrieval device comprises a data memory, wherein data modification and/or data generation on the data memory and/or deletion of data and/or retrieval of data from the data memory is effected by the analysis unit.

According to a further preferred embodiment of the present invention, the passivation device, in particular the passivation logic gate, is configured to randomly predetermine a zeros analysis bit representation with respect to the zeros binary sequence representations of the first binary sequence and the passivation device, in particular the passivation logic gate, is configured to randomly predetermine a ones analysis bit representation with respect to the ones binary sequence representations of the first binary sequence.

According to a further preferred embodiment of the present invention, the passivation device, in particular the passivation logic gate, is configured to generate the specification of the zeros analysis bit representation and the ones analysis bit representation as part of the resulting data and/or as part of the representation data and/or as part of the analysis bit representation data.

According to a further preferred embodiment of the present invention, the analysis unit is configured to randomly define, determine or select at least one or exactly one zeros analysis bit representation for generating the analysis bit representation data relating to the zeros binary sequence representations of the first binary sequence, and the analysis unit is configured to randomly define, determine or select at least one or exactly one ones analysis bit representation for generating the analysis bit representation data relating to the ones binary sequence representations of the first binary sequence.

In accordance with a further preferred embodiment of the present invention, malware signature data is stored, in particular saved, in the data memory. Preferably, the malware signature data can be supplied to the memory by means of a terminal, in particular a keyboard or a camera or a drive, in particular CD, DVD or Blue-ray or USB stick. The terminal is preferably permanently connected to the data backup and/or provisioning device.

According to a further preferred embodiment of the present invention, the malware signature data is provided as malware signature reference data.

In accordance with a further preferred embodiment of the present invention, the analysis unit is configured to use the malware signature reference data to cause the generation of comparison data for comparison with the analysis bit representation data.

According to a further preferred embodiment of the present invention, the analysis unit is configured to use the malware signature reference data or malware reference signature or the malware signature reference data or malware reference signature to generate comparison data for comparison with the analysis bit representation data and/or with the text representation of the bits of the original digital data.

According to a further preferred embodiment of the present invention, the comparison data is generated according to the at least one and preferably exactly one zeros analysis bit representation and according to the at least one or preferably exactly one ones analysis bit representation.

According to a further preferred embodiment of the present invention, the malware signature data is provided as a malware signature comparison table, wherein the analysis unit is configured to select comparison data from the malware signature comparison table for comparison with the analysis bit representation data.

According to a further preferred embodiment of the present invention, the reactivation device, in particular a logic gate, in particular an FPGA or ASIC, is configured to effect the conversion of the resulting data into the target data as a function of the representation data or a part of the representation data or inverse representation data or a part of inverse representation data.

Furthermore, the above-mentioned task can additionally or alternatively be solved by a passivation system. The passivation system is used to convert original digital data into digital output data, the digital output data representing the original digital data in a non-executable or passive state, and preferably to manipulate the digital output data in the non-executable state. The passivation system preferably comprises at least: A data processing device, wherein the data processing device has at least one data input for inputting the original digital data and a data output for outputting the digital output data, wherein the original data is defined by a first binary sequence, wherein the digital output data has resulting data as its content, wherein the resulting data represents the first binary sequence, wherein the data processing device has at least one passivation logic gate between the data input and the data output, in particular Field Programmable Gate Array (FPGA) or Application Specific Integrated Circuit (ASIC) or Complex Programmable Logic Device (CPLD) or Simple Programmable Logic Device (SPLD), wherein the passivation logic gate is configured to generate the digital output data, wherein the digital output data is defined by a second binary sequence, wherein the first binary sequence and the second binary sequence are different from each other.

In the context of the present invention, non-executable means that a file is modified in such a way that malware represented in the binary sequence is modified in such a way that this malware cannot be activated (executed).

According to a preferred embodiment of the present invention, the second binary sequence is longer than the first binary sequence, in particular the second binary sequence is longer than the first binary sequence by at least a factor of 1.2 or a factor of 1.6 or a factor of 2 or a factor of 4 or a factor of 8, and/or all contiguous bit sequences of the first binary sequence having a length of at least 0.001%, in particular at least 1% or preferably at least 10% or most preferably at least 20%, of the total length of the first binary sequence are different from all contiguous bit sequences of the second binary sequence having a length of at least 0,001%, in particular at least 1% or preferably at least 10% or most preferably at least 20%, of the total length of the first binary sequence and/or all contiguous bit sequences of the first binary sequence with a length of at least 32 bits, in particular at least 64 bits, at least 128 bits, at least 256 bits or at least 512 bits, are different from all contiguous bit sequences of the second binary sequence with a length of at least 32 bits, in particular at least 64, at least 128, at least 256 or at least 512 bits.

According to a preferred embodiment of the present invention, the original digital data can be input as an original data file or as an original data stream via the data input and/or the digital output data can be output as a resulting data file or as an output data stream for generating a resulting data file via the data output.

According to a preferred embodiment of the present invention, the resulting data file comprises the resulting data in the form of a preferably machine-readable character encoding. According to a preferred embodiment of the present invention, the character encoding is preferably a 2 bit character encoding or a 3 bit character encoding or a 4 bit character encoding or a more than 4 bit, in particular 7, 8 or 18 bit character encoding, in particular American Standard Code for Information Interchange (ASCII) or Indian Script Code for Information Interchange (ISCII) or Tamil Script Code for Information Interchange (TSCII).

According to a preferred embodiment of the present invention, the resulting data of the resulting data file represent color values and/or brightness values.

According to a preferred embodiment of the present invention, a function system is provided, wherein the function system is coupled to the data input of the data processing device.

According to a preferred embodiment of the present invention, a storage system is provided, wherein the storage system is coupled to the data output ofthe data processing device and wherein the storage system is configured to store the resulting data file and/or to generate the resulting data file by means of the output data stream.

According to a preferred embodiment of the present invention, a data verification system is provided, wherein the storage system and the data verification system are directly or indirectly connected to each other via a bidirectional or unidirectional data line, in particular an optical fiber, wherein the bidirectional or unidirectional data line connects a data output of the storage system and a data input of the data verification system, wherein data can be conducted from the storage system to the data verification system via the bidirectional or unidirectional data line.

According to a preferred embodiment of the present invention, the data verification logic system comprises a data verification logic gate, in particular Field Programmable Gate Array (FPGA) or Application Specific Integrated Circuit (ASIC) or Software Configurable Processor (SCP) or Complex Programmable Logic Device (CPLD) or Simple Programmable Logic Device (SPLD), in particular malware identification program or a malware identification hardware, for analyzing the resulting data.

According to a preferred embodiment of the present invention, the resulting data can be analyzed with respect to the bit sequences they represent.

According to a preferred embodiment of the present invention, a data verification system is provided, wherein a data output of the memory system is connected to an input of a Data verification logic gate, in particular Field Programmable Gate Array (FPGA) or Application Specific Integrated Circuit (ASIC) or Complex Programmable Logic Device (CPLD) or Simple Programmable Logic Device (SPLD), and wherein an output of the logic gate is connected to an input of the Data verification logic gate, wherein resulting data which can be fed to the input of the Data verification logic gate can be processed by the data verification logic gate via the data output of the memory system and can be fed to the input of the data verification logic gate.

According to a preferred embodiment of the present invention, a data output of the data verification system is connected to the logic gate via a data link, wherein the resulting data fed from the logic gate to the data verification system via the data input of the data verification system can be fed to the logic gate again via the data link.

According to a preferred embodiment of the present invention, the logic gate is associated with a data verification system data store, wherein the data verification system data store comprises at least malware representation data.

According to a preferred embodiment of the present invention, the malware representation data binary sequence of a malware comprises a malware representation data binary sequence, wherein the malware representation data binary sequence is different from the binary sequence of the malware.

According to a preferred embodiment of the present invention, the malware representation data binary sequence is longer than the binary sequence of the malware, in particular malware representation data binary sequence is longer than the binary sequence of the malware by at least a factor of 1.2 or a factor of 1.6 or a factor of 2 or a factor of 4 or a factor of 8, and/or all contiguous bit sequences of the binary sequence of the malware with a length of at least 0.001%, in particular at least 1% or preferably at least 10% or most preferably at least 20%, of the total length of the binary sequence of the malware are of all contiguous bit sequences of the malware representation data binary sequence with a length of at least 0,001%, in particular at least 1% or preferably at least 10% or most preferably at least 20%, of the total length of the binary sequence of the malware and/or all contiguous bit sequences of the binary sequence of the malware with a length of at least 32 bits, in particular at least 64, at least 128, at least 256 or at least 512 bits, are different from all contiguous bit sequences of the malware representation data binary sequence with a length of at least 32 bits, in particular at least 64, at least 128, at least 256 or at least 512 bits.

According to a preferred embodiment of the present invention, the malware representation data in the data verification system data store is updateable.

According to a preferred embodiment of the present invention, the storage system and the data verification system are directly or indirectly connected to each other via a bidirectional or unidirectional data line, in particular an optical fiber, wherein the bidirectional or unidirectional data line connects a data output of the storage system and a data input of the data verification system, wherein data can be conducted from the storage system to the data verification system via the bidirectional or unidirectional data line.

According to a preferred embodiment of the present invention, the data verification system comprises a malware identification program or malware identification hardware, in particular Field Programmable Gate Array (FPGA) or Application Specific Integrated Circuit (ASIC) or Software Configurable Processor (SCP) or Complex Programmable Logic Device (CPLD) or Simple Programmable Logic Device (SPLD), for analyzing the resulting data.

According to a preferred embodiment of the present invention, the resulting data can be analyzed with respect to the bit sequences they represent.

According to a preferred embodiment of the present invention, the data verification system has an update data input.

According to a preferred embodiment of the present invention, the functional system or an Internet connection device comprises an update data output, wherein the update data output of the functional system or the Internet connection device and the update data input of the data verification system are interconnected via an encryption and/or decryption logic gate, in particular Field Programmable Gate Array (FPGA) or Application Specific Integrated Circuit (ASIC) or Complex Programmable Logic Device (CPLD) or Simple Programmable Logic Device (SPLD), in particular Field Programmable Gate Array (FPGA) or Application Specific Integrated Circuit (ASIC) or Complex Programmable Logic Device (CPLD) or Simple Programmable Logic Device (SPLD), wherein the encryption and/or decryption logic gate is configured to decrypt update data supplied via the update data input.

According to a preferred embodiment of the present invention, the encryption and/or decryption logic gate performs a decryption of the update data depending on at least one defined parameter, in particular the time, the date and/or a code.

According to a preferred embodiment of the present invention, the update input is functionally connected to an update data memory for storing the update data, wherein the update data memory and a digital output of the data verification system are separated by at least one logic gate.

According to a further preferred embodiment of the device or system according to the invention, an inactivation device is provided for inactivating the data backup and/or provisioning device, in particular the passivation device, and/or for inactivating data forwarding, in particular from a system on which the original digital data is stored and from which the original data can be fed to the passivation device, to the data backup and/or provisioning device, wherein the inactivation device preferably inactivates the data backup and/or provisioning device, in particular the passivation device, as a function of status data of the original digital data and/or of system status data of the system on which the original digital data is stored and from which the original data can be fed to the passivation device.

According to a further preferred embodiment, the deactivation of the data backup and/or provisioning device, in particular the passivation device, represents a physical disconnection of a data connection via which the original data can be supplied to the passivation device in a connected state, the setting of an inactive state, wherein in the inactive state the conversion of the original digital data into the resulting digital data is paused or terminated, or the interruption of a power supply to the passivation device or a physical disconnection of a data connection connected to the passivation device output interface, wherein in a connected state the resulting digital data can be output to a further device, in particular the Providing device data memory.

The inactivation device is preferably part of the system on which the original digital data is stored and from which the original data can be fed to the passivation device, and/or is part of the data backup and/or provisioning device.

The inactivation device is particularly preferably configured to analyze the system on which the original digital data is stored and from which the original data can be fed to the passivation device with regard to encryption parameters.

According to a further preferred embodiment, the inactivation device is configured as an intrusion protection system (IPS) or is connected to an intrusion protection system (LPS) via data and or signal technology. IPS systems are described, for example, by the following internet withdrawal: https://www.informatik-aktuell.de/betrieb/sicherheit/ransomware-angriffe-erkennen-und-stoppen.html.

According to a further preferred embodiment of the device or system according to the invention, the passivation logic gate is configured to generate zero binary sequence representations for zeros of the first binary sequence of the original digital data, and wherein the passivation logic gate is configured to generate ones binary sequence representations for ones of the first binary sequence of the original digital data.

According to a further preferred embodiment of the present invention, the zero binary sequence representation has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a further preferred embodiment, the ones binary sequence representation has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a further preferred embodiment, the passivation logic gate is configured to define or provide or determine or generate different zero binary sequence representations and/or ones binary sequence representations for different original data, in particular different files, in particular original data to be processed successively.

According to a further preferred embodiment, the passivation logic gate is configured to define or provide or determine or generate different zero binary sequence representations and/or ones binary sequence representations for original data of a file.

According to a further preferred embodiment of the present invention, the passivation logic gate is configured to execute an algorithm for predetermining or generating or determining the zero binary sequence representations and/or the ones binary sequence representations, or the passivation logic gate is configured to execute a random algorithm for randomly determining or generating or determining the zero binary sequence representations and/or the ones binary sequence representations, or to execute one or more look-up tables having a plurality of predetermined zero-ones binary sequence representation combinations.binary sequence representations and/or the ones binary sequence representations, or one or more look-up tables are provided with a plurality of specified zero-ones binary sequence representation combinations, and the passivation logic gate is configured to select different zero-ones binary sequence representation combinations, in particular randomly, wherein the one zero-ones binary sequence representation is selected by the passivation logic gate, in particular randomly, wherein the one look-up table or the plurality of look-up tables comprises at least 10, in particular at least 100 and preferably at least 1000 and particularly preferably more than 3000 and most preferably more than 5000 or 10000, different Zeros-ones binary string representation combinations.

According to a further preferred embodiment of the present invention, the one look-up table or the plurality of look-up tables comprise zeros-ones binary string representation combinations, wherein the zeros-ones binary string representation combinations comprise zeros-bit representations and ones-bit representations, wherein at least individual zeros-bit representations of the zeros-ones binary string representation combinations each comprise a first number of bits, and wherein at least individual ones-bit representations of the zeros-ones-binary string representation combinations each have a second number of bits, wherein the first number of bits and the second number of bits are the same at least in the case of individual zeros-ones binary string representation combinations and/or wherein the first number of bits and the second number of bits are different at least in the case of individual zeros-ones binary string representation combinations.

According to a further preferred embodiment of the present invention, the look-up table or tables is/are provided or stored or deposited in a memory device of the passivation device.

According to a further preferred embodiment of the present invention, the passivation logic gate is configured to generate resulting data with respect to the original data of a file, wherein the resulting data can be generated with a plurality of zero binary sequence representations different from each other, wherein the zero binary sequence representations different from each other have bit sequences of different lengths and/or different bit sequences of the same length.

According to a further preferred embodiment of the present invention, the passivation logic gate is configured to generate resulting data with respect to the original data of a file, wherein the resulting data is generatable with a plurality of ones binary sequence representations different from each other, wherein the ones binary sequence representations different from each other have bit sequences of different lengths and/or different bit sequences of the same length.

According to a further preferred embodiment of the present invention, the passivation logic gate is configured to generate resulting data with respect to the original data of a file, wherein the resulting data is generatable with a plurality of ones binary sequence representations different from each other, wherein the ones binary sequence representations different from each other have bit sequences of different lengths and/or different bit sequences of the same length, and wherein the passivation logic gate is configured to generate the resulting data with a plurality of ones binary sequence representations different from each other, wherein the ones binary sequence representations different from each other have bit sequences of different lengths and/or different bit sequences of the same length, to generate the resulting data with a plurality of zero binary sequence representations different from each other, wherein the zero binary sequence representations different from each other have bit sequences of different lengths and/or different bit sequences of the same length, wherein the bit sequences of the resulting data for the zero binary sequence representations and the ones binary sequence representations are different from each other.

According to a further preferred embodiment of the present invention, the passivation logic gate is configured to generate representation data for the resulting data, wherein the representation data indicates which zero binary sequence representations and/or ones binary sequence representations the resulting data, in particular the respective resulting data file, has.

According to a further preferred embodiment of the present invention, the representation data indicates which zero binary sequence representations and/or which ones binary sequence representations form the resulting data at which position of the resulting data.

According to another preferred embodiment of the present invention, the representation data identifies a first ones binary sequence representation having a first bit length in a first number for replacing the first number of ones of the original data, and the representation data identifies a second ones binary sequence representation having a second bit length in a second number for replacing the second number of ones of the original data, wherein the first number of ones of the original data preferably comprises more than two consecutive ones or more than 10 consecutive ones or more than 100 consecutive ones of the original data or preferably up to 10,000 consecutive ones, and wherein the second number of ones of the original data preferably comprises more than two consecutive ones or more than 10 consecutive ones or more than 100 consecutive ones of the original data or preferably up to 10,000 consecutive ones, wherein the first number and the second number are different from each other or wherein the first number and the second number are the same.

According to another preferred embodiment of the present invention, the representation data identifies a first zero binary sequence representation having a first bit length in a first number for replacing the first number of zeros of the original data, and the representation data preferably identifies a second zero binary sequence representation having a second bit length in a second number for replacing the second number of ones of the original data, wherein the first number of zeros of the original data preferably comprises more than two consecutive zeros or more than 10 consecutive zeros or more than 100 consecutive zeros of the original data or preferably up to 10000 consecutive zeros, and wherein the second number of zeros of the original data preferably comprises more than two consecutive zeros or more than 10 consecutive zeros or more than 100 consecutive zeros of the original data or preferably up to 10000 consecutive zeros, wherein the first number and the second number are different from each other or wherein the first number and the second number are the same.

According to a further preferred embodiment of the present invention, the number of different zero binary sequence representations and the number of different ones binary sequence representations per resulting data, in particular per resulting data set or resulting data file, is the same or different.

According to a further preferred embodiment of the present invention, the passivation logic gate is configured to divide the first binary sequence into original data bit sequences, wherein the original data bit sequences comprise a plurality of bits, wherein the plurality of bits comprise one “0” bit or a plurality of “0” bits and one “1” bit or a plurality of “1” bits or “0” bits or “1” bits, and wherein the passivation logic gate is preferably configured to store the number of bits of each original data bit sequence in the representative data, and wherein the passivation logic gate is preferably configured to store the number of bits of each original data bit sequence in the representation data, and wherein the passivation logic gate is preferably configured to store, in particular to generate or select, a bit-representation combination in the representation data for each original data bit sequence. Each bit representation combination preferably has a zero binary sequence representation or a link to a zero binary sequence representation for all “0” bits of an original data bit sequence, and wherein each bit representation combination preferably has a ones binary sequence representation or a link to a ones binary sequence representation for all “1” bits of the same original data bit sequence. Alternatively, each bit representation combination has a zeros-ones binary string representation combination or a link to a zeros-ones binary string representation combination for all “0” bits and “1” bits of an original data bit sequence.

According to a further preferred embodiment of the present invention, the passivation logic gate is configured to divide the first n bits of the first binary sequence into original data bit sequences, the average number of bits of which is preferably less than 50 bits, in particular less than 20 bits or less than 15 bits, wherein the first n bits are less than 10,000 bits, in particular less than 5,000 bits and preferably less than 1,000 bits and particularly preferably less than 500 bits and most preferably less than 200 bits. Additionally or alternatively, the passivation logic gate is configured to divide the last m bits of the first binary sequence into original data bit sequences, the average number of bits of which is preferably less than 50 bits, in particular less than 20 bits or less than 15 bits, wherein the last m bits are less than 10000 bits, in particular less than 5000 bits and preferably less than 1000 bits and particularly preferably less than 500 bits and most preferably less than 200 bits.

According to a further preferred embodiment of the present invention, the passivation logic gate is configured to divide the first n bits of the first binary sequence into original data bit sequences, the number of bits of which is between 2 bits and 50 bits, in particular between 4 bits and 20 bits and preferably between 5 bits and 15 bits, and/or the passivation logic gate is configured to divide the last m bits of the first binary sequence into original data bit sequences, the number of bits of which is between 2 bits and 50 bits, in particular between 4 bits and 20 bits and preferably between 5 bits and 15 bits.

According to a further preferred embodiment of the present invention, the passivation logic gate is configured to divide the bits between the first n bits, in particular 100 bits, of the first binary sequence and the last m bits, in particular 100 bits, of the first bit sequence into original data bit sequences whose average number of bits is greater than 20 bits, in particular is greater than 50 bits or is greater than 100 bits.

According to a further preferred embodiment of the present invention, the representation data can be generated as part of the resulting data.

According to a further preferred embodiment of the present invention, the representation data can be generated as a separate data set associated with the resulting data.

According to a further preferred embodiment of the present invention, an analysis unit is provided for determining malware signature data.

According to a further preferred embodiment of the present invention, the analysis unit is configured to generate analysis bit representation data on the basis of resulting data, in particular also on the basis of the representation data assigned or associated with the respective resulting data.

According to a further preferred embodiment of the present invention, the analysis bit representation data represents the first bit sequence in encrypted form. According to a further preferred embodiment of the present invention, the analysis bit representation data is analyzable with respect to a malware signature contained in the first bit sequence or with respect to a plurality of malware signature data contained in the first bit sequence.

According to a further preferred embodiment of the present invention, the analysis bit representation data relating to the zero binary sequence representations of the resulting data, in particular of a resulting data file, comprises a plurality of first bit blocks relating to at least or exactly one zero analysis bit representation of a normalization system.

According to a further preferred embodiment of the present invention, the analysis bit representation data comprises a plurality of second bit blocks relating to at least or exactly one ones analysis bit representation of the normalization system with respect to the ones binary sequence representations of the resulting data, in particular a resulting data file.

According to a further preferred embodiment of the present invention, the Normalization system comprises a plurality of different bit blocks, preferably with each bit block being assigned a unique comparison parameter.

According to another preferred embodiment of the present invention, the comparison parameter(s) is/are symbols, colors, grayscale, tones and/or patterns.

According to a further preferred embodiment of the present invention, the gray levels or colors per bit block can be optically output by means of at least one pixel or several pixels, in particular 2, 3, 4, 5 or up to 10 or more than 10 or up to 200 pixels.

According to a further preferred embodiment of the present invention, 4 or more than 4 or 8 or more than 8 or 16 or more than 16 or 32 or more than 32 or up to 32 or preferably 64 or more than 64 or up to 64 or most preferably 128 or more than 128 or up to 128 or most preferably 256 or more than 256 or up to 256 different bit blocks are provided.

According to a further preferred embodiment of the present invention, the symbols are designed as numbers and/or letters and/or characters, in particular numbers and/or letters and/or characters according to ASCII code.

An assignment of bit blocks and symbols is:

| | | | | | |
|---|---|---|---|---|---|
| | | 01000000 | @ | 01100000 | [symbol] |
| 00100001 | ! | 01000001 | A | 01100001 | a |
| 00100010 | [symbol] | 01000010 | B | 01100010 | b |
| 00100011 | # | 01000011 | C | 01100011 | c |
| 00100100 | $ | 01000100 | D | 01100100 | d |
| 00100101 | % | 01000101 | E | 01100101 | e |
| 00100110 | & | 01000110 | F | 01100110 | f |
| 00100111 | [symbol] | 01000111 | G | 01100111 | g |
| 00101000 | ( | 01001000 | H | 01101000 | h |
| 00101001 | ) | 01001001 | I | 01101001 | i |
| 00101010 | [symbol] | 01001010 | J | 01101010 | j |
| 00101011 | + | 01001011 | K | 01101011 | k |
| 00101100 | , | 01001100 | L | 01101100 | l |
| 00101101 | [symbol] | 01001101 | M | 01101101 | m |
| 00101110 | . | 01001110 | N | 01101110 | n |
| 00101111 | / | 01001111 | O | 01101111 | o |
| 00110000 | 0 | 01010000 | P | 01110000 | p |
| 00110001 | 1 | 01010001 | Q | 01110001 | q |
| 00110010 | 2 | 01010010 | R | 01110010 | r |
| 00110011 | 3 | 01010011 | S | 01110011 | s |
| 00110100 | 4 | 01010100 | T | 01110100 | t |
| 00110101 | 5 | 01010101 | U | 01110101 | u |
| 00110110 | 6 | 01010110 | V | 01110110 | v |
| 00110111 | 7 | 01010111 | W | 01110111 | w |
| 00111000 | 8 | 01011000 | X | 01111000 | x |
| 00111001 | 9 | 01011001 | Y | 01111001 | y |
| 00111010 | : | 01011010 | Z | 01111010 | z |
| 00111011 | ; | 01011011 | [ | 01111011 | { |
| 00111100 | < | 01011100 | \ | 01111100 | \| |
| 00111101 | = | 01011101 | ] | 01111101 | } |
| 00111110 | > | 01011110 | \hat{ } | 01111110 | ~ |
| 00111111 | ? | 01011111 | _{—} | 01111111 | DEL |

[symbol]

indicates data missing or illegible when filed

According to a further preferred embodiment of the present invention, the colors are 128 different colors or more than 128 different colors or preferably 256 different colors or more than 256 different colors or 512 different colors or more than 512 different colors.

A mapping of bit blocks and colors is according to another preferred embodiment of the present invention:

| | |
|---|---|
| 0000000 | Color value 1 |
| 0000001 | Color value 2 |
| . . . | |
| 0111111 | Color value 128. |

According to a further preferred embodiment of the present invention, the gray levels are 128 different gray levels or more than 128 different gray levels or preferably 256 different gray levels or more than 256 different gray levels or 512 different gray levels or more than 512 different gray levels.

A mapping of bit blocks and grayscales is according to another preferred embodiment of the present invention:

| | |
|---|---|
| 0000000 | Gray value 1 |
| 0000001 | Gray value 2 |
| . . . | |
| 0111111 | Gray value 128. |

According to a further preferred embodiment of the present invention, the data storage and retrieval device has a data memory, wherein data modification and/or data generation on the data memory and/or deletion of data and/or retrieval of data from the data memory can be effected by the analysis unit.

According to a further preferred embodiment of the present invention, the passivation device, in particular the passivation logic gate, is configured to randomly predetermine a zeros analysis bit representation with respect to the zeros binary sequence representations of the first binary sequence and the passivation device, in particular the passivation logic gate, is configured to randomly predetermine a ones analysis bit representation with respect to the ones binary sequence representations of the first binary sequence.

According to a further preferred embodiment of the present invention, the passivation device, in particular the passivation logic gate, is configured to generate the specification of the zeros analysis bit representation and the ones analysis bit representation as part of the resulting data and/or as part of the representation data and/or as part of the analysis bit representation data.

According to a further preferred embodiment of the present invention, the analysis unit is configured to randomly define, determine or select at least one or exactly one zeros analysis bit representation for generating the analysis bit representation data relating to the zeros binary sequence representations of the first binary sequence, and the analysis unit is configured to randomly define, determine or select at least one or exactly one ones analysis bit representation for generating the analysis bit representation data relating to the ones binary sequence representations of the first binary sequence.

According to a further preferred embodiment of the present invention, one or more malware signature data can be stored in the data memory, in particular can be stored.

According to a further preferred embodiment of the present invention, the malware signature data can be provided as malware signature reference data.

In accordance with a further preferred embodiment of the present invention, the analysis unit is configured to use the malware signature reference data to cause the generation of comparison data for comparison with the analysis bit representation data.

According to a further preferred embodiment of the present invention, the comparison data can be generated according to the at least one and preferably exactly one zeros analysis bit representation and according to the at least one or preferably exactly one ones analysis bit representation.

According to a further preferred embodiment of the present invention, the malware signature data can be provided as a malware signature comparison table, wherein the analysis unit is configured to select comparison data from the malware signature comparison table for comparison with the analysis bit representation data.

According to a further preferred embodiment of the present invention, the reactivation device, in particular a logic gate, in particular an FPGA or ASIC, is configured to effect the conversion of the resulting data into the target data as a function of the representation data.

According to a further preferred embodiment of the present invention, the passivation logic gate part is configured to generate zero ones binary sequence representations for zeros of the first binary sequence of the original digital data, and wherein the passivation logic gate part is preferably configured to generate ones binary sequence representations for ones of the first binary sequence of the original digital data.

According to a further preferred embodiment of the present invention, the zero binary sequence representations have at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a further preferred embodiment of the present invention, the ones binary sequence representation has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

According to a further preferred embodiment of the present invention, the passivation logic gate part is configured to define or provide or determine or generate different zero binary sequence representations and/or ones binary sequence representations for different original data, in particular different files, in particular original data to be processed successively.

According to a further preferred embodiment of the present invention, the passivation logic gate part is configured to define or provide or determine or generate different zero binary sequence representations and/or ones binary sequence representations for original data of a file.

According to a further preferred embodiment of the present invention, the passivation logic gate part is configured to execute an algorithm for predetermining or generating or determining the zero binary sequence representations and/or the ones binary sequence representations, or the passivation logic gate part is configured to execute a random algorithm for randomly determining or generating or determining the zero binary sequence representations and/or the ones binary sequence representations, or to execute one or more look-up tables having a plurality of predetermined zero-ones binary sequence representation combinations.binary sequence representations and/or the ones binary sequence representations, or one or more look-up tables are provided with a plurality of specified zero-ones binary sequence representation combinations, and the passivation logic gate part is configured to select different zero-ones binary sequence representation combinations, in particular randomly, wherein the one zero-ones binary sequence representation is selected by the passivation logic gate part, in particular randomly, wherein the one look-up table or the plurality of look-up tables comprises at least 10, in particular at least 100 and preferably at least 1000 and particularly preferably more than 3000 and most preferably more than 5000 or 10000, different Zeros-ones binary string representation combinations.

According to a further preferred embodiment of the present invention, the passivation logic gate part is configured to generate resulting data with respect to the original data of a file, wherein the resulting data is preferably generatable with a plurality of zero binary sequence representations different from each other, wherein the zero binary sequence representations different from each other have bit sequences of different lengths and/or different bit sequences of the same length.

According to a further preferred embodiment of the present invention, the passivation logic gate part is configured to generate resulting data with respect to the original data of a file, wherein the resulting data can preferably be generated with a plurality of ones binary sequence representations different from each other, wherein the ones binary sequence representations different from each other have bit sequences of different lengths and/or different bit sequences of the same length.

According to a further preferred embodiment of the present invention, the passivation logic gate part is configured to generate resulting data with respect to the original data of a file, wherein the resulting data is generatable with a plurality of ones binary sequence representations different from each other, wherein the ones binary sequence representations different from each other have bit sequences of different lengths and/or different bit sequences of the same length, and wherein the passivation logic gate part is preferably configured to generate the resulting data with a plurality of ones binary sequence representations different from each other, wherein the ones binary sequence representations different from each other have bit sequences of different lengths and/or different bit sequences of the same length, to generate the resulting data with a plurality of zero binary sequence representations different from each other, wherein the zero binary sequence representations different from each other have bit sequences of different lengths and/or different bit sequences of the same length, wherein the bit sequences of the resulting data for the zero binary sequence representations and the ones binary sequence representations are different from each other.

According to a further preferred embodiment of the present invention, the passivation logic gate part is configured to generate representation data for the resulting data, wherein the representation data indicates which zero binary sequence representations and/or ones binary sequence representations the resulting data, in particular the respective resulting data file, has.

According to a further preferred embodiment of the present invention, the representation data indicates which zero binary sequence representations and/or which ones binary sequence representations form the resulting data at which position of the resulting data.

According to another preferred embodiment of the present invention, the representation data identifies a first ones binary sequence representation having a first bit length in a first number for replacing the first number of ones of the original data, and the representation data preferably identifies a second ones binary sequence representation having a second bit length in a second number for replacing the second number of ones of the original data, wherein the first number of ones of the original data comprises more than two consecutive ones or more than 10 consecutive ones or more than 100 consecutive ones of the original data or preferably up to 10,000 consecutive ones and wherein the second number of ones of the original data preferably comprises more than two consecutive ones or more than 10 consecutive ones or more than 100 consecutive ones of the original data or preferably up to 10,000 consecutive ones, wherein the first number and the second number are different from each other or wherein the first number and the second number are the same.

According to another preferred embodiment of the present invention, the representation data identifies a first zero binary sequence representation having a first bit length in a first number for replacing the first number of zeros of the original data, and the representation data preferably identifies a second zero binary sequence representation having a second bit length in a second number for replacing the second number of ones of the original data, wherein the first number of zeros of the original data preferably comprises more than two consecutive zeros or more than 10 consecutive zeros or more than 100 consecutive zeros of the original data or preferably up to 10000 consecutive zeros, and wherein the second number of zeros of the original data preferably comprises more than two consecutive zeros or more than 10 consecutive zeros or more than 100 consecutive zeros of the original data or preferably up to 10000 consecutive zeros, wherein the first number and the second number are different from each other or wherein the first number and the second number are the same.

According to a further preferred embodiment of the present invention, the number of different zero binary sequence representations and the number of different ones binary sequence representations per resulting data, in particular per resulting data set or resulting data file, is the same or different.

According to a further preferred embodiment of the present invention, the representation data can be generated as part of the resulting data.

According to a further preferred embodiment of the present invention, the representation data can be generated as a separate data set associated with the resulting data.

According to a further preferred embodiment of the present invention, the Reactivation device, in particular a logic gate, in particular an FPGA or ASIC, is configured to effect the conversion of the resulting data into the target data as a function of the representation data.

Features disclosed herein with respect to systems or devices are deemed also to be disclosed for the methods disclosed herein and vice versa, to the extent technically meaningful to a person skilled in the art.

The associated figures show purely exemplary possible embodiments of the present invention, whereby the invention is not limited to these embodiments.

### Show Therein

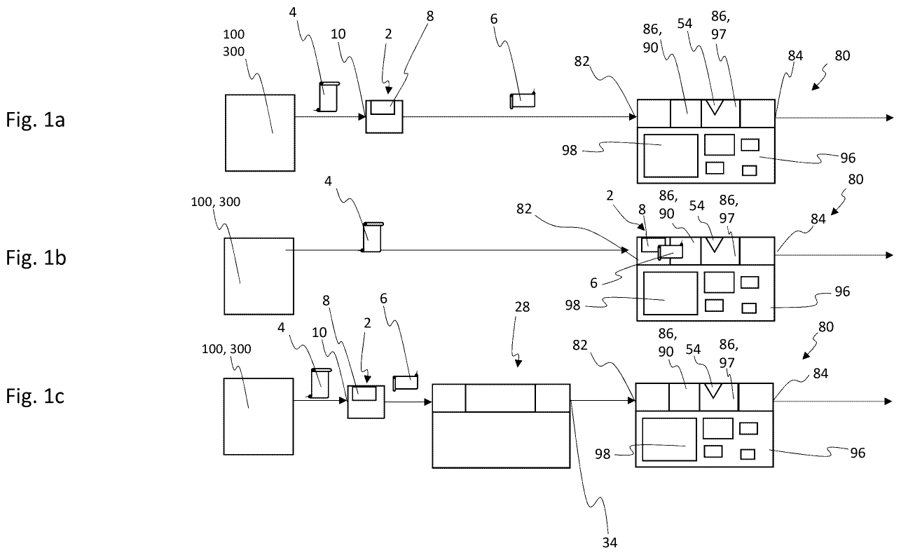

FIG. 1a a first purely schematic example of a data backup and/or provisioning device according to the invention, the representation being intended merely to illustrate an example of the path of the data to be backed up and/or processed,

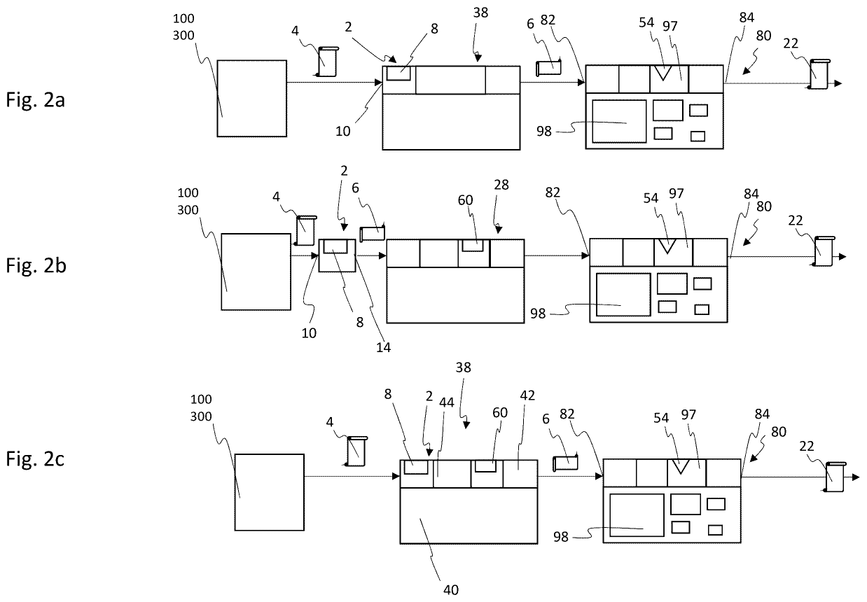

FIG. 1b a second purely schematic example of a data backup and/or provisioning device according to the invention, the representation being intended merely to illustrate an example of the path of the data to be backed up and/or processed, FIG. 1c a third purely schematic example of a data backup and/or provisioning device according to the invention, wherein the representation is merely intended to illustrate an example of the path of the data to be backed up and/or processed, FIG. 2a a fourth purely schematic example of a data backup and/or provisioning device according to the invention, the representation being intended merely to illustrate an example of the path of the data to be backed up and/or processed, FIG. 2b a fifth purely schematic example of a data backup and/or provisioning device according to the invention, the representation being intended merely to illustrate an example of the path of the data to be backed up and/or processed, FIG. 2c a sixth purely schematic example of a data backup and/or provisioning device according to the invention, the representation being intended merely to illustrate an example of the path of the data to be backed up and/or processed;

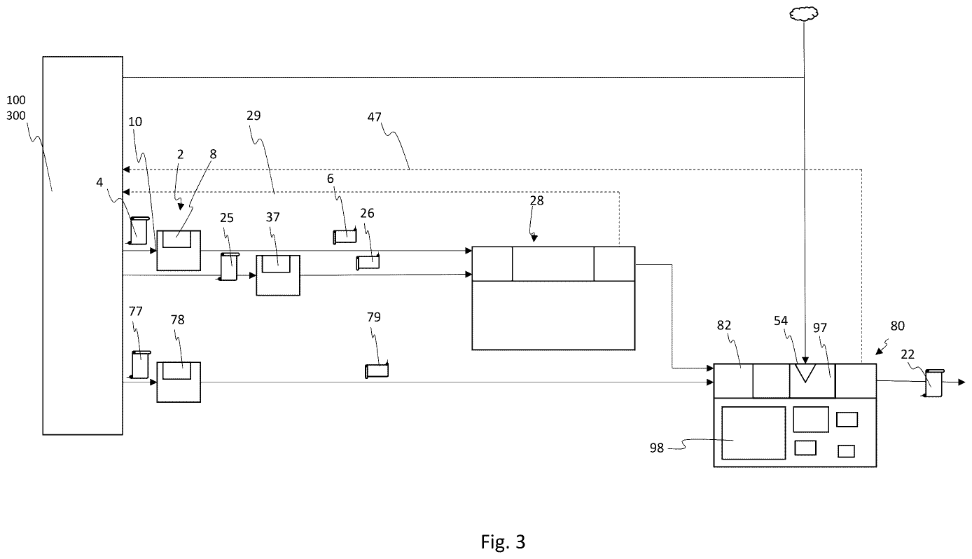

FIG. 3 a seventh purely schematic example of a data backup and/or provisioning device according to the invention, whereby this example basically corresponds to the structure according to FIG. 1c and also exemplifies communication channels for controlling individual or several of the existing devices;

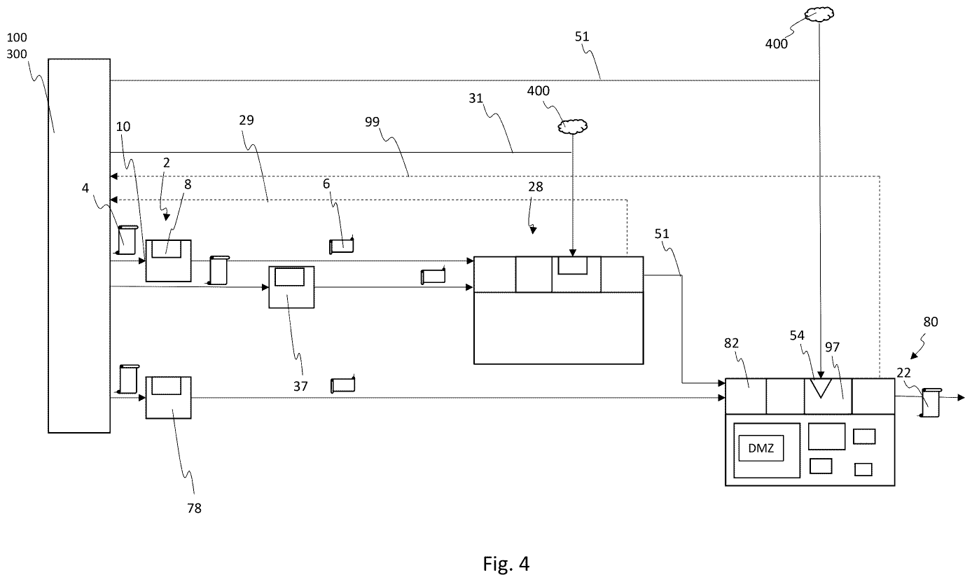

FIG. 4 an eighth purely schematic example of a data backup and/or provisioning device according to the invention, whereby this example basically corresponds to the structure according to FIG. 2a and also exemplifies communication channels for controlling individual or several of the existing devices;

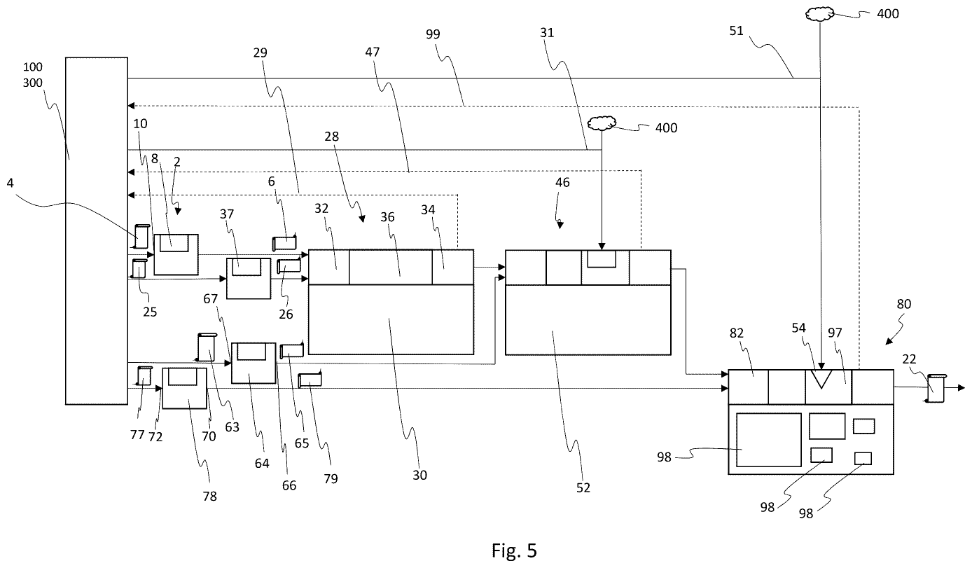

FIG. 5 a ninth purely schematic example of a data backup and/or provisioning device according to the invention and also exemplary communication channels for controlling individual or several of the existing devices;

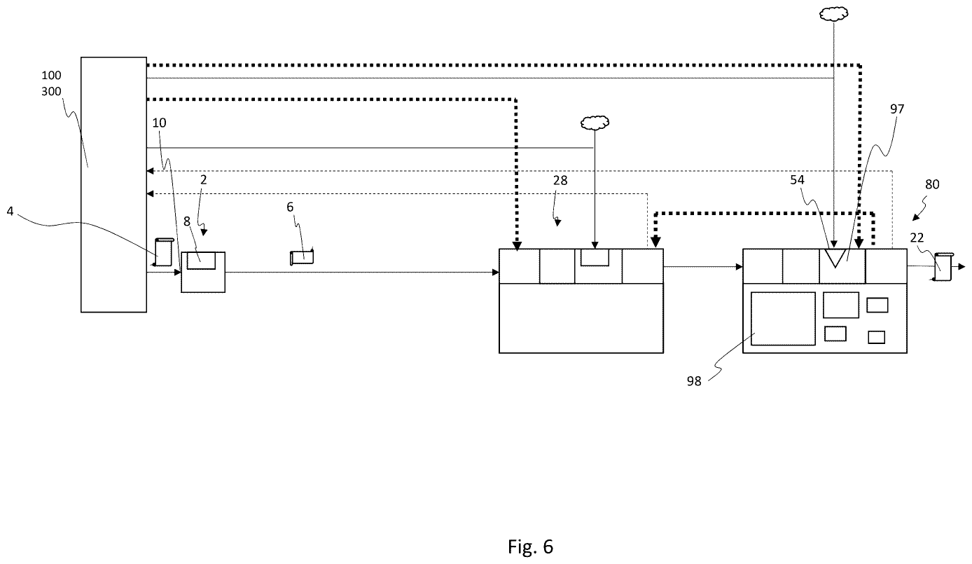

FIG. 6 a tenth purely schematic example of a data backup and/or provisioning device according to the invention, wherein this example corresponds in principle to the structure according to FIG. 2b and also exemplifies communication channels for controlling individual or several of the existing devices, wherein individual communication channels or several communication channels can be implemented by means of an analog interface;

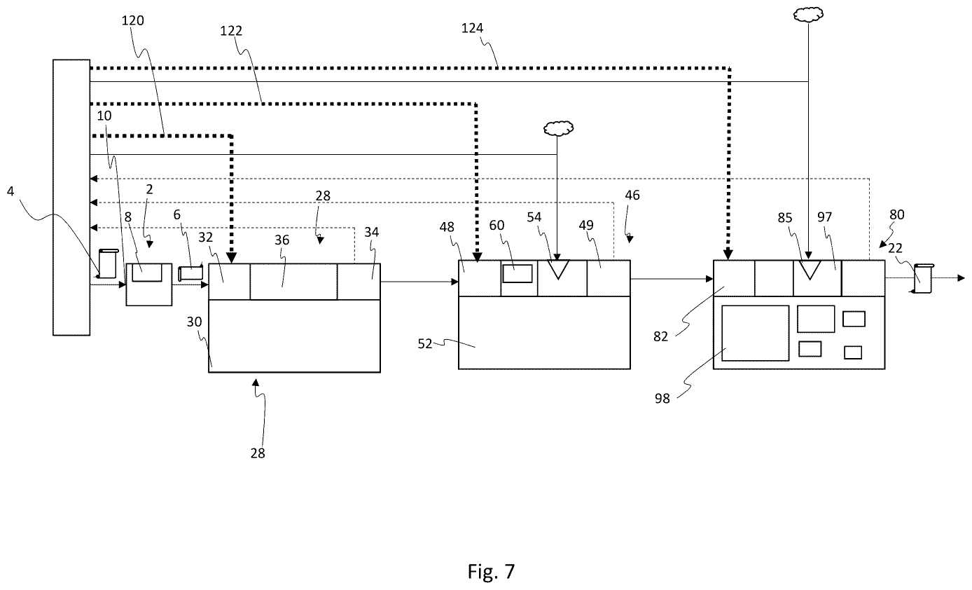

FIG. 7 an eleventh purely schematic example of a data backup and/or provisioning device according to the invention and also exemplary communication channels for controlling individual or several of the existing devices, whereby individual communication channels or several communication channels can be implemented by means of an analog interface;

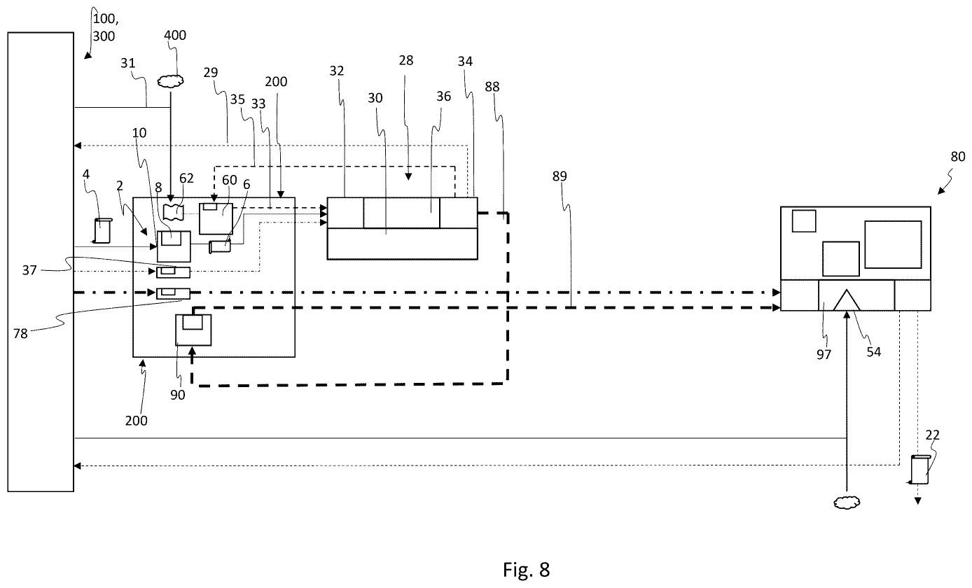

FIG. 8 a twelfth purely schematic example of a data backup and/or provisioning device according to the invention and also exemplary communication channels for controlling individual or several of the existing devices;

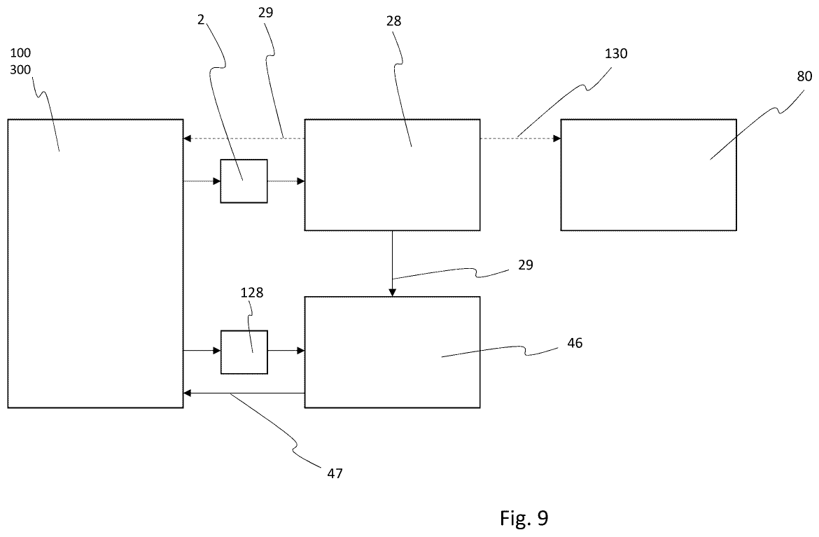

FIG. 9 a thirteenth purely schematic example of a data backup and/or provisioning device according to the invention and also exemplary communication channels for controlling individual or several of the existing devices, whereby individual communication channels or several communication channels can be implemented by means of an analog interface;

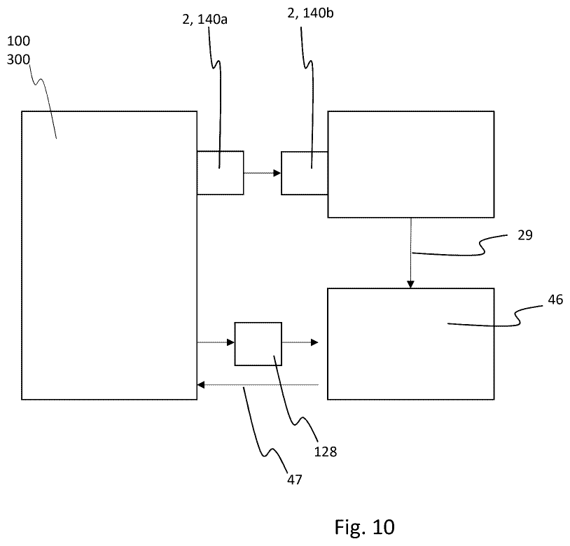

FIG. 10 a fourteenth purely schematic example of a data backup and/or provisioning device according to the invention;

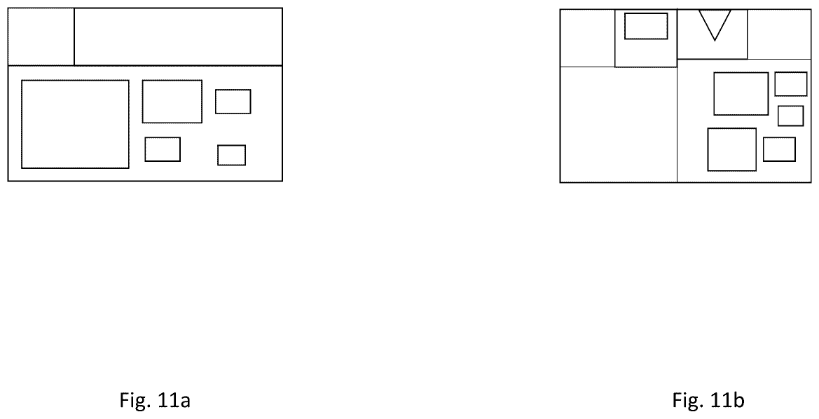

FIG. 11a schematic example of a reactivation device as it may be designed in the context of the present invention, and

FIG. 11b a further example of a reactivation device as it may be designed within the scope of the present invention;

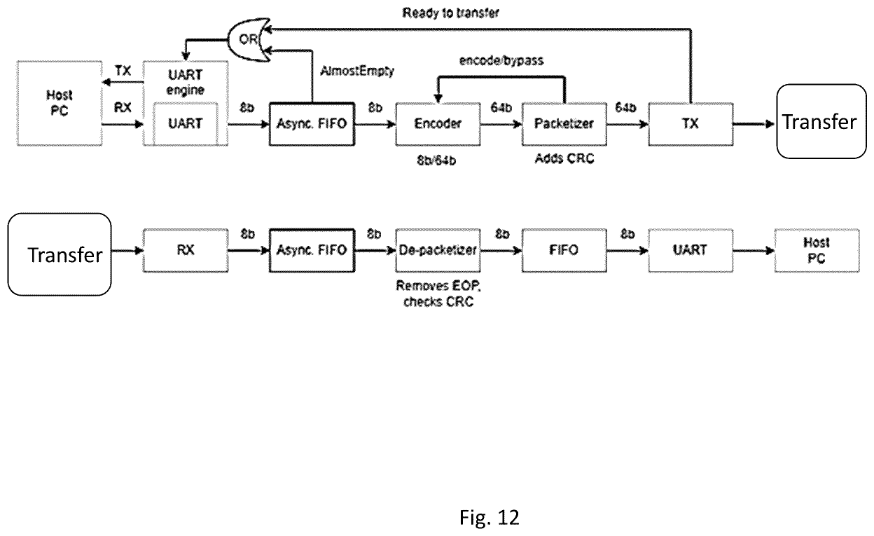

FIG. 12 an example of a passivation device, whereby the passivation device according to this embodiment can be designed with a transmitter logic gate and a receiver logic gate;

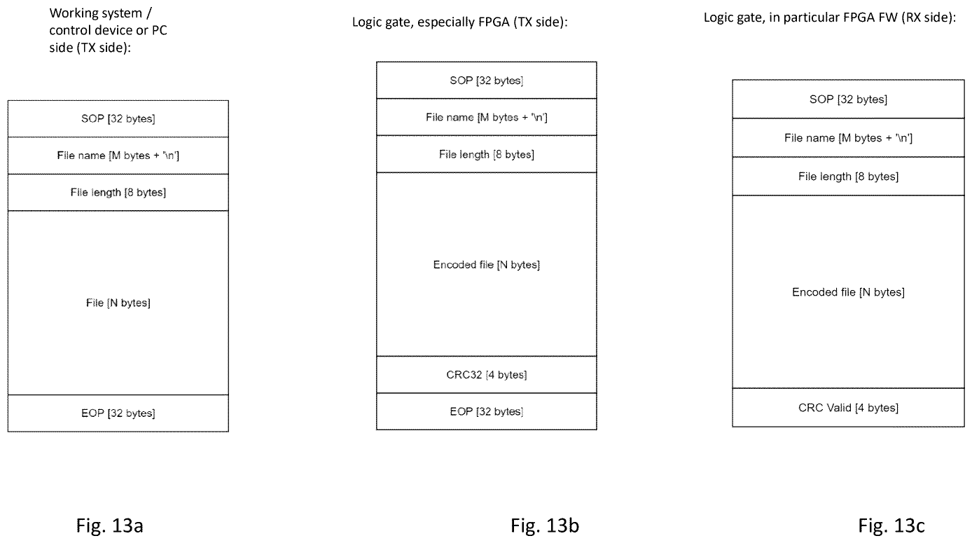

FIG. 13a-c purely as an example of data handling with regard to the passivation device shown in FIG. 12;

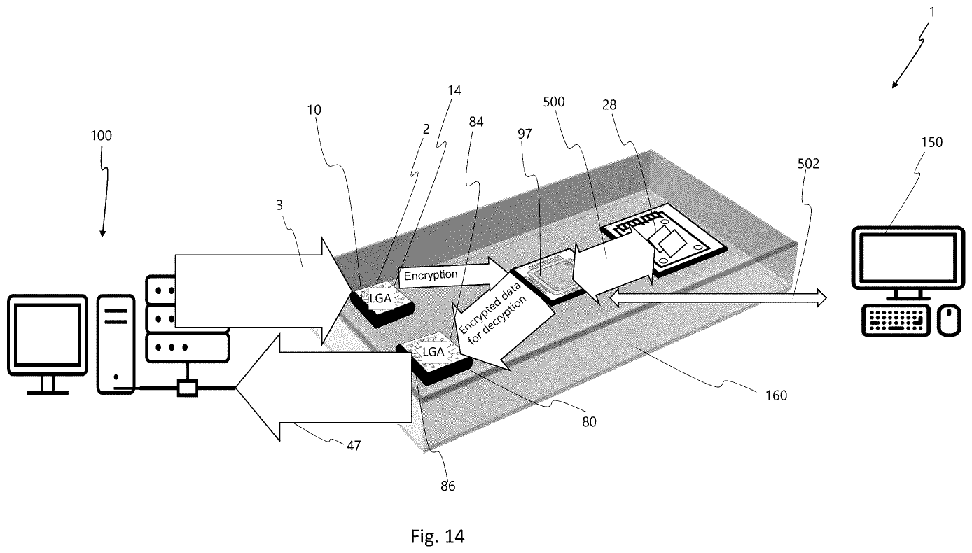

FIG. 14 exemplary schematic representation of the overall system;

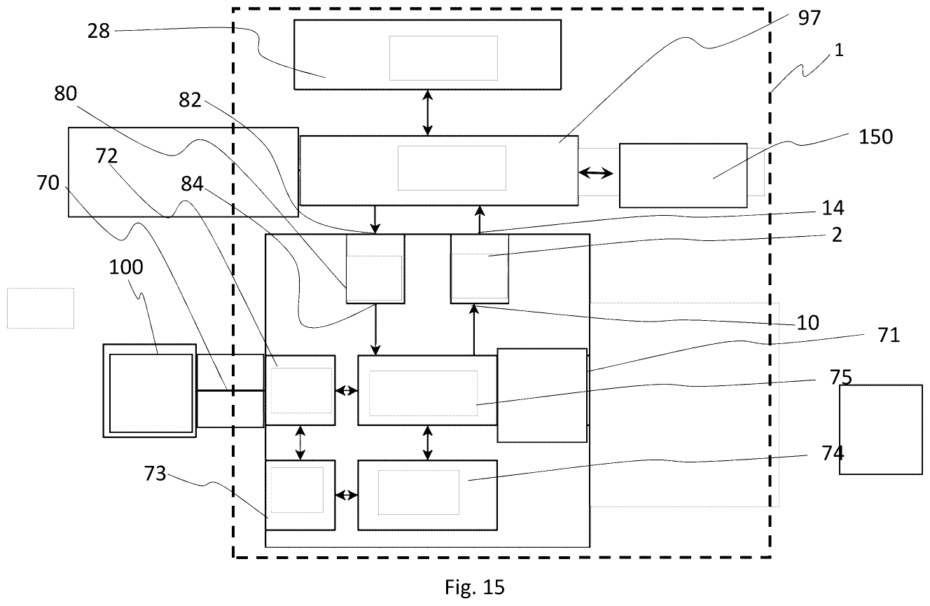

FIG. 15 another exemplary variant of the representation of the overall system;

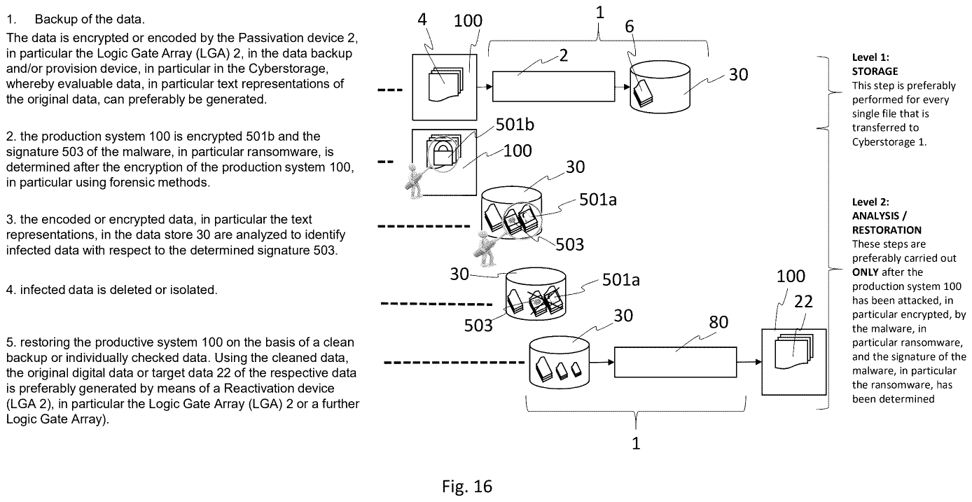

FIG. 16 exemplary schematic representation of the usage sequence of the overall system;

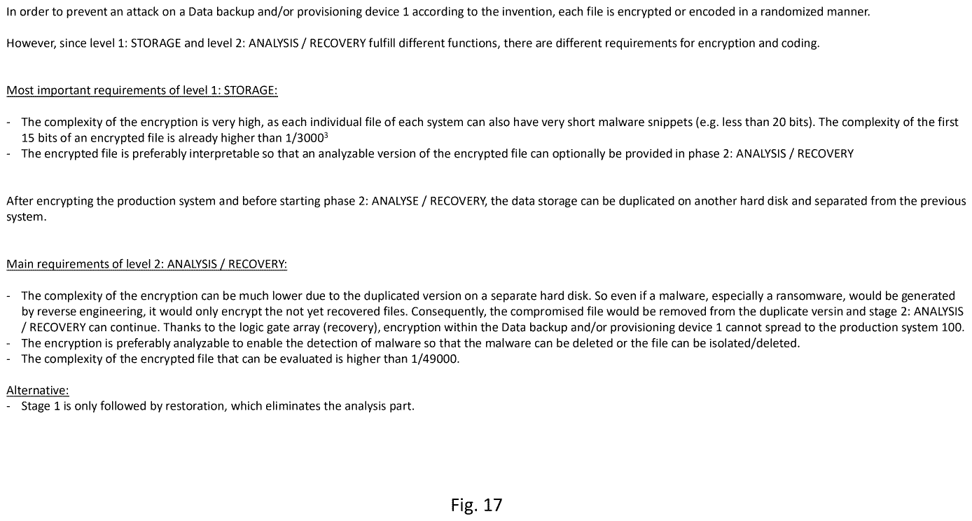

FIG. 17 exemplary schematic representation of the memory allocation by the original data, the memory allocation in the case of “Stage 1: STORAGE” and the memory allocation in the case of “Stage 2: ANALYSIS/RESET”;

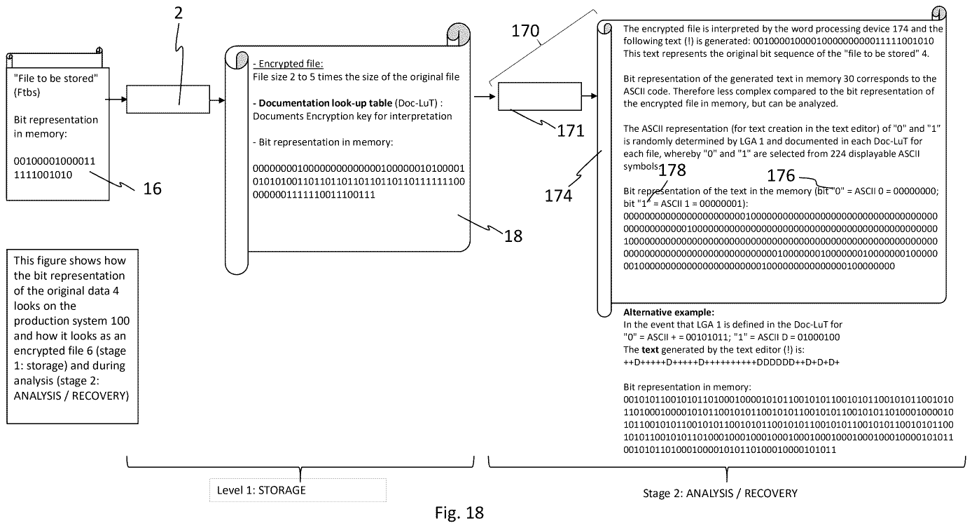

FIG. 18 exemplary schematic representation of the conversion of the original data into data encrypted in accordance with “Stage 1: STORAGE”;

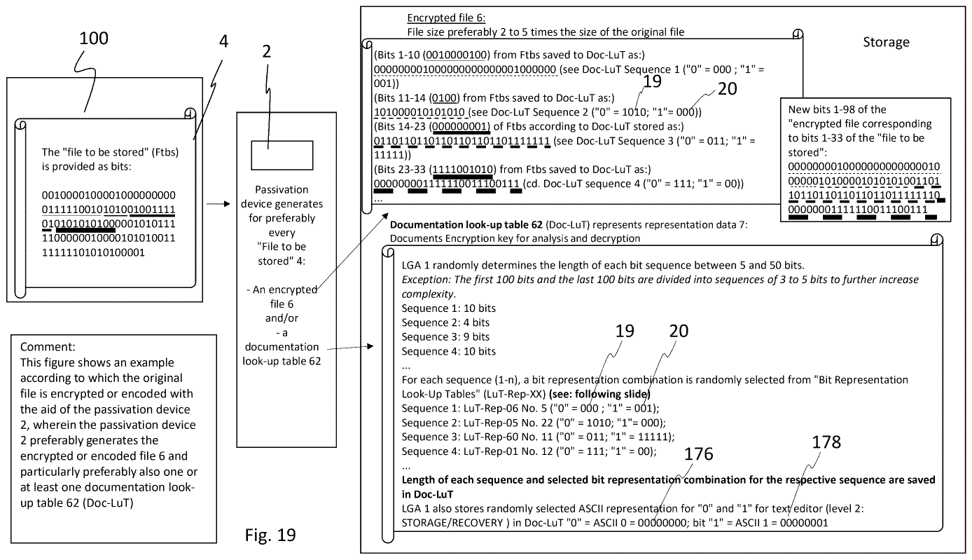

FIG. 19 exemplary schematic representation of look-up tables, where each line of the look-up tables has different combinations of zeros and ones to replace the zeros and ones of the original data;

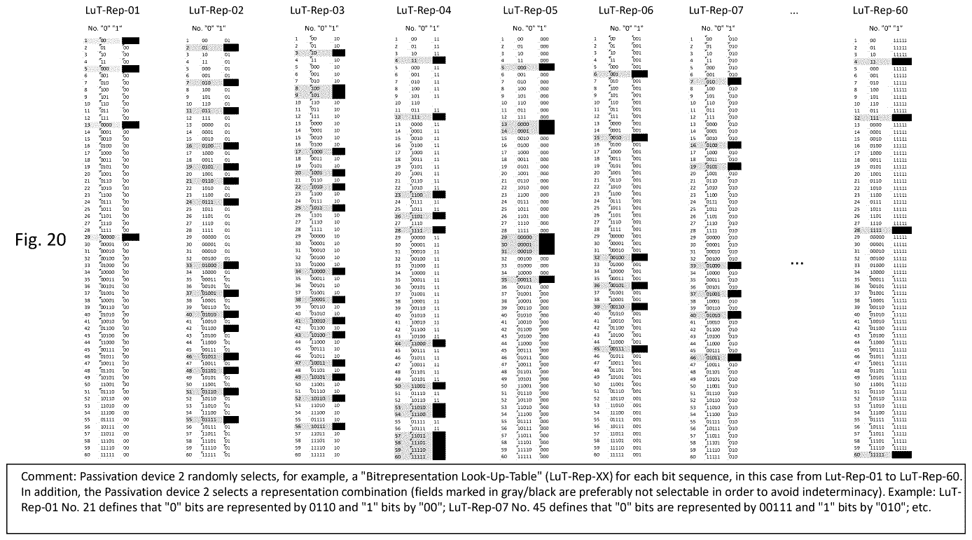

FIG. 20 exemplary schematic representation of the generation of the “Stage 2: ANALYSIS/RESET” encryption;

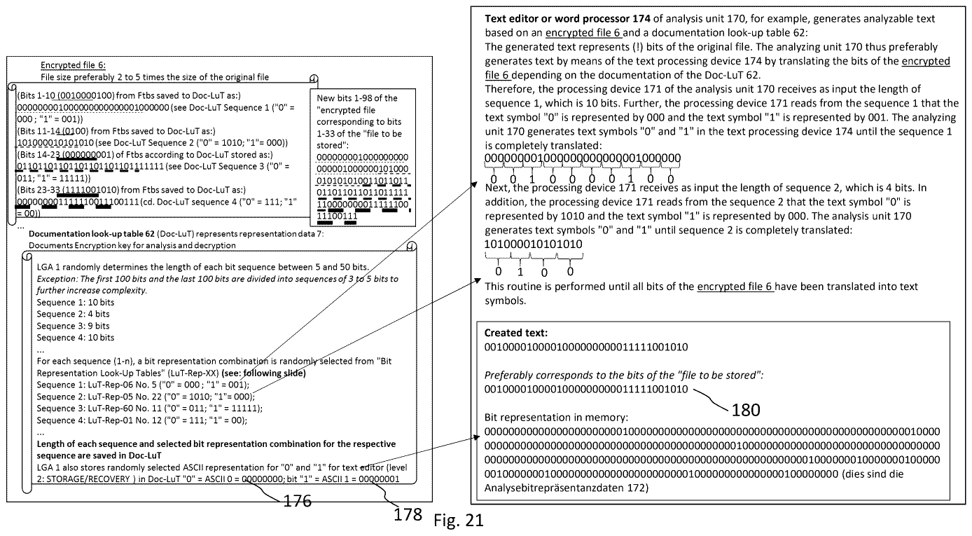

FIG. 21 alternative exemplary schematic representation of the generation of the “Stage 2: ANALYSIS/RESET” encryption;

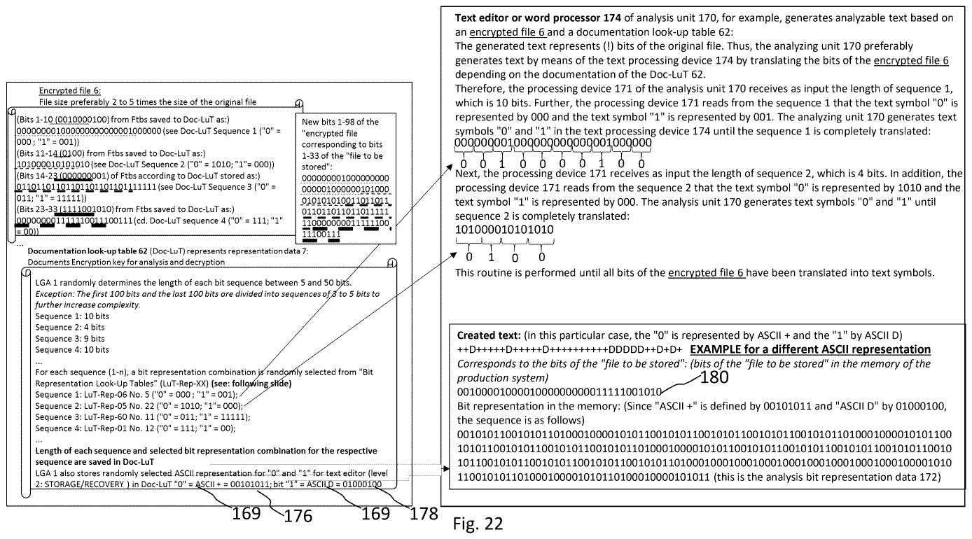

FIG. 22 exemplary schematic representation of the processing of malware signatures and exemplary schematic representation of file analysis;

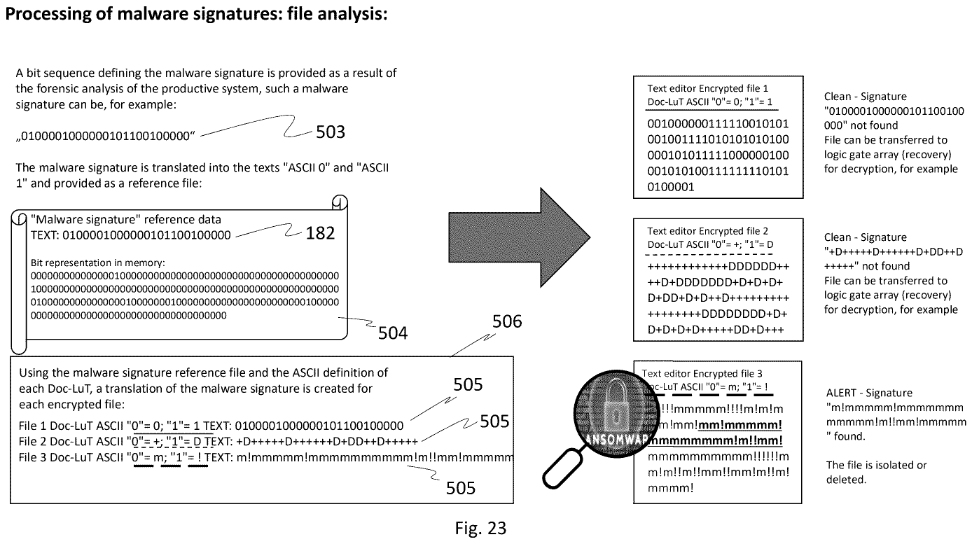

FIG. 23 exemplary schematic representation of file recovery;

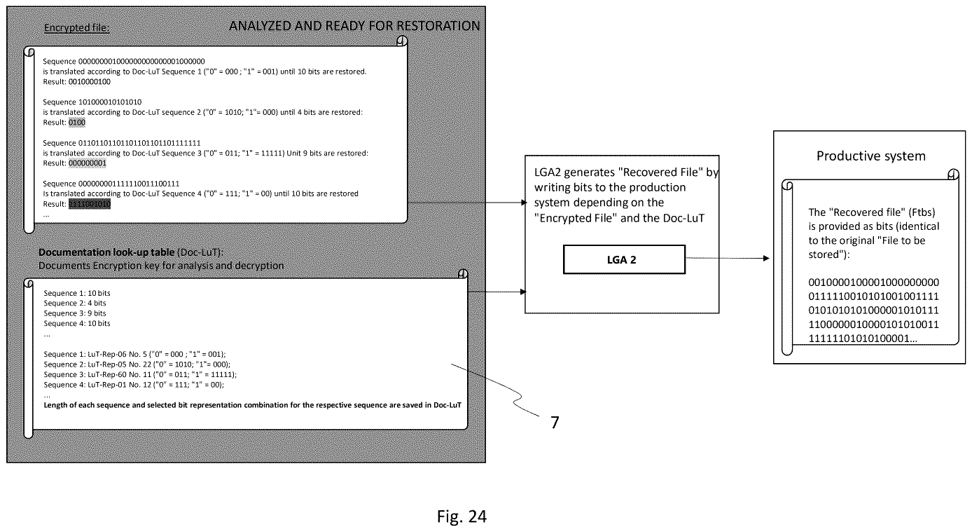

FIG. 24 exemplifying a generation of an encrypted file, wherein an analyzable zeros binary sequence representation and an analyzable ones binary sequence representation are used; and

FIG. 25a example of 95 different bit representations and

FIG. 25b example of 95 look-up tables with 94 pairs each consisting of a first bit block 196 and a second bit block 197.

FIG. 1a shows a working system 100 purely schematically, wherein the working system 100 in all embodiments of the present invention can be a computer unit, in particular a PC or a laptop or a mobile telephone or a control device of a machine or a server. Alternatively, a control device 300 may be formed between the data backup and/or provisioning device 1 according to the invention and a working system 100, in which case the control device 300 communicates on the one hand with the working system 100 and on the other hand with the data backup and/or provisioning device 1. In all embodiments of the present invention, the control device 300 may be part of the data backup and/or provisioning device 1, although this is not mandatory. For example, in all embodiments of the present invention, the data backup and/or provisioning device 1 may also be directly coupled and/or communicate with the work system 100.

The reference system 4 identifies original digital data, which is to be protected in particular from encryption. The passivation device 2, which preferably in all embodiments of the present invention can be designed as one or more logic gate devices, in particular FPGA or ASIC or CPLD or SPLD, receives the original digital data 4 and converts it into resulting digital data 6 using a passivation logic gate 8. Due to the physical design of the passivation logic gate, the original data or any data supplied to the passivation logic gate 8 is processed in the same way. In all embodiments of the present invention, the passivation logic gate 8 converts the original digital data into non-executable resulting digital data. Preferably, for example, each binary value (“0” and “1”) is written as text (“0” and “1”) in a file, whereby the resulting digital data 6 has a textual representation of the binary sequence of the original data. However, the textual representation cannot be executed and the binary sequence of the textual representation can essentially be formed from the binary sequences “00110000” and “00110001” of the ASCII codes for the numbers “0” and “1”. Alternatively, color values or gray values or temperature values or other characters can be used to represent the binary values (“0” and “1”).

The reference sign 80 indicates a reactivation device. The reactivation device 80 is preferably used to convert the resulting digital data 6 into a data form that corresponds to the original digital data 4.

The reactivation device 80 preferably comprises a CPU and/or GPU or a logic gate for converting the resulting digital data into the original digital data 4. Furthermore, the CPU and/or GPU or a logic gate may be configured to perform a malware analysis, wherein the resulting digital data or the re-generated original digital data is analyzed for the malware. The conversion of the resulting digital data and/or the malware analysis is preferably performed in a sandbox generated and/or executed by the CPU and/or GPU. Preferably, a malware analysis is first carried out with regard to the resulting digital data and, in a further step, a malware analysis is carried out with regard to the re-generated original data. However, it is also possible that only one of the two or no malware analysis is performed or provided. It is particularly preferable that a sandbox can be generated for each unit of resulting digital data or for each resulting data file. Furthermore, a memory allocation in the sense of a DMZ (demilitarized zone) can be provided for the respective sandbox.

FIG. 1b alternatively shows that the passivation device 2 and the reactivation device 80 can alternatively be provided in one device.

FIG. 1c shows that, in contrast to the embodiment according to FIG. 1a, a providing device 28 can be provided between the passivation device 2 and the reactivation device 80. The digital resulting data 6 generated by the passivation device 2 can then be stored in a data memory of the providing device 28 and forwarded to the reactivation device 80 or mirrored to the reactivation device 80.

FIG. 2a shows, compared to the embodiment according to FIG. 1c, that the passivation device 2 can be part of the providing device 28.

FIG. 2b shows that the providing device according to FIG. 1c can additionally be configured for malware analysis. Preferably, the providing device has a CPU and/or GPU or a logic gate for malware analysis. Preferably, in the malware analysis, binary components, in particular binary sequences, of the resulting digital data are comparable with binary components, in particular binary sequences, of malware. Preferably, the comparison binary sequences of the malware are generated analogously to the translation of the original digital data 4 into the resulting digital data 6. This is advantageous because the binary sequences of the malware can be very long, i.e. can have more than 16 bits and preferably more than 32 bits or more than 64 bits or more than 128 bits, and yet the comparison sequence itself -since it cannot be executed —cannot cause any damage.

FIG. 2c shows a combination of embodiments 2a and 2b. The providing device 28 thus has the passivation device 2 and a malware analysis device, in particular CPU and/or GPU, or a logic gate, in particular a data verification logic gate 69. Embodiments 2b and 2c are advantageous because the resulting digital data 6 stored in a data memory of the providing device 28 can be analyzed for malware continuously or according to defined criteria or after each update of malware identification data, without having to convert the resulting digital data back into the original data. Furthermore, especially in the case of large data sets, this ensures high availability of all resulting digital data in the form of original digital data. Furthermore, the logic-gate-based comparison of binary sequences, in particular using FPGA or ASIC, can be carried out very quickly and saves resources.

FIG. 3 shows schematically that the reactivation device update device 54 of the reactivation device 80 can be updated via a network, in particular the Internet, or the working system 100 or the control device 300. Preferably, an update of a lookup table of a logic gate, in particular an FPGA or ASIC, is carried out, which prevents the update data from contaminating the remaining data memory in the event of contaminated update data.

Furthermore, FIG. 3 shows by way of example that control data for controlling the providing device 28 in the form of original providing device control data 25, in particular from the working system 100 or the control device 300, can be fed to a providing device control logic gate part 37, in particular at least one FPGA or ASIC, and converted into providing device control resulting data 26 by the providing device control logic gate part 37. Preferably, the providing device control logic gate part 37 outputs only a defined number of instructions or only defined instructions. This is advantageous, since the original providing device control data 25 supplied can only trigger one of the defined commands as an effect. It is also possible that the providing device control logic gate part 37 only outputs the commands in the form of providing device control resulting data 26 or that the commands are only processed if the commands correspond to a defined sequence of commands. This is advantageous as it allows, for example, attacks that represent a high number of repetitions of the same command or command sequence to be blocked or filtered out. In the event that commands deviating from the defined sequence of commands occur, an alarm signal can be emitted, for example, or the device 1 can be shut down, etc.

Additionally or alternatively, original reactivation device operating data 77, in particular from the working system 100 or the control device 300, may be feedable to a reactivation device operating logic gate part 78, in particular to at least one FPGA or ASIC, for controlling the reactivation device 80. The reactivation device control logic gate part 78 is configured to generate reactivation device control output data 79 based on the original reactivation device control data 77. Preferably, the reactivation device drive logic gate part 78 outputs only a defined number of commands or only defined commands. This is advantageous, since the original reactivation device operating data 77 supplied can only trigger one of the defined commands as an effect. It is further possible that the reactivation device control logic gate part 78 only outputs the commands in the form of reactivation device control output data 79 or the commands are only processed if the commands correspond to a defined sequence of commands. This is advantageous because, for example, attacks that represent a high number of repetitions of the same command or command sequence can be blocked or filtered out. In the event that commands deviating from the defined sequence of commands occur, an alarm signal can be emitted, for example, or the device 1 can be shut down, etc.

Furthermore, it can be seen from this embodiment by way of example that the providing device 28 and/or the reactivation device 80 are each preferably connected to the working system 100 or the control device 300 via one or at least one unidirectional data conductor 29, 47, in particular an optical fiber. The unidirectional data conductor(s) 29, 47 is/are preferably designed in such a way that data can be transmitted exclusively to the working system 100 or to the control device 300.

However, it is also possible that the providing device 28 and the reactivation device 80 are also connected to one another by means of one or more unidirectional data conductors, in particular for forwarding data, in particular the resulting data, from the providing device 28 to the reactivation device 80.

FIG. 4 essentially corresponds to FIG. 3, wherein the providing device 28 is equipped with a malware verification device, in particular a data verification logic gate or a CPU and/or a GPU. The malware checking device can preferably be updated. It is particularly preferred that a lookup table is updated when the malware checking device is updated. Preferably, the malware analysis data is converted into other binary sequences analogous to the passivation by the passivation device 2. This also preferably applies to the updates of the malware analysis data. The malware checking device then preferably checks the binary sequences of the resulting digital data against the binary sequences of the malware analysis data. Preferably, the malware checking device compares the binary sequences or parts of the binary sequences of the resulting digital data and the malware analysis data. Particularly preferably, the malware verification device has the data verification logic gate and the data verification logic gate particularly preferably has an updateable lookup table, wherein the malware analysis data and/or the update data are held or provided in the Lookup table.

FIG. 5 shows an example according to which the passivation device 2, the providing device 28, the data checking device 46 and the reactivation device 80 are formed separately, in particular in separate housings or on separate PCBs or functionally separated from each other on a PCB. However, it is possible for 2, 3 or all of these devices to be provided as combined device(s).

The data checking device 46 is preferably controlled via a data checking device control logic gate part 64, wherein original data verification device operating data 63, in particular from the working system 100 or the control device 300, is supplied. The data verification device control logic gate part 64 is preferably designed at least as an FPGA or ASIC.

The data verification device operating logic gate part 64 is configured to generate data verification device operating resulting data 65 based on the original data verification device operating resulting data 63. Preferably, the data verification device driving logic gate part 64 outputs only a defined number of instructions or only defined instructions. This is advantageous, since the original data verification device operating data 63 supplied can only trigger one of the defined commands as an effect. It is further possible that the data verification device operating resulting data 64 only outputs the instructions in the form of data verification device operating resulting data 65, or the instructions are only processed when the instructions correspond to a defined sequence of instructions. This is advantageous because, for example, attacks that represent a high number of repetitions of the same command or command sequence can be blocked or filtered out. In the event that commands deviating from the defined sequence of commands occur, an alarm signal can be emitted, for example, or the device 1 can be shut down, etc.

Furthermore, FIG. 5 shows that the reactivation device 80 is preferably connected to the working system 100 or the control device 300 by means of a unidirectional data conductor 99, in particular an optical fiber, in particular for transmitting data, in particular status data of the reactivation device 80, to the working system 100 or the control device 300.

FIG. 6 shows an example according to which the control of one or more of the devices, here only providing device 28 and reactivation device 80 (but also applies to data checking device) can take place via an analog interface. Preferably, the system in this case comprises at least one control data processor for generating a plurality of different analog signals of a control representation type depending on digital control original data. The digital drive original data preferably represents a plurality of different input commands, in particular from at least one input device or a driving device, such as a control device, wherein the plurality of different input commands are generated by the digital drive original data. a control device, wherein the plurality of different input commands of the digital control original data are represented by several different analog signals of the control representation type, wherein the plurality of different analog signals of the control representation type can preferably be generated in several, in particular at least four, different states, wherein several or each analog signal of the control representation type of the plurality of different analog signals of the control representation type represents a defined input command, in particular directly or indirectly, wherein the control data processor has at least one data interface for receiving the digital control original data, wherein the drive data processor comprises at least one signal output for outputting the analog signals of the drive representative type, a drive input signal processor for converting the analog signals of the drive representative type into the digital drive resulting data for manipulating the digital drive resulting data, wherein the drive input signal processor comprises at least one signal input for receiving the analog signals of the drive representative type output via the at least one signal output of the drive data processor, wherein the digital drive resulting data is a digital representation of at least a portion of the analog signals of the drive representative type, wherein the drive input signal processor is at least indirectly coupled to a function processor means for executing or effecting at least one function and preferably a plurality of functions. The analog interface may further be formed according to PCT/EP2022/059665.

FIG. 7 shows a further example of a data backup and/or provisioning device 1 according to the invention, wherein control data of one, several or all devices 28, 46, 80 are provided via one or more analog interface(s) and the analog interface(s) are consequently part of the data backup and/or provisioning device 1. Consequently, FIG. 7 shows that the communication paths from the working system 100 or the control device 300 to the respective device (retention device, data checking device, reactivation device or passivation and retention unit) of the four embodiments described above can be effected partially or completely by means of analog interfaces.

FIG. 8 shows an example of a logic gate device 200 according to the invention. The logic gate device 200 preferably comprises one or at least one passivation logic gate part. The at least one passivation logic gate part 8 is configured to convert original digital data 4 into resulting digital data 6, wherein the resulting digital data 6 represents a passivated form of the original digital data 4.

The passivation logic gate part preferably has a providing device data supply output for outputting the resulting data to a providing device 28. Additionally or alternatively, a providing device control logic gate part may be provided. Providing device control logic gate part 37 is preferably configured to convert original providing device control data into providing device control resulting data.

The providing device control logic gate part preferably has a providing device control data output for outputting the providing device control resulting data. A reactivation logic gate part is preferably additionally or alternatively provided. The reactivation logic gate part is particularly preferably configured to convert the resulting data into target data 22.

The providing device control logic gate part or a data checking logic gate part preferably has a reactivation device data supply output for outputting the target data to a reactivation device 80.

The reactivation logic gate part preferably has a reactivation device data feed input for feeding the resulting data.

Additionally or alternatively, a reactivation device drive logic gate part may be provided for driving the reactivation device 80. The reactivation device control logic gate part is particularly preferably configured to convert original reactivation device operating data into reactivation device control output data.

Preferably, a reactivation device control output data output is provided for outputting the reactivation device control output data. Furthermore, a reactivation device activation data input for supplying the reactivation device activation original data is particularly preferably provided.

Furthermore, at least one data verification logic gate part is preferably provided. The at least one data verification logic gate 60 is preferably configured to analyze digital resulting data 6 with respect to malware.

Preferably, a data verification logic gate part compares representative information, in particular binary sequences or parts of the binary sequences of the malware, of malware stored in a lookup table 62 with the binary sequence or parts of the binary sequence of the original data or performs a comparison in accordance with a defined execution logic, in particular an algorithm.

The data verification logic gate part is preferably configured to convert the resulting data into the original data in a first step, and then effect the comparison with the representation information held in the lookup table 62.

Furthermore, a data validation logic gate part output or each data validation logic gate part output via which the original data generated from the resulting data can be output to an original data memory and/or the original data memory can be physically separated from the providing device data memory and/or the reactivation device data memory 96, in particular in such a way that malware cannot reach the providing device data memory 30 and/or the reactivation device data memory 96.

The original data generated by the data verification logic gate part can preferably be deleted after the adjustment and preferably the memory area on which the data was provided is formatted.

Depending on the matching result, matching data is preferably generated, the matching data being assigned to the corresponding resulting data held in the providing device 28 or the corresponding resulting data being supplemented by the matching data.

The matching data preferably contains information on the version of the representation information and/or the matching result.

Preferably, the data verification logic gate part compares binary sequences of malware resulting data provided in a lookup table 62 with the binary sequence of the resulting data. The binary sequences of malware resulting data held in the lookup table 62 are preferably generated from malware original data according to the transformation of the original data into the resulting data.

Furthermore, a data backup device driving logic gate part may be provided for driving the data backup device 46, i.e. be part of the data backup and/or provisioning device logic gate device 200.

The data verification device operating resulting data logic gate part is preferably configured to convert original data verification device operating resulting data into data verification device operating resulting data.

A data checking device operating data output is preferably provided for outputting the Data verification device operating resulting data.

A data verification device control data input is preferably provided for supplying the data verification device control original data.

One or more FPGAs and/or ASICs are provided.

Preferably, at least two or exactly two or at least three or exactly three or at least four or exactly four of the logic gates: passivation logic gate part, providing device logic control gate part, reactivation logic gate part, reactivation device logic control gate part, data verification logic gate part and/or data verification device logic control gate part are formed by one or one or more FPGAs or ASICs, respectively.

FIG. 9 shows schematically that the providing device 28 has a preferably unidirectional data connection 130, in particular an optical fiber, for transmitting the resulting digital data 6 to the reactivation device 80. Additionally or alternatively, the providing device 28 may comprise a preferably unidirectional data connection 29, in particular an optical fiber, for transmitting, in particular copying or mirroring or shifting, the resulting digital data 6 to a data checking device 46.

Furthermore, the working system 100 or the control device 300 may be interconnected via an update logic gate, in particular FPGA, for updating the malware identification data.

Additionally or alternatively, the providing device 28, the reactivation device 80 and/or the data checking device 46 may be connected to the work system 100 or the control device 300 by means of a unidirectional data connection for transmitting data to the work system 100 or the control device 300. FIG. 10 shows an example of the present invention without a reactivation device, i.e. the data is only backed up and preferably checked for malware. The reactivation of the data can, for example, in the case of data stored in the cloud, take place at the actual owner of the data, whereby the latter would then maintain a reactivation device 80.

FIGS. 11a and 11b show the reactivation device 80 with different degrees of complexity. The respective reactivation devices 80 shown according to the previously shown embodiments may alternatively be designed according to FIG. 11a or 11b. That is, the respective reactivation device 80 may comprise, for example, a reactivation device input interface, a reactivation device data processing device and a data processing device. In this case, the reactivation device data processing device may be, for example, a logic gate, a CPU and/or a GPU.

Alternatively (1 1b), the reactivation device 80 may additionally comprise one or two malware analysis devices, wherein one malware analysis device is preferably hardware-based, in particular an FPGA or ASIC, and the other is preferably software-based and executed by a CPU and/or GPU.

FIG. 12 shows another purely exemplary embodiment, wherein a “host PC”, also called working system 100 or control device 300, preferably a server or a computer system for receiving and processing data, is provided. The “host PC” sends a file or data in general to the device via an interface such as Universal Asynchronous Receiver Transmitter (UART). With UART, a bidirectional connection consists of a channel that enables the data to be sent to the device (RX) and a channel that enables the UART engine to report back to the output system (TX).

The UART engine transmits the data in frames of 8 bits each to an Async FIFO module, which also forwards the data in 8 bits to an encoder module without further synchronization. In the encoder module, which can be designed as a logic gate such as an FPGA, the incoming bits are translated individually into equivalents such as ASCI characters of 8 bits each. In this case, the data size is increased eightfold. The now 64-bit translated data is transferred to a packetizer module. This splits the total amount of translated data into packets and adds a checksum and other packet components.

These packet components are listed in FIG. 13a. In detail, these are the bit sequences marking the start and end of the package (SOP and EOP), the name and ending of the output file and the size of the output file.

These supplemented packets are transferred to the output interface (TX) (see FIG. 13b), which forms the end of the transmit side of the device. Both the output interface (TX) and the first in first out module (Async. FIFO) can provide direct status updates to the input interface (UART) via unidirectional lines and thus control the amount of data provided by the input interface. Alternatively, a memory module could also be used here, which buffers the data traffic.

Opposite the transmitting side described above is a receiving side of the device, or a second device configured as the receiving side. The input interface of the receiving side (RX) (see FIG. 13c) is preferably connected unidirectionally to the output interface of the transmitting side (TX). As the connection between the two interfaces has no further channel for exchanging information such as the clock, a special encoding method can be used during transmission, which integrates the clock into the data stream, as in Manchester encoding, for example.

The input interface on the receiving side (RX) (see FIG. 13c) forwards the received data packets preferably according to the Async. FIFO principle, which checks the individual packets and prepares and resolves them for further processing. The checksum (CRC) and the end of packet (EOP) are removed in the process. During the check, the checksum previously added to the packet on the sending side is compared with a self-calculated checksum. The result of this comparison is appended to the file packet as a CRC Valid value.

By means of another FIFO module and an interface to a receiving system (here also a host PC), the file package is transferred to this receiving system, preferably a data server or a hard disk.

The transmitting and receiving sides can be implemented as separate units and can also be connected via corresponding network nodes instead of the direct connection. However, it would also be possible to implement the device in just one component (logic gate) with separate sectors.

FIG. 14 shows a further schematic example of the data backup and/or provisioning device 1 according to the invention.

The reference sign 160 preferably identifies a housing which is designed to accommodate the passivation device 2, in particular the passivation logic gate 8, the reactivation device 80, in particular the reactivation logic gate 90, the data processing device 97 and/or the providing device 28 or comprises the passivation device 2, the reactivation device 80, the data processing device 97 and/or the providing device 28. In addition, the housing 160 may comprise the terminal 150 or the terminal may be formed as part of the housing 160. Additionally or alternatively, an interface may be provided for preferably directly connecting the terminal 150 to the housing 160 for controlling the data backup and/or provisioning device 1 and/or for introducing malware signature data.

The data processing device 97 may preferably be configured to effect a plurality of functions. For example, the data processing device 97 may effect the function(s) of one or more of the following devices: data processing device of the providing device, data processing device of the passivation and providing unit, data processing device of the data verification device and/or data processing device of the reactivation device. Particularly preferably, the data processing device 97 can store the data provided by the passivation device 2 (arrow P1) and/or preferably, the data processing device 97 can transfer the stored data (which is provided by the passivation device 2) to the reactivation device 80 (arrow P2).

Of course, the data backup and/or provisioning device 1 has further components which are familiar to a person skilled in the art and are therefore not mentioned, such as power supply or switch-on/switch-off means, without such components being shown or described in detail.

It is not intended to execute the “DATA BACKUP” process (reference 3) at the same time as the “DATA RECOVERY” process (reference 47), although this may still be possible.

The “DATA RECOVERY” process (reference sign 47) is preferably only executed if the “Operative System” is encrypted. Thus, after the signature of a malware has been identified, the signature is preferably fed into the system 1 via the terminal 150 and the data processing device 97, in particular CPU and/or GPU or ASIC and/or FPGA, analyzes the representations of individual or several or all files with regard to this signature. All files that do not contain this signature can be provided to the reactivation device 80 in order to be decrypted by it and made available to the productive system 100.

The reactivation device 80, in particular a logic gate or reactivation logic gate 90, in particular an FPGA or ASIC, is preferably configured to effect the conversion of the resulting data 6 into the target data 22 as a function of the representation data 7 or a part of the representation data 7 or inverse representation data or a part of inverse representation data. “Inverse representation data” describes a version of the representation data prepared in such a way that an “inverse encryption” or a decryption of the resulting data 6 for generating the target data 22 can be realized.

FIG. 15 shows a somewhat more detailed functional diagram of a possible technical implementation of the present invention, in particular of the structure shown in FIG. 14. The logic gate unit 71 preferably represents an interface to the productive system 100. The reference sign 72 here purely by way of example indicates a data connection MAC, which is functionally coupled at least with a control logic 73 and/or a DMA 75. Furthermore, the DMA 75 and/or the control logic 73 can be coupled to a CPU 74. The DMA 75 is further preferably directly or indirectly connected to a passivation device 2, in particular a logic gate. On the one hand, the receipt of data coming from the production system 100 can be confirmed by this structure. On the other hand, the data received from the productive system 100 can be preconditioned in such a way that it can be generated in a modified form by means of the passivation device 2. The preconditioning preferably comprises adding file information and/or dividing the bits of the file into predetermined block lengths, in particular 8-bit blocks or 16-bit blocks or 32-bit blocks or 64-bit blocks or 128-bit etc., and feeding the blocks to the passivation device 2.

The passivation device 2, in particular the passivation logic gate 8, is coupled to a data processing device 97. Furthermore, the passivation device 2 forms the only path via which data from the productive system 100 can reach the data processing device 97. The passivation device 2 thereby generates a first encrypted form of the original digital data 4. This first encrypted form can be generated, for example, as described in FIGS. 18/19. Furthermore, malware signature reference data, in particular relating to one or more malware signatures, can be supplied to the data processing device 97 via the terminal 150, for example, or can be generated by the data processing device 97 as a function of data supplied to the data processing device 97. The data processing device 97 or a part of the data processing device 97 can preferably be provided as an analysis unit for determining malware signature data. wherein the analysis unit is particularly preferably configured to generate analysis bit representation data on the basis of resulting data, in particular also on the basis of the representation data assigned or associated with the respective resulting data, wherein the analysis bit representation data represents the first bit sequence in encrypted form and wherein the analysis bit representation data can be analyzed with respect to a malware signature contained in the first bit sequence or with respect to a plurality of malware signature data contained in the first bit sequence. Thus, a second encrypted and analyzable form may preferably be generated from the first encrypted form by the data processing device 97. This second encrypted form can be generated, for example, as described in FIGS. 20/21. In addition, FIG. 17 shows an example of a multi-stage modification of the bit representations of the original data. The second encrypted form is preferably generated from the first encrypted form and/or alongside the first encrypted form, i.e. the first encrypted form can preferably continue to exist.

Alternatively, however, it is also possible for the passivation device 2 to generate the resulting data 6 in such a way that it represents the analysis bit representation data. In this alternative embodiment, the encryption or coding prior to the analysis would be less strong, whereby the overall computing effort and memory requirements would also be smaller.

FIG. 16 shows a purely schematic example of a data backup with subsequent encryption of the working system 100 and an analysis of the data backup with regard to malware and an optional cleanup of the data backup, whereby the infected or compromised files can be deleted and/or moved to quarantine during the optional cleanup. In addition, the data backup or the process on which the data backup is based can include the step of restoring the working system 100 by transferring the data backed up by the data backup back to the working system 100. Especially in a backup situation, the solution or data backup and/or provisioning device 1 according to the invention or the cyberstorage according to the invention is superior to other solutions. Due to the homomorphic properties, it is possible to completely cleanse the backup of malicious code after an attack by malware, in particular ransomware, without the data having to be decrypted and thus without any renewed risk of infection.

Steps S1-S5 describe the following purely by way of example: Si: Backup of the data.

The data is encrypted or encoded by the passivation device 2, in particular the Logic Gate Array (LGA) 2, in the data backup and/or provision device, in particular in the cyberstorage, whereby evaluable data, in particular text representations of the original data, can preferably be generated.

S2: The production system 100 is encrypted 501b and the signature 503 of the malware, in particular ransomware, is determined after the encryption of the production system 100, in particular using forensic methods.

S3: The encoded or encrypted data, in particular the text representations, in the data store 30 are analyzed to identify infected data with respect to the determined signature 503.

S4: Infected data is deleted or isolated.

S5: Restoration of the productive system 100 on the basis of a clean backup or individually checked data. Using the cleaned data, the original digital data or target data 22 of the respective data are preferably generated by means of a reactivation device 80, in particular the Logic Gate Array (LGA) 2 or a further Logic Gate Array).

Steps S1-S5 can be assigned to different levels (SI and SII).

The SI stage is preferably performed for each individual file that is transferred to cyberstorage 1.

Stage SII preferably concerns the ANALYSIS/RESTORATION of data. These steps are preferably only carried out after the production system 100 has been attacked, in particular encrypted, by the malware, in particular ransomware, and the signature of the malware, in particular the ransomware, has been determined.

Consequently, in order to prevent an attack on a data backup and/or provisioning device 1 according to the invention, each file is encrypted or encoded or obfuscated in a preferably random manner.

However, as level SI and level SII fulfill different functions, there are different requirements for encryption, coding and obfuscation.

Preferred requirements for SI: The complexity of the encryption or coding or obfuscation is preferably very high, since each individual file of each system can also have very short malware snippets or malware snippets (e.g. less than 20 bits). For example, it is particularly preferred if the complexity of the first 15 bits of an encrypted file is already higher than 1/1000, in particular higher than 1/2000 and preferably higher than 1/3000 and particularly preferably higher than 1/30002 and most preferably higher than 1/3000′.

The encrypted file is preferably interpretable so that an analyzable version of the encrypted file can optionally be provided in stage SII. After the encryption of the production system and before the start of stage SII, the data storage can preferably be duplicated on another hard disk and separated from the previous system.

Preferred requirements for SII: The complexity of the encryption or coding or obfuscation can be much lower due to the duplicated version on a separate hard disk. Even if a malware, especially a ransomware, were generated by reverse engineering, it would only encrypt the files that have not yet been recovered. Consequently, the compromised file would be removed from the duplicated version and SII can continue to be performed. Due to the logic gates, especially logic gate array (recovery), a (malicious) encryption within the data backup and/or provisioning device 1 cannot spread to the production system 100.

The encryption or coding or obfuscation is preferably analyzable to enable the detection of malware so that the malware can be deleted or the file can be isolated/deleted.

The complexity of the evaluable encrypted file is preferably higher than 1/1000, in particular higher than 1/5000 and preferably higher than 1/10000 and particularly preferably higher than 1/20000 and most preferably higher than 1/49000.

Alternatively, however, it is also possible for the SI to be followed only by the restoration, which eliminates the analysis part. The analysis part can then be carried out on the recovered file using appropriate software, such as a virus scanner/malware scanner from Avira, Kasperski, etc., for example. It is conceivable that the file is restored in a DMZ and can be analyzed there using a virus scanner/malware scanner.

However, the data backup and/or provisioning device 1 according to the invention may alternatively be designed such that the function of forensic analysis and the function of deleting or isolating the identified files is only optionally present or is not present. For example, the one malware analysis software can be executed on the working system 100, which, for example, after a corresponding update with knowledge or data on the malware, immediately examines the original data of the respective files generated by the reactivation device 80 and, if necessary, i.e. if an infection has been detected, deletes or isolates them. In this case, the data backup and/or provisioning device 1 according to the invention represents a preferably continuously fillable and non-encryptable data backup.

Consequently, the invention may concern a method for data backup, preferably comprising the steps of: converting original digital data 4 into resulting digital data 6 by means of a passivation device 2, wherein the passivation device 2 comprises at least one passivation logic gate 8, and wherein the at least one passivation logic gate 8 is configured for converting the original digital data 4 into the resulting digital data 6 and preferably for generating the resulting digital data 6, wherein the original digital data 4 is defined by a first binary sequence 16 (cf. FIG. 17), the resulting digital data being defined by a second binary sequence 18 (cf. FIG. 17), the first binary sequence 16 and the second binary sequence 18 being different from each other, and the step of converting the resulting data into target data 22 by means of a reactivation device 80.

Furthermore, according to the invention, the passivation device 2 may comprise, on the one hand, a passivation device input interface 10 for feeding the original data 4 to the at least one passivation logic gate 8 and, on the other hand, the passivation device 2 may comprise a passivation device output interface 14 for outputting the resulting data generated by the at least one passivation logic gate 8 (cf. FIG. 14). The reactivation device 80 may have a reactivation device input interface 84 for supplying the resulting data to the reactivation device 80, and preferably a reactivation device output interface 86 for outputting the target data 22 (cf. FIG. 14).

The target data 22 preferably matches the original data, in particular exactly matches or preferably matches at least 90% or at least 95% or at least 99% or at least 99.9% or exactly 100%.

FIG. 17 shows how the bit representation of the original data 4 looks, for example, on the production system 100 and how it looks, for example, as an encrypted file 6 (stage 1: storage (SI)) and during analysis (stage 2: ANALYSIS/RECOVERY (SII)). Level 1 or SI is also explained in FIG. 18.

In the event that SII is provided, an analysis unit 170 may be provided for determining and/or identifying malware signature data.

The analysis unit 170 is preferably configured to generate analysis bit representation data 172 on the basis of resulting data 6, in particular also on the basis of the representation data 7 assigned or associated with the respective resulting data 6, wherein the analysis bit representation data 172 represents the first bit sequence 16 in encrypted form and wherein the analysis bit representation data 172 is analyzable with respect to a malware signature 503 contained in the first bit sequence 16 or with respect to a plurality of malware signature data 503 contained in the first bit sequence 16.

The analysis bit representation data 172 with respect to the zeros binary sequence representations 19 of the resulting data 6, in particular of a resulting data file, comprise a plurality of first bit blocks 196 (cf. e.g. FIG. 25a) to at least or exactly one zeros analysis bit representation 176, in particular of a normalization system 506 (cf. FIG. 22), and wherein the analysis bit representation data 172 relating to the ones binary sequence representations 20 of the resulting data 6, in particular of a resulting data file, comprise a plurality of second bit blocks 197 (cf. e.g. FIG. 25a) relating to at least or exactly one ones analysis bit representation 178, in particular of the normalization system 506 (cf. FIG. 22).

The normalization system 506 preferably has a plurality of different bit blocks, in particular from a plurality of systems2^{A}-2^{B}, such as 2⁵-2¹⁰, wherein each bit block is assigned a unique comparison parameter. Preferably, each of these bit blocks can be used as zero binary sequence representation 19 or ones binary sequence representation 20 and consequently as first bit block 196 and second bit block 197.

The comparison parameter can be selected, for example, from the following group of comparison parameters: symbols, colors, grayscale and/or patterns.

According to a further preferred embodiment of the present invention, the gray scale or color per bit block can be optically output by means of at least one pixel or several pixels, in particular 2, 3, 4, 5 or up to 10 or more than 10 or up to 200 pixels.

According to a further preferred embodiment of the present invention, 4 or more than 4 or 8 or more than 8 or 16 or more than 16 or 32 or more than 32 or up to 32 or preferably 64 or more than 64 or up to 64 or most preferably 128 or more than 128 or up to 128 or most preferably 256 or more than 256 or up to 256 different bit blocks 196, 197 are provided.

According to a further preferred embodiment of the present invention, the symbols are designed as numbers and/or letters and/or characters, in particular numbers and/or letters and/or characters according to ASCII code.

An assignment of bit blocks and symbols is for example:

| | | | | | |
|---|---|---|---|---|---|
| | | 01000000 | @ | 01100000 | [symbol] |
| 00100001 | ! | 01000001 | A | 01100001 | a |
| 00100010 | [symbol] | 01000010 | B | 01100010 | b |
| 00100011 | # | 01000011 | C | 01100011 | c |
| 00100100 | $ | 01000100 | D | 01100100 | d |
| 00100101 | % | 01000101 | E | 01100101 | e |
| 00100110 | & | 01000110 | F | 01100110 | f |
| 00100111 | [symbol] | 01000111 | G | 01100111 | g |
| 00101000 | ( | 01001000 | H | 01101000 | h |
| 00101001 | ) | 01001001 | I | 01101001 | i |
| 00101010 | [symbol] | 01001010 | J | 01101010 | j |
| 00101011 | + | 01001011 | K | 01101011 | k |
| 00101100 | , | 01001100 | L | 01101100 | l |
| 00101101 | [symbol] | 01001101 | M | 01101101 | m |
| 00101110 | . | 01001110 | N | 01101110 | n |
| 00101111 | / | 01001111 | O | 01101111 | o |
| 00110000 | 0 | 01010000 | P | 01110000 | p |
| 00110001 | 1 | 01010001 | Q | 01110001 | q |
| 00110010 | 2 | 01010010 | R | 01110010 | r |
| 00110011 | 3 | 01010011 | S | 01110011 | s |
| 00110100 | 4 | 01010100 | T | 01110100 | t |
| 00110101 | 5 | 01010101 | U | 01110101 | u |
| 00110110 | 6 | 01010110 | V | 01110110 | v |
| 00110111 | 7 | 01010111 | W | 01110111 | w |
| 00111000 | 8 | 01011000 | X | 01111000 | x |
| 00111001 | 9 | 01011001 | Y | 01111001 | y |
| 00111010 | : | 01011010 | Z | 01111010 | z |
| 00111011 | ; | 01011011 | [ | 01111011 | { |
| 00111100 | < | 01011100 | \ | 01111100 | \| |
| 00111101 | = | 01011101 | ] | 01111101 | } |
| 00111110 | > | 01011110 | \hat{ } | 01111110 | ~ |
| 00111111 | ? | 01011111 | _{—} | 01111111 | DEL |

[symbol]

indicates data missing or illegible when filed

According to a further preferred embodiment of the present invention, the colors are 128 different colors or more than 128 different colors or preferably 256 different colors or more than 256 different colors or 512 different colors or more than 512 different colors.

A mapping of bit blocks and colors is according to another preferred embodiment of the present invention:

| | |
|---|---|
| 0000000 | Color value 1 |
| 0000001 | Color value 2 |
| . . . | |
| 0111111 | Color value 128. |

According to a further preferred embodiment of the present invention, the gray levels are 128 different gray levels or more than 128 different gray levels or preferably 256 different gray levels or more than 256 different gray levels or 512 different gray levels or more than 512 different gray levels.

A mapping of bit blocks and gray levels is according to another preferred embodiment of the present invention:

| | |
|---|---|
| 0000000 | Gray value 1 |
| 0000001 | Gray value 2 |
| . . . | |
| 0111111 | Gray value 128. |

Preferably, 64 gray values, i.e. in system 2⁶, are used, whereby the bit blocks comprise 000000 to 111111. Additionally or alternatively, 128 color values, i.e. in system 2′, are used, whereby the bit blocks comprise 0000000 to 1111111. Additionally or alternatively, 256 characters, i.e. in system 28, are used, whereby the bit blocks comprise 00000000 to 11111111.

Alternatively, however, it is also possible that only color values and/or gray values are used and that these extend over several systems 2^{A}-2^{B}.

For example, a first group of color values can comprise 32 color values, i.e. belong to system 2′ and thus comprise the bit blocks 00000 to 11111. In addition, a second group of color values may comprise 64 color values, i.e. belonging to system 2⁶ and thus comprising the bit blocks 000000 to 111111. In addition, a third group of color values may comprise 128 color values, i.e. belonging to system 2⁷ and thus comprising the bit blocks 0000000 to 1111111. In addition, a fourth group of color values can comprise 256 color values, i.e. belong to system 28 and thus comprise the bit blocks 00000000 to 11111111. In addition, a fifth group of color values may comprise 512 color values, i.e. belong to system 29 and thus comprise the bit blocks 000000000 to 111111111. In addition, a sixth group of color values can comprise 1024 color values, i.e. belong to system 21⁰ and therefore comprise the bit blocks 0000000000 to 1111111111. In this example, 2016 different bit blocks are thus defined and consequently 2016 different optical output colors are defined. The selection of one of the 2016 bit blocks (with the color represented by) for bit “0” and the selection of one of the remaining 2015 bit blocks (with the color represented by it) for bit “1” thus creates a complexity of 2016*2015=4,062,240, i.e. a selection from 4,062,240 possible choices.

The term color value preferably describes an optically readable but particularly preferably at least machine-readable or machine-processable color. The terms color value and hue can be used synonymously.

The term gray value preferably describes an optically readable but particularly preferably at least machine-readable or machine-processable gray value. The terms gray value, gray scale and gray tone can be used synonymously.

According to a further preferred embodiment of the present invention, the data storage and/or provision device 1 has a data memory, wherein the analysis unit can effect a change of data and/or data generation on the data memory and/or the deletion of data and/or the retrieval of data from the data memory.

However, it is alternatively also possible in the embodiment example shown in FIG. 17 that the passivation device 2, in particular the passivation logic gate 8, generates or selects the zeros binary sequence representation 19 and ones binary sequence representation 20, wherein the zeros binary sequence representation 19 and ones binary sequence representation 20 can also be used or are used as zeros analysis bit representation 176 and ones analysis bit representation 178. I.e., a conversion or recoding or reobfuscation from SI to SII or of the zeros binary sequence representation 19 and ones binary sequence representation 20 into a zeros analysis bit representation 176 and ones analysis bit representation 178 is not absolutely necessary, since the zeros binary sequence representation 19 and ones binary sequence representation 20 can be generated or defined directly as analyzable ones binary sequence representation 190 and analyzable ones binary sequence representation 192.

By way of example only, FIG. 24 shows how the passivation device 2 generates such an analyzable zeros binary sequence representation 190 and analyzable ones binary sequence representation 192.

For the purposes of the present IPR, the term zero binary sequence representation 19 thus includes the analyzable zeros binary sequence representation 190 and the term ones binary sequence representation 20 includes the term analyzable ones binary sequence representation 192, except where a zero analysis bit representation 176 and ones analysis bit representation 178 are mandatorily provided in addition to the zero binary sequence representation 19 and ones binary sequence representation 20.

Passivation device 2, in particular LGA 1, can thus determine or select analyzable zeros binary sequence representation 190 and analyzable ones binary sequence representation 192, in particular a bit representation combination, in particular an analyzable zeros binary sequence representation 190 and an analyzable ones binary sequence representation 192, is randomly selected from an “analysis of bit representation look-up table” 189 or alternatively determined by means of an algorithm. Examples of random algorithms (as may be used in other embodiments of the present invention) are available, for example, here: https://infoskript.de/files/infoskript/oopjava/zufallszahlen/algo38.pdf.

Alternatively, analogous to the look-up tables shown in FIG. 19, the bit representations of the table 189 can be divided into preferably a plurality of different look-up tables, particularly preferably 95 different look-up tables, preferably each with a plurality of positions, particularly preferably 94 positions each (bit representation for “0” and “1” must not be identical), and the passivation device (LGA1) 2 selects an analyzable bit representation look-up table entry 194.

The bit representations shown in FIGS. 25a and 25b represent purely exemplary ASCII characters.

However, it is additionally or alternatively possible that the bit representations represent gray values or that further bit representations are provided which represent gray values. However, it is additionally or alternatively possible that the bit representations represent color values or that further bit representations are provided that represent color values. For example, bit representations could be provided for 128 gray values if the 7-digit bit representations 0000000 to 1111111 are linked to them.

Additionally or alternatively, for example, bit representations could be provided for 512 color values if the 9-digit bit representations 000000000 to 111111111 are linked to them. In the case of 95 ASCII characters, 128 grey values and 512 color values, the available number of analyzable zeros binary sequence representation is 735 and the available number of analyzable ones binary sequence representation is 734.

FIG. 18 shows an example according to which the original file is encrypted or encoded or obfuscated with the aid of the passivation device 2, wherein the passivation device 2 preferably generates the encrypted or encoded or obfuscated file 6 and particularly preferably also one or at least one documentation look-up table 62 (Doc-LuT).

The “data to be stored” or the “file to be stored” is formed by bits, i.e. zeros and ones.

The passivation device 2 preferably generates an encrypted file 6 (where encrypted means in particular “obfuscated”). In addition, the passivation device 2 preferably generates one or at least one or exactly one documentation look-up table 62 with respect to the encrypted file 6.

The documentation look-up table 62 has documentation on which bit sequence (sequence 1 to sequence n) has which length and with which bit representation look-up table entry the zeros and ones of the respective bit sequence 185 are translated or encrypted or obfuscated. Alternatively, it is possible that the length of the bit sequence 185 is always the same, which means that this information may be obsolete.

As shown in FIG. 19, the individual bit representation look-up tables entries 184 can be part of different bit representation look-up tables 186a-n or a single bit representation look-up table 186.

The passivation device 2 preferably randomly selects a “bit representation look-up table” 186a-n for each bit sequence 185, in the example shown (see FIG. 19) from Lut-Rep-01 to LuT-Rep-60. In addition, the passivation device 2 selects a representation combination (fields marked in gray/black are preferably not selectable in order to avoid indeterminacy). Example: LuT-Rep-01 No. 21 defines that “0” bits are represented by 0110 and “1” bits by “00”; LuT-Rep-07 No. 45 defines that “0” bits are represented by 00111 and “1” bits by “010”; etc. Alternatively, the passivation device 2 may preferably randomly select a bit representation look-up table entry 184 for each bit sequence 185.

In the event that an analysis of the encrypted file 6 is to be possible, the passivation device 2 preferably generates, in particular randomly, a zeros analysis bit representation 176 and ones analysis bit representation 178 for preferably each bit sequence 185 or assigns such a zeros analysis bit representation 176 and ones analysis bit representation 178 to the respective bit sequence 185. The zeros analysis bit representation 176 and ones analysis bit representation 178 may then also be/be added to the look-up table 62 or be part of another look-up table associated with the encrypted file 6 or file associated with the encrypted file 6 or a table entry associated with the encrypted file 6.

The zeros analysis bit representation 176 and ones analysis bit representation 178 may, for example, be selected from the ASCII encoding, whereby particularly preferably only the optically displayable ASCII encoding entries may be selected.

By way of example, successive bits of the “file to be stored” 4 are underlined with four lines of different thicknesses. Each of these lines of different thicknesses indicates the bits of a bit sequence 1-4 185. In this example, bit sequence 1 has 10 bits, bit sequence 2 has 4 bits, bit sequence 3 has 9 bits and bit sequence 4 has 10 bits.

Each bit sequence 1-4 is preferably assigned a bit representation look-up table entry 184 by the passivation device 2, in particular at random, or the zero binary sequence representation 19 and ones binary sequence representation 20 stored in the respective bit representation look-up table entry 184 is linked to the respective bit sequence.

In the present example, the bit representation look-up table entry 184 “LuT-Rep-06 No. 5” (see FIG. 19) is therefore selected for bit sequence 1, as a result of which the zero binary sequence representation 19 is “000” and the ones binary sequence representation 20 is “001”. In the example shown, the bit representation look-up table entry 184 “LuT-Rep-05 No. 22” (see FIG. 19) is selected for bit sequence 2, whereby the zero binary sequence representation 19 is “1010” and the ones binary sequence representation 20 is “000”. It can be seen that the individual zero binary sequence representations 19 and the ones binary sequence representations 20 of the individual bit sequences can differ in terms of the respective length (number of bits) and the respective bit sequence, which results in a high level of complexity.

The passivation device 2, in particular the passivation logic gate 8, is thus preferably configured to generate or select or determine zero binary sequence representations 19 for zeros of the first binary sequence 16 of the original digital data 4, and wherein the passivation device 2, in particular the passivation logic gate 8, is configured to generate or select or determine ones binary sequence representations 20 for ones of the first binary sequence 16 of the original digital data 4.

The zero binary sequence representation 19 preferably has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

The ones binary sequence representation preferably has at least two bits and preferably more than 2 bits, in particular 3 bits or more than 3 bits or 4 bits or more than 4 bits or 5 bits or more than 5 bits or 6 bits or more than 6 bits or 7 bits or more than 7 bits or 8 bits or more than 8 bits.

With respect to the encrypted file 6, the respective encrypted or coded or obfuscated representation 188 of the respective bit sequence is marked in the present example with dashed lines of different thicknesses. The encrypted or coded or obfuscated representation 188 of bit sequence 1 is therefore: 000000001000000000000001000000. The encrypted or coded or obfuscated representation 188 of bit sequence 2 is therefore: 101000010101010.

The encrypted or encoded or obfuscated file 6 or the resulting data 6 is composed of the encrypted or encoded or obfuscated representation 188 of the bit sequences 1-n, the encrypted or encoded or obfuscated representation 188 of the individual bit sequences preferably being stored in the order in which the bit sequences occur one after the other. In this example, the bits 1-33 (001000010001000000000011111001010) of the file to be stored 4 are therefore represented by the new bits 1-98 (000000001000000000000001000000101000010101010011011 01101101101101101111111000000001111110011100111) of the encrypted or coded or obfuscated file 6 or the resulting data 6.

The passivation device 2, in particular the passivation logic gate 8, is preferably configured to define or provide or determine or generate or select different zero binary sequence representations 19 and/or ones binary sequence representations 20 for different original data 4a-n, in particular different files 4, in particular original data to be processed successively.

The passivation device 2, in particular the passivation logic gate 8, is preferably configured to define or provide or determine or generate or select different zero binary sequence representations 19 and/or ones binary sequence representations 20 for generating resulting data 6 with respect to the original data 4, in particular the first binary sequence 16.

The passivation device 2, in particular the passivation logic gate 8, is preferably configured one bit representation look-up table entry 184, in particular in each case one or in each case at least or exactly one bit representation look-up table entry 184 (cf. FIG. 19) per bit sequence in a look-up table, in particular a bit representation look-up table 186, or in a plurality of look-up tables, in particular a plurality of bit representation look-up tables 186a-n, with a plurality of preferably defined Zeros-ones binary string representation combinations, in particular at random. The one look-up table or the plurality of look-up tables preferably have at least 10, in particular at least 100 and preferably at least 1000 and particularly preferably more than 3000 and most preferably more than 5000 or 10000, different Zeros-ones binary string representation combinations.

The look-up table 186 or the look-up tables 186a-n is/are provided or stored or deposited in a memory device of the Passivation device.

The passivation device 2, in particular the passivation logic gate 8, is preferably configured to generate resulting data 6 with respect to the original data 4 of a file, wherein the resulting data 6 can be generated with a plurality of zero binary sequence representations 19 which are different from one another, wherein the zero binary sequence representations 19 which are different from one another have bit sequences of different lengths and/or different bit sequences of the same length.

The passivation device 2, in particular the passivation logic gate 8, is preferably configured to generate resulting data 6 with respect to the original data 4 of a file, wherein the resulting data 6 can be generated with a plurality of ones binary sequence representations different from one another, wherein the ones binary sequence representations 20 different from one another have bit sequences of different lengths and/or different bit sequences of the same length.

The passivation device 2, in particular the passivation logic gate 8, is preferably configured to generate resulting data 6 with respect to the original data 4 of a file, wherein the resulting data 6 can be generated with a plurality of ones binary sequence representations 20 different from one another, wherein the ones binary sequence representations 20 different from one another have bit sequences of different lengths and/or different bit sequences of the same length, and wherein the passivation device 2, in particular the passivation logic gate 8, is preferably configured to generate the resulting data 6 with a plurality of ones binary sequence representations 19 different from one another, wherein the ones binary sequence representations 19 different from one another have the same length, in particular the passivation logic gate 8, is preferably configured to generate the resulting data 6 with a plurality of different zero binary sequence representations 19, the different zero binary sequence representations 19 having different bit sequences of different lengths and/or different bit sequences of the same length, the bit sequences of the resulting data 6, in particular per bit sequence 185, being different from one another for the zero binary sequence representations 19 and the ones binary sequence representations 20.

The passivation device 2, in particular the passivation logic gate 8, is preferably configured to generate representation data 7 for the resulting data 6 or with respect to the resulting data 6, wherein the representation data 7 indicates which zero binary sequence representations 19 and/or ones binary sequence representations 20 the resulting data 6, in particular the respective concrete resulting data file, has.

The representation data 7 preferably indicates which zero binary sequence representations 19 and/or which ones binary sequence representations 20 form the resulting data 6 at which position of the resulting data 6.

The passivation device 2, in particular the passivation logic gate 8, is preferably configured to divide the first binary sequence 16 into bit sequences 185 or original data bit sequences en 185, wherein the original data bit sequences 185 comprise a plurality of bits, wherein the plurality of bits comprise one “0” bit or a plurality of “0” bits and one “1” bit or a plurality of “1” bits or “0” bits or “1” bits.

The passivation device 2, in particular the passivation logic gate 8, is preferably configured to store the number of bits of each original data bit sequence 185 in the representation data 7 The passivation device 2, in particular the passivation logic gate 8, is preferably configured to store, in particular to generate or select, a bit representation combination 187 or Zeros-ones binary string representation combinations 187 in the representation data 7 for each original data bit sequence 185.

Preferably, each bit representation combination 187 has a zero binary sequence representation 19 or a combination with a zero binary sequence representation 19 for all “0” bits of an original data bit sequence 185 and preferably each bit representation combination 187 has a ones binary sequence representation 20 or a combination with a ones binary sequence representation 20 for all “1” bits of the same original data bit sequence 185. Additionally or alternatively, for all “0” bits and “1” bits of an original data bit sequence 185, each bit representation combination preferably has a Zeros-ones binary string representation combinations 187 or a concatenation with a Zeros-ones binary string representation combinations 187.

The passivation device 2, in particular the passivation logic gate 8, is preferably configured to divide the first n bits of the first binary sequence 16 into original data bit sequences 185a-n, the average number of bits of which is preferably less than 50 bits, in particular less than 20 bits or less than 15 bits, wherein the first n bits are less than 10,000 bits, in particular less than 5,000 bits and preferably less than 1,000 bits and particularly preferably less than 500 bits and most preferably less than 200 bits. Additionally or alternatively, the passivation device 2, in particular the passivation logic gate 8, is preferably configured to divide the last m bits of the first binary sequence 16 into original data bit sequences 185, the average number of bits of which is preferably less than 50 bits, in particular less than 20 bits or less than 15 bits, wherein the last m bits are less than 10000 bits, in particular less than 5000 bits and preferably less than 1000 bits and particularly preferably less than 500 bits and most preferably less than 200 bits.

The passivation device 2, in particular the passivation logic gate 8, is preferably configured to divide the first n bits of the first binary sequence 16 into original data bit sequences 185, the number of bits of which is between 2 bits and 50 bits, in particular between 4 bits and 20 bits and preferably between 5 bits and 15 bits. In addition or alternatively, the passivation device 2, in particular the passivation logic gate 8, is preferably configured to divide the last m bits of the first binary sequence 16 into original data bit sequences 185, the number of bits of which is between 2 bits and 50 bits, in particular between 4 bits and 20 bits and preferably between 5 bits and 15 bits.

This embodiment is advantageous as it results in a very high level of complexity and consequently safety.

The passivation device 2, in particular the passivation logic gate 8, is preferably configured to convert the bits between the first n bits, in particular, for example, 100 bits or 500 bits or up to 500 bits or 1000 bits or up to 1000 bits or 10000 bits or up to 10000 bits, of the first binary sequence 16 and the last m bits, in particular, for example, 100 bits or 500 bits or up to 500 bits or 1000 bits or up to 1000 bits or 10000 bits, of the first binary sequence 16 into original data sequences.B. 100 bits or 500 bits or up to 500 bits or 1000 bits or up to 1000 bits or 10000 bits or up to 10000 bits, of the first bit sequence 16 into original data bit sequences 185, the average number of bits of which is preferably greater than 20 bits, in particular greater than 50 bits or greater than 100 bits.

This embodiment is advantageous because the longer bit sequences 185 mean that less memory is required.

Preferably, the number of different zero binary sequence representations 19 and the number of different ones binary sequence representations 20 per resulting data 6, in particular per resulting data set or resulting data file, can be the same or different.

The representation data 7 can preferably be generated as part of the resulting data 6 or as part of a resulting data set. Alternatively, the representation data 7 can be generated as a separate data set assigned to the resulting data 6.

The passivation device 2, in particular the passivation logic gate 8, is preferably configured, in particular randomly, to predetermine a zeros analysis bit representation 176 with respect to the zeros binary sequence representations 19 of the first binary sequence 16, and the passivation device 2, in particular the passivation logic gate 8, is preferably configured, in particular randomly, to predetermine a ones analysis bit representation 178 with respect to the ones binary sequence representations 20 of the first binary sequence 16.

The passivation device 2, in particular the passivation logic gate 8, is preferably configured to generate the default zeros analysis bit representation 176 and ones analysis bit representation 178 as part of the resulting data 6 and/or as part of the representation data 7 and/or as part of the analysis bit representation data 172.

Alternatively, the analysis unit 170 (cf. FIG. 17) may be configured, on the one hand, to randomly define, determine or select at least one or exactly one zeros analysis bit representation 176 for generating the analysis bit representation data 172 with respect to the zeros binary sequence representations 19 of the first binary sequence 16 and, on the other hand, the analysis unit 170 may be configured to randomly define, determine or select at least one or exactly one ones analysis bit representation 178 for generating the analysis bit representation data 172 with respect to the ones binary sequence representations 20 of the first binary sequence 16.

The passivation device 2, in particular the passivation logic gate 8, is additionally or alternatively preferably configured to execute an algorithm for predetermining or generating or determining or selecting the zero binary sequence representations 19 and/or the ones binary sequence representations 20, or the passivation device 2, in particular the passivation logic gate 8, is preferably configured to execute a random algorithm for randomly determining or generating or determining or selecting the zero binary sequence representations 19 and/or the ones binary sequence representations 20.

FIG. 19 shows a plurality of look-up tables, wherein the plurality of look-up tables preferably comprise a plurality of zeros-ones binary string representation combinations 187, wherein the zeros-ones binary string representation combinations 187a-n comprise zeros-bit representations 19 and ones-bit representations 20, wherein at least individual zeros-bit representations 19 of the zeros-ones binary string representation combinations 187 each comprise a first number of bits, and wherein at least individual ones-bit representations 20 of the zeros-ones binary string representation combinations 187 each have a second number of bits, wherein the first number of bits and the second number of bits are the same at least in the case of individual Zeros-ones binary string representation combinations 187 and/or wherein the first number of bits and the second number of bits are different at least in the case of individual Zeros-ones binary string representation combinations 187.

Consequently, a data backup and/or provisioning device 1, in particular data backup and/or provisioning device 1, or a cyberstorage is disclosed, at least comprising a passivation device 2 for converting original digital data 4 into resulting digital data 6, wherein the passivation device comprises at least one passivation logic gate 8 and wherein the at least one passivation logic gate 8 is configured to convert the original digital data 4 into the resulting digital data and to generate the resulting digital data, wherein the original digital data 4 is defined by a first binary sequence 16, wherein the resulting digital data is defined by a second binary sequence 18, wherein the first binary sequence 16 and the second binary sequence 18 are different from each other, a reactivation device 80 for converting the resulting data into target data 22 matching the original data.

This data backup device is particularly preferred for carrying out a data backup method according to the invention, which preferably comprises at least the following steps: Converting original digital data 4 into resulting digital data 6 by means of a passivation device, wherein the passivation device comprises at least one passivation logic gate 8, and wherein the at least one passivation logic gate 8 is configured to convert the original digital data 4 into the resulting digital data and to generate the resulting digital data, wherein the original digital data 4 is defined by a first binary sequence 16, wherein the resulting digital data is defined by a second binary sequence 18, wherein the first binary sequence 16 and the second binary sequence 18 are different from each other, converting the resulting data into target data 22 corresponding to the original data by means of a reactivation device 80. The reactivation device 80 preferably has a reactivation device input interface 82 for supplying the resulting data to the reactivation device 80, and preferably a reactivation device output interface 86 for outputting the target data 22. The target data 22 preferably matches the original data by at least 90%, or by at least 95%, or by at least 99%, or by at least 99.9%, or most preferably by exactly 100%. In other words, the bit sequence of the original data 4 and the bit sequence of the target data 22 generated using the resulting data 6 preferably match or are identical. The passivation device 2 preferably comprises a passivation device input interface 10 for supplying the original data to the at least one passivation logic gate 8, and wherein the passivation device 2 comprises a passivation device output interface 14 for outputting the resulting data generated by the at least one passivation logic gate 8.

FIG. 20 shows the encrypted file 6 on the left-hand side of the image, in particular with the look-up table 62 contained or assigned therein.

The look-up table preferably represents the length of the individual bit sequences 1-n and the respective representation for “0” and “1”. Furthermore, the look-up table 62 may already contain the information into which zeros analysis bit representation 176 and into which ones analysis bit representation 178 the respective zeros binary sequence representation 19 and ones binary sequence representation 20 are to be translated.

Based on the look-up table entries, a machine-processable representation is generated in a processing editor for each “0” bit and each “1” bit, in particular as a character/symbol or grey value or color value. The processable representation can be text, for example.

In this example, the processing submission, in particular processing editor or text editor or word processor 171, of the analysis unit 170 generates analyzable text based on an encrypted file 6 and a documentation look-up table 62.

The generated text represents (!) bits of the original file. The analysis unit 170 thus preferably generates text and/or gray and/or colored pixels by means of the processing device 171 by translating the bits of the encrypted file 6 in dependence on the documentation of the Doc-LuT 62. Therefore, the processing device 171 of the analysis unit 170 receives as input the length of sequence 1, which is 10 bits. In addition, the processing device 171 reads from the sequence 1 that the text symbol “0” is represented by 000 and the text symbol “1” is represented by 001. The analyzing unit 170 generates text symbols “0” and “1” in the processing device 171 until the sequence 1 is completely translated (see: translation of sequence 1).

Next, the processing device 171 receives as input the length of sequence 2, which is 4 bits. In addition, the processing device 171 reads from the sequence 2 that the text symbol “0” is represented by 1010 and the text symbol “1” is represented by 000. The analysis unit 170 generates text symbols “0” and “1” until sequence 2 is completely translated (see: translation of sequence 2).

This routine is performed until all bits of the encrypted file 6 have been translated into text symbols or gray values or color values.

The text generated by the processing device 171 reads:
0010000100001000000000011111001010

The text generated by the processing device 171 preferably corresponds to the bits of the “file to be stored”:
0010000100001000000000011111001010

The bit representation of the text created by the processing device 171 in memory is: 0000000000000000000000010000000000000000000000000000000000000000000000010000000000 0000000000000000000000000000000000001000000000000000000000000000000000000000000000 0000000000000000000000000000000000000000001000000010000000100000001000000010000000 00000000000000001000000000000000100000000 (these are the analysis bit representation data 172) (see reference marks 176 and 176 on FIG. 20)

FIG. 21 corresponds in essence to FIG. 20, with only the zeros analysis bit representation 176 and the ones analysis bit representation 178 differing from those used in FIG. 20.

The text generated by the processing device 171 reads: (whereby in this special case the “0” is represented by ASCII+ and the “1” by ASCII D) ++D+++++D+++++D++++++++++DDDDD++D+D+

The text generated by the processing device 171 preferably corresponds to the bits of the “file to be stored”:
0010000100001000000000011111001010

The bit representation of the text created by the processing device 171 in the memory is as follows: (Since “ASCII+” is defined by the first bit block 196 “00101011” and “ASCII D” by the second bit block 197 “01000100”, the sequence is as follows)
0010101100101011010001000010101100101011001010110010101100101011010001000010101100 1010110010101100101011001010110100010000101011001010110010101100101011001010110010 1011001010110010101100101011001010110100010001000100010001000100010001000100001010 110010101101000100001010110100010000101011 (these are the analysis bit representation data 172).

FIG. 22 shows on the left an example of how comparison data 505 can be generated on the malware signature data. FIG. 22 further shows on the right-hand side how the analysis bit representation data can be examined using the comparison data 505 to determine whether it has the malware signature.

In particular, after the analysis bit representation data of a file has been analyzed to determine whether a specific malware signature —in particular the malware signature of the malware by means of which the production system was encrypted —is contained in the analysis bit representation data and it has been determined that the analysis bit representation data of this file does not contain the malware signature, the file can be translated or decrypted into target data 22 matching the original data 4 by means of the reactivation device 80 for transmission to the production system 100. The reactivation device 80 may be arranged to generate the target data 22 using the analysis bit representation data.

Alternatively, the reactivation device 80 may be arranged to generate the target data 22 based on the resulting data, in particular taking into account the representation data 7.

Malware signature data can be kept, in particular stored, in the data storage 28 of the data backup and/or provisioning device 1 or the cyberstorage 1 according to the invention.

The malware signature data 503 can preferably be provided as malware signature reference data 182, in particular can be provided by the analysis unit 170. The analysis unit 170 is preferably configured to use the malware signature reference data 182 to generate comparison data 505 for comparison with the analysis bit representation data 172. Comparison data 505 is preferably generatable according to the at least one and preferably exactly one zeros analysis bit representation 176 or zeros binary sequence representation 19, in particular the analyzable zeros binary sequence representation 190, and according to the at least one or preferably exactly one ones analysis bit representation 178 or ones binary sequence representation 20, in particular the analyzable ones binary sequence representation 192.

Based on the “malware signature” reference file 182 and a translation definition, in particular e.g. ASCII definition of each Doc-LuT, a translation of the malware signature is created for each encrypted file 6, in particular by the passivation device 2 or the analysis unit 170, i.e. the malware signature is normalized by translating it according to the first bit block 196 and the second bit block 197. The preferably two and particularly preferably exactly two different characters, gray value(s) and/or color value(s), by means of which the processing device 171, in particular processing editor, in particular color, grayscale and/or character editor, outputs, in particular represents, the first binary sequence 16 in a machine-processable, in particular optically outputable manner, correspond to the two different characters, gray value(s) and/or color value(s), on the basis of which the comparison data 505 were generated or from which the comparison data 505 consist. In the sense of the entire disclosure, the term gray value can also be replaced by the term gray tone and the term color value can be replaced by the term color tone (the same applies to the respective plural).

Preferably, the search for the character sequence defined by the Comparison data 505 in the “created text” (cf. FIG. 20 and FIG. 21) or with the “created text”, which represents the first binary sequence 16 or at least parts of the first binary sequence 16, is carried out during the file analysis step. The “created text” can also have gray values and/or color values, in particular individual or multiple pixels, or consist entirely of these, i.e. without characters and/or other symbols. In other words, the “created text” does not have to be text, but can consist purely of pixels or of a combination of pixels and text.

If the comparison data 505 is found in a “created text”, this file is preferably treated separately, in particular deleted or moved to quarantine. Particularly preferably, however, this file or the file having the malware signature (i.e. the encrypted file 6 and/or the analysis bit representation data 172 of this encrypted file 6) is prevented from being reactivated by the reactivation device.

In the example shown, the zeros analysis bit representation 176 or the zeros binary sequence representation 19, in particular the analyzable zeros binary sequence representation 190, and correspondingly the at least one or preferably exactly one ones analysis bit representation 178 or the ones binary sequence representation 20, in particular the analyzable ones binary sequence representation 192, are represented as characters or symbols, in particular ASCII characters, and are contained in the memory by the corresponding bit blocks. In addition or alternatively, however, color values and/or gray values can also be used as the zeros analysis bit representation 176 or the zeros binary sequence representation 19, in particular the analyzable zeros binary sequence representation 190, and correspondingly as the at least one or preferably exactly one ones analysis bit representation 178 or the ones binary sequence representation 20, in particular the analyzable ones binary sequence representation 192.

It is also conceivable that the malware signature data 503 may be provided as a malware signature comparison table (not shown), wherein the analysis unit 170 may be configured to select comparison data from the malware signature comparison table for comparison with the analysis bit representation data 172.

FIG. 23 shows that the data backup and/or provisioning device 1 according to the invention or the cyberstorage device 1 according to the invention uses a reactivation device 80 for restoring the respective file 9, i.e. for generating a “recovered file” 9 which corresponds to the respective “file to be stored” 4, or corresponds substantially or exactly, and is preferably identical (cf. FIG. 14). The reactivation device 80 may be designed as a GPU or CPU, wherein the reactivation device 80 is preferably designed as a logic gate device or logic gate unit. Preferably, the reactivation device 80 and the passivation device 2 can be part of the same logic gate device, in particular FPGA or ASIC, or consist of different or separate logic gate devices, in particular FPGA or ASIC.

The reactivation device 80 preferably generates a “Recovered File” by writing bits to the productive system 100 in dependence on the “Encrypted File” 6 and the Doc-LuT 62, wherein the reactivation device 80 is configured to process the look-up table “backwards”.

The documentation look-up table (Doc-LuT) preferably represents a key or instructions for decoding or deciphering or deobfuscating the data represented by the sequences S₁ to Sₙ.

This means that sequence 1 (“0”=000; “1”=001) is translated from the first sequence 000000001000000000000001000000 of the encrypted file 6 according to Doc-LuT until 10 bits are recovered: Result: 0010000100.

Sequence 1 is underlined on the left-hand side of the screen with the same line as the restored result on the right-hand side of the screen.

The second sequence 101000010101010 of the encrypted file 6 is translated according to Doc-LuT sequence 2 (“0”=1010; “1”=000) until 4 bits are recovered: Result: 0100.

Sequence 2 is underlined on the left-hand side of the screen with the same line as the restored result on the right-hand side of the screen.

The third sequence 01101101101101101101101111111 of the encrypted file 6 is translated according to Doc-LuT Sequence 3 (“0”=011; “1”=11111) until 9 bits are recovered: Result: 000000001.

Sequence 3 is underlined on the left-hand side of the screen with the same line as the restored result on the right-hand side of the screen.

The fourth sequence 000000001111110011100111 of the encrypted file 6 is translated according to Doc-LuT Sequence 4 (“0”=111; “1”=00) until 10 bits are recovered: Result: 1111001010.

Sequence 4 is underlined on the left-hand side of the screen with the same line as the restored result on the right-hand side of the screen.

### Etc.

The underlining on the left and right-hand sides of the picture is only intended to make it easier to follow, it does not have a technical effect.

In the event that the encrypted file 6 was generated using one or at least one or more than one analyzable zeros binosary sequence representation and one or at least one or more than one analyzable ones binary sequence representation, the look-up table may have fewer entries, in particular in this case it may be that no sequence lengths need to be specified. Preferably, in this case, for example, only a first bit block 196 and a second bit block 197 are used, whereby splitting into multiple sequences would not be necessary.

### LIST OF REFERENCE SYMBOLS

| | |
|---|---|
| 1 | Data backup and/or provisioning |
| | device // Cyberstorage |
| 2 | Passivation device (LGA1) |
| 3 | Data channel from the productive |
| | system, preferably unidirectional |
| 4 | original digital data / “file to be stored” |
| 6 | Resulting digital data / “encrypted file” |
| 7 | Representation data |
| 8 | Passivation logic gate |
| 9 | digital recovery data / “recovered file” |
| 10 | Passivation device input interface |
| 14 | Passivation device output interface |
| 16 | first binary sequence |
| 18 | second binary sequence |
| 19 | Zero binary sequence representation |
| 20 | ones binary sequence representation |
| 22 | Target data |
| 25 | Original holding device control data |
| 26 | Providing device-income data |
| 28 | Providing device |
| 29 | data channel, in particular |
| | unidirectional, of the providing device |
| | to the operating system or control |
| | device, in particular for transmitting |
| | status data of the providing device |
| 30 | Providing device data memory |
| 31 | Update channel for updating the |
| | malware identification data |
| 32 | Retention device input interface |
| 33 | Data channel from the data verification |
| | logic gate to the providing device or |
| | additionally or alternatively to the |
| | reactivation device |
| 34 | Retention device output interface |
| 35 | Data channel, in particular memory, |
| | from the providing device to the data |
| | check logic gate |
| 36 | Data processing device of the |
| | providing device |
| 37 | Providing device control logic gate |
| | part |
| 38 | Passivating and providing unit |
| 40 | Providing unit data memory |
| 42 | Passivating and providing unit output |
| | interface |
| 44 | data processing device of the |
| | passivation and providing unit |
| 46 | Data checking device |
| 47 | feedback channel, in particular |
| | unidirectional, of the data checking |
| | device to the operating system or |
| | control device, in particular for |
| | transmitting status data of the data |
| | checking device |
| 48 | Data checking device input interface |
| 49 | Data checking device output interface |
| 50 | Data processing device of the data |
| | verification device |
| 51 | Update channel for updating the |
| | malware identification data |
| 52 | Data checking device-data memory |
| 54 | Update device |
| 56 | Malware representation data |
| 58 | Malware representation data binary |
| | sequence |
| 60 | Data verification logic gate |
| 62 | Lookup table |
| 63 | Original data verification device |
| | control data |
| 64 | Data checking device-control logic |
| | gate part |
| 65 | Data checking device-tax resulting |
| | data |
| 66 | Data checking device-control data |
| | output |
| 70 | Data connection, in particular Ethernet |
| | connection |
| 71 | Logic gate unit |
| 72 | Data connection MAC |
| 73 | Control logic |
| 74 | CPU |
| 75 | DMA |
| 77 | Original reactivation device control |
| | data |
| 78 | Reactivation device-activation logic |
| | gate part |
| 79 | Reactivation device-tax resulting data |
| 80 | Reactivation device (LGA 2) |
| 81 | Data conductor |
| 82 | Reactivation device input interface |
| 84 | Reactivation device output interface |
| 85 | Reactivation device update device |
| 86 | Reactivation device data processing |
| | device |
| 88 | data channel from the providing device |
| | to the reactivation logic gate |
| 89 | data channel from the reactivation |
| | logic gate to the reactivation device |
| 90 | Reactivation logic gate |
| 92 | first Reactivation device data memory |
| 94 | Second Reactivation device data |
| | memory |
| 96 | Reactivation device data memory |
| | (92 + 94) |
| 97 | data processing device, in particular |
| | CPU and/or GPU and/or ASIC and/or |
| | FPGA |
| 98 | Sandbox / DMZ |
| 99 | data channel, in particular |
| | unidirectional, from reactivation |
| | device to operating system or control |
| | device, in particular for transmitting |
| | status data of the reactivation device |
| 100 | Working system/productive system |
| | (PC or server) |
| 120 | Activation path via analog interface |
| | from control device or working system |
| | to providing device |
| 122 | Activation path via analog interface |
| | from control device or working system |
| | to data checking device |
| 124 | Activation path via analog interface |
| | from control device or working system |
| | to reactivation device |
| 126 | unidirectional mirroring of the |
| | generated resulting data to data |
| | checking device |
| 128 | update logic gate, in particular FPGA, |
| | for updating the malware identification |
| | data |
| 130 | data channel, in particular |
| | unidirectional data channel, in |
| | particular optical fiber, for forwarding |
| | the resulting data to reactivation device |
| 134 | alternative or optional feedback |
| | channel from the data checking device |
| | to the providing device, wherein the |
| | feedback channel has an analog |
| | interface |
| 136 | alternative or optional feedback |
| | channel from the reactivation device to |
| | the data checking device, wherein the |
| | feedback channel has an analog |
| | interface |
| 140a | first part of the passivating logic gate, |
| | in particular first FPGA |
| 140b | second part of the passivation logic |
| | gate, in particular second FPGA |
| 150 | Terminal |
| 160 | Housing |
| 169 | Comparison parameters |
| 170 | Analysis unit/processing device, in |
| | particular processing editor, in |
| | particular color, grayscale and/or |
| | character editor, |
| 171 | Processing device |
| 172 | Analysis bit representation data |
| 176 | Zeros analysis bit representation |
| 178 | Ones analysis bit representation |
| 180 | Text representation of the bits of the |
| | “file to be stored” |
| 182 | text representation of the bits of the |
| | harmful software signature or malware |
| | signature |
| 184 | Bit representation look-up table entry |
| 185 | Bit sequence or original data bit |
| | sequence |
| 186a-n | Bit representation look-up tables |
| 187 | Zeros-ones binary string representation |
| | combinations |
| 188 | encrypted or coded or obfuscated |
| | representation of the respective bit |
| | sequence |
| | Analysis of bit representation look-up |
| | table |
| 190 | analyzable zeros binary sequence |
| | representation |
| 192 | analyzable ones binary sequence |
| | representation |
| 194 | Analyzable bit representation look-up |
| | table entry |
| 196 | first bit block |
| 197 | second bit block |
| 200 | Data backup and provision device |
| | logic gate device |
| 300 | Control device |
| 400 | Update server |
| 500 | data processing, in particular saving, |
| | modifying, analyzing and/or deleting |
| 501a | file encrypted with harmful software, |
| | in particular ransomware |
| 501b | files encrypted with harmful software, |
| | in particular ransomware / system |
| 502 | Introduction of the harmful software or |
| | malware signature data and/or |
| | selection of one or more files and/or |
| | starting the analysis and/or starting the |
| | reactivation |
| 503 | Harmful software or malware signature |
| 504 | Harmful software or malware signature |
| | representation bit sequence |
| 505 | Comparison data |
| 506 | Normalization system |
| SOP | Start of package |
| Filename | Filename |
| File length | File size |
| EOP | End of the package |
| CRC32 | Cyclic redundancy check |
| Ftbs | File to be stored |
| Ftbr | recovered file |
| P1 | Arrow between passivation |
| | device 2 and data processing |
| | device 97 |
| P2 | Arrow between data |
| | processing device 96 and |
| | Reactivation device 80 |

1. A data backup device, comprising:
a passivation device configured to convert original digital data into resulting digital data, and
a reactivation device configured to convert the resulting digital data into target data corresponding to the original data,
wherein:
the passivation device comprises at least one passivation logic gate,
the at least one passivation logic gate is configured to convert the original digital data into the resulting digital data and to generate the resulting data,
the original digital data are defined by a first binary sequence, and
the resulting digital data are defined by a second binary sequence that is different from the first binary sequence.

2. The data backup device according to claim 1,
the passivation device comprises a passivation device input interface configured to supply the original digital data to the at least one passivation logic gate,
the passivation device comprises a passivation device output interface configured to output the resulting digital data generated by the at least one passivation logic gate, and
the passivation device input interface is connected to the passivation device output interface exclusively via the at least one passivation logic gate.

3. The data backup device according to claim 88, wherein the passivation device is part of a data backup and provision device logic gate device.

4. The data backup device according to in that claim 3, further comprising:
a providing device;
wherein the providing device comprises a providing device data memory for storing the resulting digital data.

5.-7. (canceled)

8. The data backup device according to claim 4, further comprising:
a data processing device in the providing device data memory of the providing device, the data processing device being configured to store resulting digital data and to forward the resulting digital data to the reactivation device.

9.-81. (canceled)

82. The data backup device according to claim 2, wherein:
the passivation logic gate is configured to generate zero binary sequence representations for zeros of the first binary sequence of the original digital data, and
the passivation logic gate is configured to generate ones binary sequence representations for ones of the first binary sequence of the original digital data.

83. The data backup device according to claim 82, wherein:
the zero binary sequence representation has at least two bits; and
the ones binary sequence representation has at least two bits.

84. (canceled)

85. The data backup device according to claim 83, wherein the passivation logic gate is configured to define or provide or determine or select or generate different zero binary sequence representations and/or ones binary sequence representations for different original data.

86. The data backup device according to claim 85, wherein:
for generating resulting digital data, the passivation logic gate is configured to define or provide or determine or select or generate different zero binary sequence representations and/or ones binary sequence representations for original data of the first binary sequence.

87. The data backup device according to 86, wherein:
the passivation logic gate is configured to execute an algorithm for predetermining or generating or determining the zero binary sequence representations and/or the ones binary sequence representations, or
the passivation logic gate is configured to execute a random algorithm for randomly determining or generating or determining the zero binary sequence representations and/or the ones binary sequence representations, or
one or more look-up tables having a plurality of fixed zeros-ones binary string representation combinations are provided and the passivation logic gate is arranged to select different zeros-ones binary string representation combinations, wherein the one or more look-up tables has at least 10 different zeros-ones binary string representation combinations.

88. The data backup device according to claim 87, wherein:
the one or more look-up tables have zeros-ones binary string representation combinations,
the zeros-ones binary string representation combinations have zeros-bit representations and ones-bit representations,
at least individual zero bit representations of the zeros-ones binary string representation combinations each have a first number of bits,
at least individual ones-bit representations of the zeros-ones binary string representation combinations each have a second number of bits, and
wherein, at least for individual zeros-ones binary string representation combinations, the first number of bits and the second number of bits are the same and/or are different.

89.-103. (canceled)

104. The data backup device according to claim one 82, further comprising:
an analysis unit configured to determine at least one malware signature or malware signature data,
wherein:
the analysis unit is configured to generate analysis bit representation data and/or a text representation using a processing device based on the resulting digital data
the analysis bit representation data represents the first bit sequence in encrypted form, and
wherein:
the analysis bit representation data is analyzable with respect to one malicious code signature or malware signature contained in the first bit sequence or with respect to multiple malicious code signature data or malware signatures or malicious code signatures or malware signatures contained in the first bit sequence 16, and/or
the text representation is analyzable with respect to a malicious code signature or malware signature contained in the first bit sequence or with respect to multiple malicious code signature data or malware signatures or malicious code signatures or malware signatures contained in the first bit sequence.

105. The data backup device according to claim 104, wherein:
the analysis bit representation data relating to the zero binary sequence representations of the resulting digital data comprise a plurality of first bit blocks relating to at least or exactly one zero analysis bit representation of a normalization system,
the analysis bit representation data relating to ones binary sequence representation of the resulting digital data comprises a plurality of second bit blocks relating to at least or exactly one ones analysis bit representation of the normalization system, and
the normalization system comprises a plurality of different bit blocks, each bit block being assigned a unique comparison parameter.

106. The data backup device according to claim 105, wherein the analysis unit comprises one or at least one logic gate device, and a processing editor.

107. The data backup device according to claim 106, wherein the comparison parameter is selected from the group consisting of symbols, colors, grayscales, tones and/or patterns.

108.-125. (canceled)

126. A control system for controlling at least one digital subsystem via a network, wherein:
the at least one digital subsystem comprises a data input interface,
the data input interface is connected to the network and to a control logic gate,
the control logic gate is configured to generate defined control signals or control data dependent on control original data supplied to the data input interface via the network, and
the bit sequence of the control original data is different from the bit sequence of the control signals or control data.

127. The control system according to claim 126, wherein:
the digital subsystem is a data backup device, a robot, a router or a vehicle, or
the digital subsystem includes one or more actuators, and/or one or more water supply devices and/or one or more factories, and/or one or more communication devices and/or one energy supply devices, and/or one or more production devices.

128.-167. (canceled)

168. A logic gate device for securing data having:
at least one passivation logic gate part,
wherein:
the at least one passivation logic gate part is configured to convert original digital data into resulting digital data, the resulting digital data representing a passivated form of the original digital data,
the passivation logic gate part is configured to generate: (i) one or more zero binary sequence representations for zeros of a first binary sequence of the original digital data, and (ii) one or more ones binary sequence representations for ones of the first binary sequence of the original digital data,
the zero binary sequence representation has at least two bits or the zero binary sequence representations each have at least two bits,
the ones binary sequence representation comprises at least two bits or wherein the ones binary sequence representations each comprise at least two bits and
the passivation logic gate part is configured to define or provide or determine or generate different combinations of zero binary sequence representations and ones binary sequence representations for different original data.

169.-207. (canceled)

208. A method for backing up data using the data backup device of claim 1, comprising:
converting the original digital data into the resulting digital data using the passivation device, and
converting the resulting digital data into the target data using the reactivation device,
wherein:
the passivation device comprises a passivation device input interface configured to supply the original data to the at least one passivation logic gate and a passivation device output interface configured to output the resulting digital data generated by the at least one passivation logic gate,
the reactivation device comprises a reactivation device input interface configured to supply the resulting digital data to the reactivation device and a reactivation device output interface configured to output the target data, and
at least 90% of the target data matches the original digital data.

209. The method according to claim 208, wherein:
the passivation logic gate is configured to: (i) generate zero binary sequence representations for zeros of the first binary sequence of the original digital data, and (ii) generate ones binary sequence representations for ones of the first binary sequence of the original digital data,
the zero binary sequence representation has at least two bits,
the ones binary sequence representation has at least two bits,
the passivation logic gate is configured to define or provide or determine or generate different zero binary sequence representations and/or ones binary sequence representations for different original digital data,
for generating resulting data, the passivation logic gate is configured to define or provide or determine or generate different zero binary sequence representations and/or ones binary sequence representations for original data of the first binary sequence, and
wherein:
the passivation logic gate executes an algorithm for predetermining or generating or determining the zero binary sequence representations and/or the ones binary sequence representations, or
the passivation logic gate executes a random algorithm for randomly determining or generating or determining the zero binary sequence representations and/or the ones binary sequence representations, or
one or more look-up tables having a plurality of predetermined zeros-ones binary string representation combinations are provided and the passivation logic gate is equipped to select different zeros-ones binary string representation combinations, the one or more look-up tables comprising at least 10 different zeros-ones binary string representation combinations, and
wherein:
the one or more look-up tables comprise zeros-ones binary string representation combinations,
the zeros-ones binary string representation combinations comprise zeros-bit representations and ones-bit representations,
at least individual zero bit representations of the zeros-ones binary string representation combinations each comprise a first number of bits,
at least individual ones-bit representations of the zeros-ones binary string representation combinations each comprise a second number of bits, and
at least for individual zeros-ones binary string representation combinations, the first number of bits and the second number of bits are the same and/or are different.

216.-252. (canceled)
